(19) United States
(12) Patent Application Publication
(10) Pub. No.: US 2013/0180173 A1
(43) Pub. Date: Jul. 18, 2013

(54) PLANT ARTIFICIAL SEEDS HAVING MULTILAYERS AND METHODS FOR THE PRODUCTION THEREOF

(71) Applicant: E I DU PONT DE NEMOURS AND COMPANY, Wilmington, DE (US)

(72) Inventors: Timothy Caspar, Yorklyn, DE (US); Denise Gaspareto, Sao Joaquim Da Barra (BR); Lawrence Doka Gaultney, Elkton, MD (US); Ross Gilmour, Wilmington, DE (US); Beverly Hallahan, Wilmington, DE (US); David L. Hallahan, Wilmington, DE (US); Barry D. Johnson, Bridgeton, NJ (US); Brad H. Jones, Wilmington, DE (US); Katrina Kratz, Chadds Ford, PA (US); Prakash Lakshmanan, Indooroopilly (AU); Surbhi Mahajan, Grove City, OH (US); Brian D. Mather, Newark, DE (US); Barry Alan Morris, Wilmington, DE (US); Marcos Luciano Nunhez, Sao Paulo (S.P.) (BR); Joseph Anthony Perrotto, Landenberg, PA (US); Jingjing Xu, Wilmington, DE (US)

(73) Assignee: E I DU PONT DE NEMOURS AND COMPANY, Wilmington, DE (US)

(21) Appl. No.: 13/721,101

(22) Filed: Dec. 20, 2012

Related U.S. Application Data
(60) Provisional application No. 61/578,432, filed on Dec. 21, 2011.

(51) Int. Cl. A01G 9/10; A01G 1/00

(52) U.S. Cl. CPC A01G 9/1026; A01G 1/001
USPC 47/65.7; 47/58.1 SE

(57) ABSTRACT

Composition and method for preparing artificial seeds of plantlets that can be developed into grown plants for propagation in the field are disclosed. In one embodiment, the artificial seeds are developed in degradable containers. The disclosed methods also allow for rapid propagation of in demand plants, such as sugarcane, to meet the ever increasing global demand for this plant.

### CROSS-REFERENCE TO RELATED APPLICATION

Benefit is claimed under 35 U.S.C. §119(e) to the filing date of U.S. Provisional Application No. 61/578,432, filed Dec. 21, 2011, the disclosure of which is herein incorporated by reference in its entirety.

### FIELD OF INVENTION

This invention relates to the production of plant artificial seeds. Specifically, it relates to the production of sugarcane artificial seeds.

### BACKGROUND

Some plants such as sugarcane, banana, pineapple, citrus, conifers and apple cannot be propagated via seeds due to: a) the loss of genetic identity during reproduction by seed; b) the long duration of growth for the plants before seed production; and c) the poor growth and survival rate of these plants' natural seeds under field growth conditions. Currently, these crops are propagated by either vegetative means or via seedlings. Thus attempts have been made to develop various economical alternatives for their propagation.

Artificial seeds have long been studied as an alternative means to propagate some plants (Kitto, S., Hort. Science, 20: 98-100, 1985). An artificial seed is an object that is man-made, and which includes components necessary to facilitate plant growth, and from which a plant may grow and be established from its own plant tissue, but wherein the plant tissue is not typically the same as the plant's natural seed. By contrast, a natural seed is produced by plants in a natural biological process without human intervention.

Traditional artificial seeds are alginate-encapsulated laboratory-cultured tissue that can be grown in vitro, but they suffer from very low survival rates in field environments due to both encapsulated material as well as biological challenges. Encapsulation is the process of adding the regenerable plant tissue to a container to provide an artificial seed. A regenerable plant tissue is a tissue capable of regenerating into a mature plant with the same features and genetic identity as the parent plant. A plantlet is one type of regenerable plant tissue. Plantlets can possess well-differentiated shoots and roots or they can be immature plantlets with only shoots that are capable of rooting when planted in soil or other growth media. Some of the challenges include the desiccation of exposed alginate-encapsulated tissue, attack by soil microorganisms, poor gas exchange of encapsulants, and immaturity and weakness of the laboratory-cultured tissue (Redenbaugh, K., Hort. Science, 22: 803-809, 1987 and Redenbaugh, K., Cell Cult and Somat Cell Genet Plants, 8: 35-74, 1991).

Artificial seeds have been used for the production of conifers using conifer embryos (Weyerhaeuser Corporation, WO1998033375). This method uses a complex, multi-compartment, individually-assembled design.

Sugarcane is commercially propagated vegetatively due to the loss of genetic identity during sexual reproduction by seed. Vegetative reproduction of this plant involves planting of stalk cuttings (multi-node stem sections called billets or whole stalks) horizontally in furrows. Each stalk has a bud or meristem, at each node. Meristems are undifferentiated cells found in zones of the plant where growth can take place. A node segment refers to a section of cane stalk containing a lateral bud, capable of regenerating a sugarcane plant. After planting, these buds produce shoots and roots, which become new sugarcane plants. The sugar and nutrients inside the stalk sections fuel the initial growth of the new plants.

The vegetative reproduction of sugarcane is a very laborious process and is fraught with issues. The main issues include the requirement of a large quantity of stalk material for planting (called “seed cane” in commercial cane production operations) that otherwise could be milled for sugar production, and the cost of dedicating a significant portion of the field and the labor involved to produce seed cane. Significant cost is involved in simply transporting multiple tons of sugarcane (10-15 ton/ha) needed to plant a field. Additionally, seed cane can contain diseases which are propagated by planting diseased sugarcane to the next generation. Hence, pathogen-free planting stocks need to be maintained, which involves large-scale stalk sterilization procedures, adding more cost to conventional propagation. For the introduction of new varieties of sugarcane, the vegetative propagation method is inefficient due to the long growing cycles and hence the relatively low multiplication factor (e.g., 5 to 15 kg of seed cane produced for each 1 kg of sugarcane planted) per growing cycle of 1 year duration.

Plene™ (Syngenta Co.), is a commercial product which consists of single node segments of the sugarcane stalk, trimmed of excess internode tissue to resemble miniaturized billets, and has been used as a vegetative propagule. A propagule is a plant material used for propagation.

Another process for culturing sugarcane meristems into bud masses from field-grown stalks of sugarcane has been disclosed (BSES, WO2011/085446 A1). This method allows for high multiplication factors, which can be used to accelerate variety release. However, the propagules from this process require hardening in a nursery before being transferred to the field, which limits their practicality for large scale sugarcane production.

Thus, there remains a need to develop novel and economical methods for improving the viability of the plant tissues incorporated into artificial seeds to enable direct planting of the plantlets into soil.

### SUMMARY OF INVENTION

The present invention provides artificial seeds to improve growth and viability of regenerable plant tissues and allow for a scaleable planting process of difficult to propagate plants such as sugarcane.

In one aspect, the invention is directed to an artificial seed comprising one or more regenerable plant tissues, a container comprising a degradable portion, an unobstructed airspace, a multilayer, and a nutrient source, and further comprising one or more features selected from the group consisting of: a penetrable or degradable region through which the regenerable plant tissue grows, a monolayer water soluble portion of the container, a region of the container that flows or creeps between about 1° C. and 50° C., a separable closure which is physically displaced during regenerable plant tissue growth, one or more openings in sides or bottom of the container, a conical or tapered region leading to an opening less than 2 cm wide at the apex and wherein the angle of the conical or tapered region is less than 135 degrees measured from opposite sides, and a plurality of flexible flaps through which the regenerable tissue grows.

In one embodiment of the invention, the container, a region of the container, a closure, or a layer of the multilayer further comprises, or alternatively consists of, one or more of the following: polyesters, polyamides, polyolefins, cellulose, cellulose derivatives, polysaccharides, polyethers, polyurethanes, polycarbonates, poly(alkyl methacrylate)s, poly(alkyl acrylate)s, poly(acrylic acids), poly(meth)acrylic acids, polyphosphazenes, polyimides, polyanhydrides, polyamines, polydienes, polyacrylamides, poly(siloxanes), poly(vinyl alcohol), poly(vinyl esters), poly(vinyl ethers), natural polymers, block copolymers, crosslinked polymers, proteins, waxes, oils, greases, water soluble polymers, poly(ethylene glycol), salts of poly(acrylic acid), poly(vinyl alcohol), plasticizers, antioxidants, nucleating agents, impact modifiers, processing aids, tougheners, colorants, fillers, stabilizers, flame retardants, natural rubber, polysulfones, or polysulfides; or blends thereof; or crosslinked versions thereof.

In another embodiment of the invention, the container further comprises a component selected from the group consisting of: a) amorphous poly(D,L-lactic acid), poly(lactic acid), poly(L-lactic acid), poly(D-lactic acid), poly(meso-lactic acid), poly(rac-lactic acid), or poly(D,L-lactic acid), (poly(hydroxyalkanoate), poly(hydroxybutyrate), poly(hydroxybutyrate-co-valerate), poly(caprolactone), poly(butylene succinate), poly(ethylene succinate), poly(ethylene carbonate), poly(propylene carbonate), starch, gelatin, thermoplastic starch, poly(butylene terephthalate adipate), poly(propylene terephthalate succinate), poly(propylene terephthalate adipate), poly(vinyl alcohol), poly(ethylene glycol), cellulose, chitosan, cellulose acetate, or cellulose butyrate acetate, b) a polyester with greater than 5 mol percent aliphatic monomer content, c) a crosslinked version of amorphous poly(D,L-lactic acid), poly(lactic acid), poly(L-lactic acid), poly(D-lactic acid), poly(meso-lactic acid), poly(rac-lactic acid), or poly(D,L-lactic acid), (poly(hydroxyalkanoate), poly(hydroxybutyrate), poly(hydroxybutyrate-co-valerate), poly(caprolactone), poly(butylene succinate), poly(ethylene succinate), poly(ethylene carbonate), poly(propylene carbonate), starch, gelatin, thermoplastic starch, poly(butylene terephthalate adipate), poly(propylene terephthalate succinate), poly(propylene terephthalate adipate), poly(vinyl alcohol), poly(ethylene glycol), cellulose, chitosan, cellulose acetate, cellulose butyrate acetate, or a polyester with greater than 5 mol percent aliphatic monomer content, d) a plasticizer, wherein the plasticizer is present at less than 30 wt % of the total composition, e) acetyl tributyl citrate, tributyl citrate, di-n-octyl sebacate, di-2-ethylhexylsebacate, di-2-ethylhexylsuccinate, diisooctyl adipate, di-2-ethylhexyl adipate, diisooctyl glutarate, di-2-ethylhexyl glutarate, poly(ethylene glycol), poly(ethylene glycol) monolaurate, sorbitol, glycerol, poly(propylene glycol), or water,

f) copolymers of two or more of caprolactone, lactic acid, D-lactide, L-lactide, meso-lactide, D,L-lactide, sebacic acid, succinic acid, adipic acid, glycolic acid, oxalic acid, ethylene glycol, 1,2-propanediol, 1,3-propanediol, 1,3-butanediol, 1,4-butanediol, 1,5-pentanediol, 2,2,4,4-tetramethyl-1,3-cyclobutanediol, 1,6-hexanediol, terephthalic acid, isophthalic acid, dimethyl siloxane, succinic anhydride, a diisocyanate, a crosslinker, or phthalic anhydride, g) an antioxidant, a nucleating agent, an impact modifier, a processing aid, a toughener, a colorant, a filler, a stabilizer, or a flame retardant, h) paper, water soluble paper, recycled paper, bond paper, kraft paper, waxed paper, or coated paper, i) a combination of two or more of components a) through h), and j) a blend comprising two or more of components a) through i).

In another embodiment, a region of the container or closure or a layer of the multilayer further comprises a component selected from the group consisting of: a) random, block or gradient copolymers of lactic acid with caprolactone, b) random, block or gradient copolymers of lactic acid with dimethylsiloxane, c) an alkyd resin, d) poly(vinyl alcohol), poly(acrylamide), poly(vinyl pyrrolidone), starch, cellulose, glycerol, poly(ethylene glycol), citric acid, urea, water, sodium acetate, potassium nitrate, ammonium nitrate, fertilizers, agar, xanthan gum, alginate, hydroxypropylcellulose, methylcellulose, carboxymethylcellulose, guar gum, pectin, a water soluble protein, a water soluble carbohydrate, a water soluble synthetic polymer, gelatin, or sodium carboxymethylcellulose, and crosslinked versions thereof, e) blends of two or more of the following: poly(vinyl alcohol), starch, cellulose, glycerol, poly(ethylene glycol), poly(acrylamide), poly(vinyl pyrrolidone), citric acid, urea, water, sodium acetate, potassium nitrate, ammonium nitrate, fertilizers, agar, xanthan gum, alginate, hydroxypropylcellulose, methylcellulose, carboxymethylcellulose, a water soluble protein, a water soluble carbohydrate, a water soluble synthetic polymer, gelatin, a crosslinker, or sodium carboxymethylcellulose, f) a gel comprising a block copolymer and an oil, g) sodium carboxymethylcellulose, h) wax-impregnated water soluble paper, i) amorphous poly(D,L-lactic acid), poly(lactic acid), poly(L-lactic acid), poly(D-lactic acid), poly(meso-lactic acid), poly(rac-lactic acid), or poly(D,L-lactic acid), poly(hydroxyalkanoate), poly(hydroxybutyrate), poly(hydroxybutyrate-co-valerate), poly(caprolactone), poly(butylene succinate), poly(ethylene succinate), poly(ethylene carbonate), poly(propylene carbonate), starch, thermoplastic starch, gelatin, poly(butylene terephthalate adipate), poly(propylene terephthalate succinate), poly(propylene terephthalate adipate), poly(vinyl alcohol), poly(ethylene glycol), cellulose, chitosan, cellulose acetate, cellulose butyrate acetate; or a crosslinked version thereof, j) a polyester with greater than 5 mol percent aliphatic monomer content, k) a crosslinked version of amorphous poly(D,L-lactic acid), poly(lactic acid), poly(L-lactic acid), poly(D-lactic acid), poly(meso-lactic acid), poly(rac-lactic acid), or poly(D,L-lactic acid), poly(hydroxyalkanoate), poly(hydroxybutyrate), poly(hydroxybutyrate-co-valerate), poly(caprolactone), poly(butylene succinate), poly(ethylene succinate), poly(ethylene carbonate), poly(propylene carbonate), starch, gelatin, thermoplastic starch, poly(butylene terephthalate adipate), poly(propylene terephthalate succinate), poly(propylene terephthalate adipate), poly(vinyl alcohol), poly(ethylene glycol), cellulose, chitosan, cellulose acetate, cellulose butyrate acetate, or a polyester with greater than 5 mol percent aliphatic monomer content, l) a plasticizer, wherein the plasticizer is present at less than 30 wt % of the total composition, m) acetyl tributyl citrate, tributyl citrate, di-n-octyl sebacate, di-2-ethylhexylsebacate, di-2-ethylhexylsuccinate, diisooctyl adipate, di-2-ethylhexyl adipate, diisooctyl glutarate, di-2-ethylhexyl glutarate, poly(ethylene glycol), poly(ethylene glycol) monolaurate, sorbitol, glycerol, poly(propylene glycol), or water, n) copolymers of two or more of caprolactone, lactic acid, D-lactide, L-lactide, meso-lactide, D,L-lactide, sebacic acid, succinic acid, adipic acid, glycolic acid, oxalic acid, ethylene glycol, 1,2-propanediol, 1,3-propanediol, 1,3-butanediol, 1,4-butanediol, 1,5-pentanediol, 2,2,4,4-tetramethyl-1,3-cyclobutanediol, 1,6-hexanediol, terephthalic acid, isophthalic acid, succinic anhydride, a diisocyanate, a crosslinker, or phthalic anhydride, o) an antioxidant, a nucleating agent, an impact modifier, a processing aid, a toughener, a colorant, a filler, a stabilizer, or a flame retardant, p) a wax, Parafilm® or Nescofilm®, a hydrophobic substance, a fat, a triglyceride, fatty acid, fatty alcohol, a lipid, an oil, polyethylene, polypropylene, ethylene propylene copolymers, polybutadiene, polyisoprene, polyisobutylene, polyolefin oligomers, and crosslinked versions or blends thereof, q) paper, water soluble paper, recycled paper, bond paper, kraft paper, waxed paper, or coated paper; or r) a combination of two or more of components a) through q), and s) a blend comprising two or more of components a) through r).

In another embodiment, the container is expandable. Non-limiting examples of expandable methods include methods selected from the group consisting of: a) telescoping of two or more tubular members, b) unfolding, c) inflation, d) unraveling; and e) stretching.

In another embodiment of the invention, the nutrient source further comprises a component selected from the group consisting of: a) soil, b) coconut coir, c) vermiculite, d) an artificial growth medium, e) agar, f) a superabsorbent polymer, g) a plant growth regulator, h) a plant hormone, i) micronutrients, j) macronutrients, k) water, l) a fertilizer, m) peat, n) a combination of two or more of components a) through m), and o) a blend comprising two or more of components a) through n).

In another embodiment, the regenerable plant tissue is a regenerable tissue selected from the group consisting of: a) sugar cane, a graminaceous plant, saccharum spp, saccharum spp hybrids, miscanthus, switchgrass, energycane, sterile grasses, bamboo, cassava, corn, rice, banana, potato, sweet potato, yam, pineapple, trees, willow, poplar, mulberry, ficus spp, oil palm, date palm, poaceae, verbena, vanilla, tea, hops, Erianthus spp, intergeneric hybrids of Saccharum, Erianthus and Sorghum spp, African violet, apple, date, fig, guava, mango, maple, plum, pomegranate, papaya, avocado, blackberries, garden strawberry, grapes, canna, cannabis, citrus, lemon, orange, grapefruit, tangerine, or dayap, b) a genetically modified plant of a), c) a micropropagated version of a), and d) a genetically modified, micropropagated version of a).

In another embodiment, the container further comprises a component selected from the group consisting of: a) a cylindrical tube with a conical top, b) a two part tube with a porous bottom section and a nonporous top section, c) a flexible packet, d) a semi-flexible packet, e) a rolled tube structure, capable of unraveling, f) an anchoring device, g) a two multi-part tube with a hinged edge, h) a two multi-part tube held together with adhesive, i) a tubular shape, j) a container portion in contact with soil that degrades faster than the portion above soil, k) an airspace comprising multiple compartments, l) a closed bottom end that retains moisture, m) a cap attached by an adhesive joint, n) a cap attached by insertion into the container, and o) a weak region.

In another embodiment, the container or closure further comprises a material selected from the group consisting of: a) a transparent, translucent or semi-translucent material, b) an opaque material, c) a porous material, d) a nonporous material, e) a permeable material, f) an impermeable material; and g) any one of materials a) through f), wherein the material is biodegradable, hydrolytically degradable, or compostable.

In another embodiment, one or more of the openings are secured using a component selected from the group consisting of: a) a crimp, b) a fold, c) a porous material, d) mesh, e) screen, f) cotton, g) gauze; and h) a staple.

In another embodiment, the artificial seed further comprises an agent selected from the group consisting of: a) a fungicide, b) a nematicide, c) an insecticide, d) an antimicrobial compound, e) an antibiotic, f) a biocide, g) an herbicide, h) plant growth regulator or stimulator, i) microbes, j) a molluscicide, k) a miticide, l) an acaricide, m) a bird repellant, n) an insect repellant, o) a plant hormone; and p) a rodent repellant.

In another embodiment, a method for preparing the artificial seed comprising the steps of: a) preparing said container; b) preparing one or more regenerable plant tissues; and c) placing the tissue of step (b) inside the container prepared in step (a).

In another embodiment, a method of storing the artificial seed, comprising obtaining the artificial seed and storing said artificial seed before planting in one or more of the following conditions: a) ambient conditions, b) sub-ambient temperature, c) sub-ambient oxygen levels, or d) under sub-ambient illumination, and wherein the regenerable plant tissue remains viable.

In another embodiment, a method of planting the artificial seed, comprising obtaining the artificial seed and performing a step from the group consisting of: a) introducing one or more breaches in said artificial seed during planting, wherein the breaches facilitate the growth of the regenerable plant tissues, b) expanding the artificial seed, and c) the combination of a) and b).

### DESCRIPTION OF THE FIGURES

FIG. 1-FIG. 1a depicts a schematic representation of an artificial seed—architecture 1. Numbers on this Figure represent various parts of the artificial seed as indicated herein: (1) is stretched gelatin-starch-glycerol film layer; (2) is wax paper container; (3) is Metromix soil; (4) is sugarcane plantlet.

FIG. 1b is a photograph of an artificial seed with architecture 1: (1) is stretched gelatin-starch-glycerol film; (2) is wax paper container

FIG. 1c is a photograph of two artificial seeds with architecture 1 from which shoots and roots have sprouted. The photograph was taken after three weeks of planting the artificial seed in the soil.

FIG. 2-FIG. 2a depicts a schematic representation of an artificial seed—architecture 2. (1) is stretched gelatin-starch-glycerol film layer; (2) is wax paper container; (3) is Metromix soil; (4) is sugarcane plantlet and (5) is paper disc layer.

FIG. 2b is a photograph of an artificial seed with architecture 2. (1) is stretched gelatin-starch-glycerol film; (2) is wax paper container; (3) is Metromix soil; (4) is sugarcane plantlet and (5) is paper disc layer.

FIG. 2c is a photograph of an artificial seed with architecture 2 from which shoots and roots have sprouted. The photograph was taken after three weeks of planting the artificial seed in the soil. (2) is wax paper container; (6) is sugarcane shoots; (7) is paper disc used in securing the top opening which had opened after softening of gelatin-starch-glycerol film; (8) is sugarcane roots.

FIG. 3-FIG. 3a depicts a schematic representation of an artificial seed—architecture 3. (1) is stretched gelatin-starch-glycerol film; (2) is wax paper container; (3) is Metromix soil; (4) is sugarcane plantlet; (5) is paper disc layer; (9) is Crisco® fat layer; (10) is gelatin-starch-glycerol film.

FIG. 3b is a schematic representation of an artificial seed with a 3 layer bottom opening architecture. (5) is paper disc layer; (9) is Crisco® fat layer; (10) is gelatin-starch-glycerol film layer.

FIG. 3c is a photograph showing sprouting of sugarcane plantlets from the top opening of the artificial seed based on architecture 3. The photograph was taken 11 days after planting the artificial seed in the soil.

FIG. 3d is a photograph of sprouting of sugarcane plantlets from the top opening of the artificial seed and emergence of root from the bottom opening based on architecture 3. (2) is the artificial seed; 6 sugarcane shoots; (8) is sugarcane roots.

FIG. 4-FIG. 4a depicts the process of preparing the closure for the top opening for the artificial seed based on architecture 4. (11) is an aqueous gelatin-starch-glycerol solution and (12) is the gelatin-starch-glycerol dried film used as closure for securing the top opening.

FIG. 4b depicts preparation of the closure for the bottom opening of the artificial seed. (10) represents the gelatin-starch-glycerol dried film used as closure for securing the bottom opening of the artificial seed.

FIG. 4c depicts an artificial seed based on architecture 4, with the gelatin-starch-glycerol film (12) used as closure for securing of the top opening; Metromix (3) Crisco® oil (6) and gelatin-starch-glycerol film (10) used as closure for securing of the bottom opening of the artificial seed.

FIG. 4d is a photograph of an artificial seed based on architecture 4 prior to planting in Metromix soil.

FIG. 4e is a photograph of artificial seed based on architecture 4 after 7 days of being planted in the soil.

FIG. 5 is a photograph of packet type artificial seeds based on paper-polyethylene bilayer films containing sugarcane plantlets in the field.

### DETAILED DESCRIPTION OF INVENTION

It is to be understood that this invention is not limited to the particular methodology, protocols, cell lines, genera, and reagents described, as such may vary. It is also to be understood that the terminology used herein is for the purpose of describing particular embodiments only, and is not intended to limit the scope of the present invention.

As used herein the singular forms “a”, “and”, and “the” include plural referents unless the context clearly dictates otherwise. Thus, for example, reference to “a cell” includes a plurality of such cells and reference to “the protein” includes reference to one or more proteins and equivalents thereof known to those skilled in the art, and so forth. All technical and scientific terms used herein have the same meaning as commonly understood to one of ordinary skill in the art to which this invention belongs unless clearly indicated otherwise.

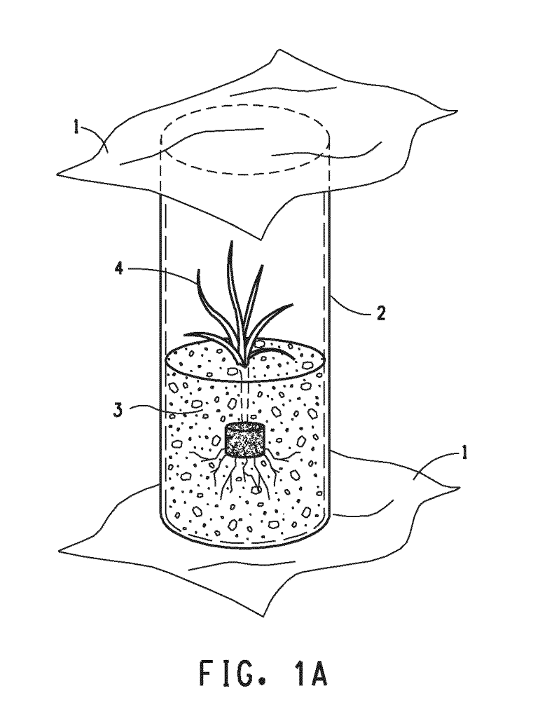

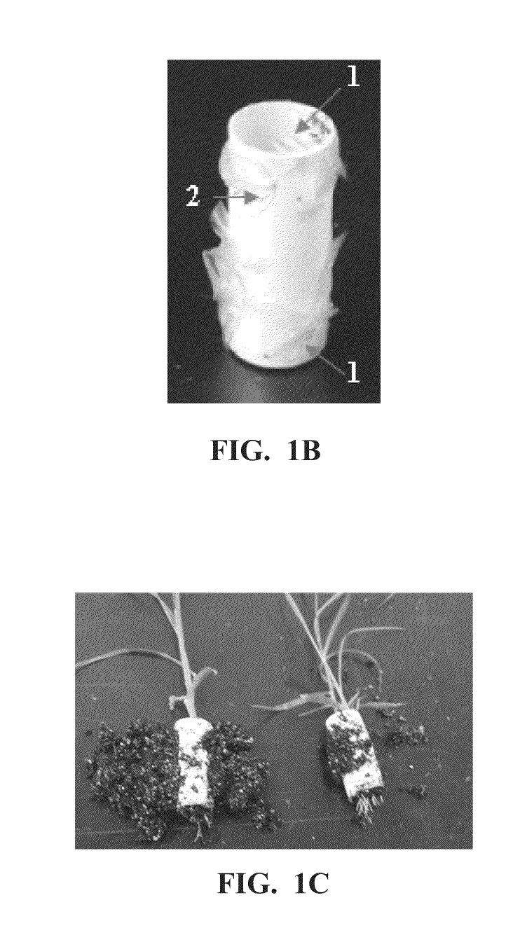

One embodiment of the invention relates to the development of a plant artificial seed (FIG. 1) where a regenerable plant tissue (3) is placed in a container (4) and the container is planted in soil and the regenerable plant tissue is allowed to grow. An artificial seed of the present invention comprises a container and a regenerable plant tissue.

In another embodiment of the invention is provided an artificial seed comprising one or more regenerable plant tissues, a container comprising a degradable portion, an unobstructed airspace, and a nutrient source, and further comprising a feature selected from the group consisting of: a penetrable or degradable region through which the regenerable plant tissue grows, a monolayer water soluble portion of the container, a region of the container that flows between about 1° C. and 50° C., a separable closure which is physically displaced during regenerable plant tissue growth, one or more openings in sides or bottom of the container, a conical or tapered region leading to an opening less than 2 cm wide at the apex and wherein the angle of the conical or tapered region is less than 135 degrees measured from opposite sides, and a plurality of flexible flaps through which the regenerable tissue grows. The degradable region may be biodegradable, photodegradable, oxidatively degradable, hydrolytically degradable, or compostable. As used herein, “a region” means any component of the container or any associated closures.

A regenerable plant tissue is a tissue capable of regenerating into a mature plant with the same features and genetic identity as the parent plant. Regenerable plant tissues used for encapsulation in artificial seeds as described herein include, but are not limited to, apical or lateral meristematic tissue, callus, somatic embryos, natural embryos, plantlets, leaf whorls, stem and leaf cuttings, natural seeds and buds. A plant of any age can be a source of these tissues. As used herein, “apical meristem” means the meristem at the apical end of the growing stalk. It is the tissue that generates new leaves as well as lateral meristems as the stalk elongates and grows in height.

Various meristematic tissues such as shoot apical meristem, lateral shoot meristem, root apical meristem, vascular meristem and young immature leaves are used in the practice of the present invention. In one embodiment, apical shoot meristem tissue can be used. In another embodiment, lateral shoot meristem tissue is used. In another embodiment leaf tissue is used. As used herein, “meristem” encompasses all kinds of meristems available from a plant.

As used herein, “container” means any hollow structure that can hold the regenerable plant tissue. The container can have a variety of shapes and forms, so long as the shape allows the container to hold the plant tissue. For example, the container can be spherical, tubular with circular, conical, cubic, ovoid or any other cross-sectional shape. In one embodiment of the invention, the regenerable plant tissue can have a volume of between 0.0001% and 90% of the container volume.

One class of regenerable plant tissues of interest is micropropagated plant tissue. Micropropagated tissue is typically grown in a highly hydrated environment, and thus typically lacks features such as full stomatal function and protective morphology such as a cuticle layer. These features are important for the regulation of moisture within the tissue and pose an issue for the survival of these tissues outside of the micropropagation environment. In particular, the field environment can be particularly harsh and challenging for the survival of micropropagated tissues. Micropropagated sugarcane plantlets lack desiccation tolerance and typically exhibit low survival in the field environment. The traditional solution for this is to condition the sugarcane plantlets in a greenhouse, however this is costly and time consuming and results in plants that are too large to plant economically in production fields. In order to support the survival of these tissues in a field environment, it is critical to offer protection from desiccation. This protection may involve protecting the tissue from wind, and creating a humid local environment around the tissue. This can be accomplished by creating a physical barrier or container around the tissue.

Another feature of micropropagated tissue is that it typically lacks robust, lignified structures such as woody stems. These are important to provide stiffness to a mature plant which prevents the plant from damage during winds. Due in part to the lack of such structures, and the sometimes decreased vigor of these tissues compared to natural seeds, it is challenging for micropropagated tissue to escape a container offering maximum protection against moisture loss and desiccation. Micropropagated sugarcane plantlets possess weak, grassy shoots, which are incapable of puncturing commonly-used packaging materials. Thus, it is important to develop mechanisms enabling the escape and proliferation of these tissues from packaging materials.

Ideally, containers reduce the rate of water loss the tissue experiences in the field environment, either through transpiration into the atmosphere or conduction and capillary action into the surrounding soil. The container must also allow sufficient gas permeability, to allow the tissue to obtain the gases it needs for photosynthesis and respiration. Additionally, it is beneficial that the container allow the passage of some light to the plant for photosynthesis. Assuming the container protects the tissue adequately to enable survival and growth, the tissue will grow to a size requiring it to escape and shed the container. This allows the roots to proliferate into the soil to reach additional nutrient and water sources, and allows the leaves and shoots to proliferate to increase photosynthesis.

In one embodiment, the invention provides novel packaging containers for the delivery and successful growth of micropropagated tissue, said novel packaging containers referred to hereinafter as artificial seed(s). In general, the artificial seed will have a top and bottom end, with the micropropagated tissue positioned such that the shoots grow toward the top end, and the roots grow toward the bottom end. In a non-limiting hypothesis of the invention, it is believed that the top region of the artificial seed is more important to protect from moisture loss than the bottom region, due to the fact that soil offers a buffer from evaporation and may also provide a source of moisture depending on the depth the artificial seed is planted.

Artificial seed of the invention may include one or more of the following mechanisms, including all seven, in order to balance the moisture retentive feature of the artificial seed while allowing the eventual escape and proliferation of the micropropagated tissue:

1) In one embodiment of the invention, weak hydrophobic regions of the artificial seed or lid(s) thereof are contemplated which block moisture loss while allowing shoots and roots of the developing plant to puncture them. It is not feasible for the entire container to be composed of such a weak material, as this would pose problems for handling, storage and planting. Thus a solution proposed herein involves a multilayer structure, combining weak, moisture retaining layers with mechanically robust water soluble or rapidly degradable layers;

2) In another embodiment of the invention, the artificial seed(s) comprise degradable regions or lids thereof which block moisture loss and degrade at a rate commensurate with the growth and development of protective structures within the plant itself, such that the container releases the plant at a developmentally favorable stage. The degradation mechanism includes, but is not limited to, one of the following: biodegradation, hydrolytic degradation, photo-degradation or oxidative degradation. In a particular embodiment, the artificial seed comprises, or alternatively consists of, two degradable materials having different degradation rates, wherein the degradation rate of the subsurface portion is more rapid than the degradation rate of the aerial portion. In a non-limiting example, once the subsurface portion has degraded, the aerial portion is displaced with the growth of the shoots;

3) In another embodiment of the invention, the artificial seed(s) comprise flap-like structures in which a plurality of flexible flaps converge to substantially enclose one or both ends of the structure, preferably the top end of the structure. The mechanical behavior of the flaps is designed through material choice and geometrical features (thickness, angle relative to emerging shoots) to enable weak plants to deflect and thereby escape the artificial seed;

4) In yet another embodiment of the invention, the artificial seed(s) comprise caps, lids or fastener structures that are displaced by the growing plant. In a particular embodiment, the caps, lids or fastener structures are displaced by a telescoping action or via the rupture of a weak adhesive joint;

5) In a further embodiment of the invention, the artificial seed(s) comprise tapered regions at the top, leading to openings which are small relative to the diameter or cross-section of the artificial seed. These tapered regions guide the shoots of the micropropagated tissue toward the opening(s) through which they can escape;

6) In a further embodiment of the invention, the artificial seed(s) comprise a water soluble top region or closure, wherein the closure is dissolved by irrigation or rainfall, thereby allowing the shoots of the micropropagated tissue to grow out of the artificial seed structure;

7) In a further embodiment of the invention, the artificial seed(s) comprise a region or closure wherein the closure or region flows or creeps at a temperature between 1-50° C. This temperature range is commensurate with typical ambient temperatures experienced in field environments where this invention is directed.

One mechanism which is proposed in this invention to achieve the balance of moisture retention and plant release is the use of a bi- or multilayer container, wherein the inner wall is water insoluble, and retains moisture, but is weak enough to be punctured by the growing regenerable plant tissue and an outer wall which is water soluble but is mechanically robust and protects the artificial seed and plant tissue therein from mechanical damage.

In another embodiment, the container comprises a weak seam or slotted edge, allowing it to open and release the growing tissue. The weak seam may be created in the container by any means known in the art, including but not limited to perforation, thinning a region of the wall of the container, pre-stressing, creasing, or cracking a region of the container. In one embodiment, the container is an extruded cylindrical tube in which a weak seam is created along one or more edges by extruding a thinner region of material along the seam. In another embodiment, the container is a cylindrical tube with a slot cut along one edge. The material of the container is then flexible enough to allow the plantlet to push the container open. In one embodiment, the container can be constructed of two or more pieces or parts, which may be separable by the growth of the tissue or by dissolution or degradation of an adhesive connecting them. In one embodiment, the container consists of an extruded cylindrical tube with bands of soluble or degradable material along the length of the cylinder. This can be achieved through extrusion of a bi-component or multicomponent, or through the assembly of pieces using adhesive or heat sealing. In another embodiment, the container consists of two longitudinal halves of a tube, which are connected by adhesive. In another embodiment, two halves are connected along one edge through means including, but not limited to, heat sealing or adhesives, such that a hinged structure is created. In one embodiment, the adhesive consists of a water soluble polymer, including but not limited to poly(vinyl alcohol) or poly(vinyl pyrrolidone). The two halves may be connected using an adhesive or degradable material. The adhesive may be water soluble or flowable in a range of temperatures from about 1-50° C. The degradable material may be hydrolytically degradable, oxidatively degradable, biodegradable, compostable, or photodegradable. In another embodiment, the container consists of two connected sections of a tube. The connected sections may possess different porosity and/or degradability. The sections may be connected by means including, but not limited to, insertion, tape or an adhesive. In one embodiment the top section is composed of plastic and the bottom section is composed of paper.

The container may possess a conical or tapered feature. The angle of the conical feature, measured from one side of the conical section to the opposite side, may be varied, preferably less than 179 degrees, more preferably less than 135 degrees and most preferably less than 100 degrees. A conical tube is defined herein as a cylindrical tube with one or more conical features connected to it. The conical feature may be made of the same material as the cylindrical tube, or a different material. The conical or tapered feature may possess one or more holes, through which the plant can grow. Additionally, the holes provide rapid gas exchange. The size of the holes can vary from 0.1 to 30 mm, preferably from 1 to 20 mm and more preferably from 3 to 15 mm.

The container may be expandable or collapsible, such that prior to planting (for instance during storage) the seed occupies a smaller volume than it does after planting. The container may possess an expandable portion or component. As used herein, “expandable” means the capability of increasing in size. This is achieved for instance with concentric tubular or cylindrical containers that can be telescoped to form a longer tube.

As used herein, “telescoping” means the movement of two contacting objects in opposite directions without breaking contact. Also, the container may be partly or completely foldable, such that the folded container, prior to planting, occupies less space than the unfolded container after planting. The container may have pleated or ribbed sections, allowing collapsing while maintaining the same overall shape as the expanded version. The container may expand through the unfolding of an accordion-like structure. The container may possess rigidifying elements. As used herein, “stretching” means the act of elongation through deformation in one or more directions. As used herein, “a rigidifying element” means an element which increases the rigidity of an object. Rigidifying elements include, but are not limited to, creases, folds, inflated compartments, and thick or ribbed regions of the container. The container may be formed from a rolled sheet or tube, such that the structure can unroll or unravel, either at the time of planting or afterward through the growth of the tissue. As used herein, “unraveling” means unrolling of a rolled object without loss of the object's overall shape. The container may possess a collapsible film which can be expanded to form a protective tent around the artificial seed. In one embodiment, the container of the artificial seed may also be stretchable. As used herein, “stretching” means the act of elongation through deformation. In one embodiment, the container may be deflatable and inflatable. The deflation may be achieved through the application of external pressure or through vacuum sealing. Upon rupturing the seal, the container may spontaneously re-inflate. Alternatively, gas pressure may be applied to cause the inflation. In many cases, a restraint may be used to keep the container in a compact or collapsed form prior to planting. This restraint includes, but is not limited to, a band or tape, a glue or other fastener.

In one embodiment the artificial seed possesses a closed bottom end, which contains moisture. This closed end prevents the moisture from draining into the surrounding soil. Holes on the sides of the container are then situated to allow root growth, while maintaining the closed nature of the bottom end of the artificial seed.

The container may comprise a packet or a pouch. The packet may be completely sealed or may possess multiple openings. The packet may be made of biodegradable, photodegradable, oxidatively degradable or hydrolytically degradable material. The packet may be flexible or semi-flexible. Semi-flexible is defined herein as being capable of deformation through an external force, but returning to a shape similar to its original shape after removal of the external force. The packet may possess rigidifying elements. The packet may have shapes including, but not limited to, tubular, cylindrical, rectangular, square or round shapes. The packet may consist of multiple layers, or a single layer. The packet may consist of a bilayer or multilayer film. The packet may possess a water soluble outer layer and a moisture retaining water insoluble inner layer.

The container may be transparent, translucent, semi-opaque or opaque. Transparent materials include but are not limited to polycarbonate and glass. Translucent materials include but are not limited to high density polyethylene and polypropylene. Semi-translucent materials include but are not limited to etched glass and coated plastics. Opaque materials include but are not limited to filled plastics, wood and paper.

The size of the container can vary. However, in one embodiment, the container possesses a cylindrical shape with a wall thicknesses ranging from 0.01-0.25 cm and dimensions of from 0.5-5 cm diameter and 1-30 cm length.

Various materials can be used to make the container, and in one embodiment of the invention the materials used to make the container comprise, or alternatively consist of: cellulosic material, such as, for example cellulose, ethyl cellulose, nitrocellulose, cellulose acetate, cellulose priopionate, cellulose acetate butyrate; with or without waxes and oils, synthetic and natural polymers and plastics such as, for example, gelatin, chitosan, zein, polyolefins, polypropylene, polyethylene, polyolefins, photodegradable polymers, oxidatively degradable polymers, polystyrene, acrylic copolymers, poly(alkyl (meth)acrylates), polyesters, polyethers, poly(vinyl acetate) copolymers, poly(acrylamide), poly(vinyl pyrrolidone), poly(vinyl pyridine), natural rubber, poly(ethylene oxide), polyamides, polysaccharides and polycarbonates, porous and non-woven materials, as well as crosslinked versions thereof, combinations thereof, copolymers thereof and plasticized versions thereof; biodegradable plastics including poly(hydroxy alkanoate)s, poly(lactic acid), poly(L-lactide), poly(D-lactide), poly(D,L-lactide), stereocomplexes of poly(L-lactide) with poly(D-lactide), poly(glycolic acid), poly(1,3-propanediol succinate), poly(1,2-propanediol succinate), poly(propylene succinate) and crosslinked versions and copolymers thereof.

Porous materials include, but are not limited to, ceramics, nonwovens and textiles. The container may also be nonporous. Nonporous materials include but are not limited to plastic, glass and metal. The container may be fabricated from a permeable material. Permeability includes but is not limited to water permeability, gas permeability and oxygen permeability. Permeable materials include poly(vinyl alcohol), poly(dimethyl siloxane) and natural rubber. The container may be fabricated from impermeable materials. Impermeability includes but is not limited to moisture impermeable or barrier materials, gas impermeable or barrier materials and oxygen impermeable or barrier materials. Impermeable materials include but are not limited to glass, metal and polyethylene terephthalate. Waxes and/or oils can be used to coat the walls of the container. Waxes include but are not limited to paraffin wax, spermaceti wax, beeswax and carnauba wax.

It is preferred that the artificial seed described herein substantially or completely degrades in the field environment such that the planted containers do not accumulate in the field over years of repeated planting. In order to accomplish this, biodegradable materials may be used to construct the container and closures. Traditional biodegradable materials including poly(lactic acid), poly(1,3-propanediol succinate), poly(propylene succinate), poly(hydroxybutyrate)s, poly(caprolactone) and cellulose derivatives are candidate biodegradable materials. In a preferred embodiment of poly(lactic acid), amorphous grades having a higher D-lactic acid content (typically >6 mol % D-lactic acid) are incorporated to provide higher degradation rates compared to more crystalline-containing poly(lactic acids) (<6 mol % D-lactic acid).

Another method of increasing degradability while reducing brittleness involves blending poly(lactic acid) or amorphous poly(lactic acid) with more rapidly degradable polymers, such as poly(caprolactone), poly(hydroxybutyrates) or thermoplastic starch (Rychter et al. Biomacromolecules 2006, 7, 3125). Blends can be formed by any method known in the art, including solution blending, melt blending, extrusion, compounding, reactive extrusion, etc. As used herein, “blends” means mixtures of two or more components. Blends may be miscible, immiscible, partially miscible and may consist of separate domains of each component. In one embodiment of the invention, the materials used to produce the container may comprise, or alternatively consist of, blends of poly(lactic acid), poly(hydroxybutyrate), poly(hydroxybutyrate-co-valerate), starch, cellulose, and chitosan, optionally with plasticizers including but not limited to sorbitol, glycerol, citrate esters, phthalate esters and water. Plasticizers are defined herein as substances which reduce the glass transition temperature of a material.

In another embodiment of the invention, the container comprises, or alternatively consists of, blends of poly(lactic acid) with poly(1,3-propanediol succinate). Such blends are optically translucent to translucent, which is advantageous to allow light to reach the tissue. Blends of crystalline poly(lactic acid) with poly(1,3-propanediol succinate) are partially miscible, as evidenced by the presence of two glass transition temperatures which change as a function of composition. Additionally, the optical clarity remains good even at high concentrations (even 50 wt %) of poly(1,3-propanediol succinate). Additionally, poly(1,3-propanediol succinate) is disclosed herein to exhibit rapid soil degradability, ideal for an artificial seed application.

Another method of increasing degradability while reducing brittleness involves plasticizing poly(lactic acid) with plasticizers including but not limited to citrate derivatives, citrate esters, acetyl butyl citrate, triethyl citrate, tributyl citrate, diethyl bishydroxymethyl malonate, phthalate esters, glycerol, poly(ethylene glycol), poly(ethylene glycol) monolaurate, oligomeric poly(lactic acid).

In another embodiment, the container is degradable at a rate that is commensurate with the growth of the tissue. In this embodiment, the container comprises, or alternatively consists of, poly(ε-caprolactone) or poly(hydroxyalkanoate). In one embodiment, the entire container is fabricated from poly(ε-caprolactone) or poly(hydroxyalkanoate) such that the portion in contact with the soil degrades at a rate sufficient to allow roots to escape and proliferate into the surrounding soil, and subsequently the top portion is then pushed off or shed by forces exerted by the growing shoots.

In another embodiment, the container and/or its closure(s) comprises, or alternatively consists of, dissolvable materials. In one such embodiment, the container and/or its closure(s) comprises, or alternatively consists of, blends of poly(vinyl alcohol) with starch, cellulose fibers and glycerol, optionally with crosslinking with a suitable agent, including but not limited to hexamethoxymethylmelamine or glutaraldehyde. This provides materials which are rapidly degradable in moist soil conditions, permitting rapid growth of the tissue inside. The starch may be from sources including but not limited to potato, corn, rice, wheat and cassava and may be modified or unmodified. Additional additives may include, but are not limited to, poly(ethylene glycol), citric acid, urea, water, salts including but not limited to sodium acetate, potassium nitrate and ammonium nitrate, fertilizers, agar, xanthan gum, alginate, and cellulose derivatives including but not limited to hydroxypropylcellulose, methylcellulose and carboxymethylcellulose.

The container may also comprise plasticizers, antioxidants, nucleating agents, tougheners, colorants, fillers, impact modifiers, processing aids, stabilizers, and flame retardants. Antioxidants include but are not limited to hydroquinone, Irganox® 1010, and vitamin E. Nucleating agents include but are not limited to calcium carbonate, cyclodextrin and phenylphosphonic acid zinc. Tougheners include but are not limited to styrenic block copolymers, Biomax® Strong, and oils. Colorants include but are not limited to pigments and dyes. Fillers include but are not limited to starch, mica and silica. Impact modifiers include but are not limited to Paraloid™ BPM-520, Biostrength® 280, and butadiene rubber. Processing aids include but are not limited to erucamide and stearyl erucamide. Stabilizers include but are not limited to UV stabilizers, hindered amine light stabilizers, antiozonants and organosulfur compounds. Flame retardants include but are not limited to aluminium trihydroxide (ATH), magnesium hydroxide (MDH), phosphonate esters, triphenyl phosphate, phosphate esters, ammonium pyrophosphate and melamine polyphosphate.

When the container is constructed of cellulosic material, it can optionally contain clay, alum, waxes, binders, glues, surfactants and barriers such as plastic or metallized layers. The cellulosic material may be porous and may possess multiple layers comprising, or alternatively consisting of, a variety of papers including but not limited to craft paper, bond paper, recycled paper, recycled newsprint, construction paper, chip board, cup stock, copier paper, wax paper, and coated papers.

In the presently disclosed invention, artificial seeds can be produced using a paper or a plastic container. The paper or plastic, to be used for container construction, has the following properties to be suitable for such application: it does not immediately overly soften by the aqueous nutrient source contained within it. The paper containers can be porous in nature, and can be degradable over the course of at least 5 years in soil. The plastic containers can be porous or non-porous, and may or may not be degradable in soil. The plastic material is either thermoplastic or thermoset materials.

In an embodiment, wax paper can be used to prepare the paper containers. In this case the size of the wax paper container can be around 1.19 cm in diameter and 4-6 cm in length.

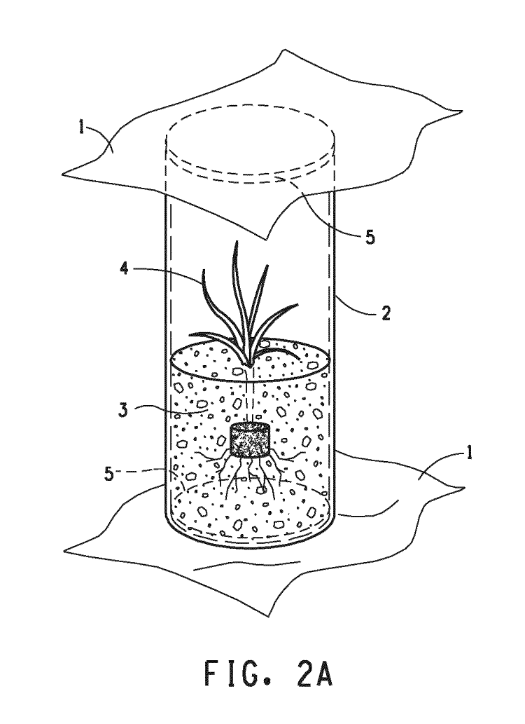

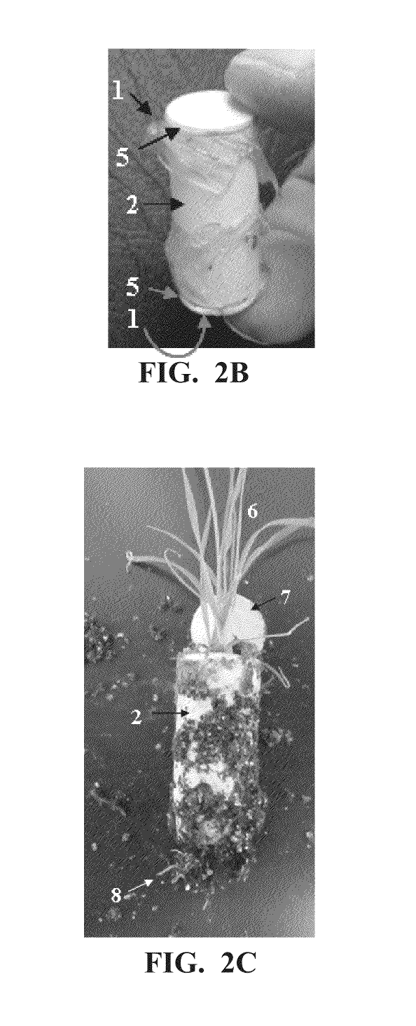

The cylindrical containers can have flat ends at the top and the bottom. In one embodiment, the bottom end of the container is crenellated (see FIG. 2). As used herein, “crenellation” means the creation of an irregular edge via the use of tabs of material extending from the edge and indentations into the edge. The size of crenellation can be from 0.65 cm to about 2 cm in length, with 2-6 tabs. In another embodiment, crenellation can be from 0.8 cm to about 1.2 cm in length, with 3-4 tabs.

Artificial seeds can also comprise one or more of a nutrient source (FIG. 1, (5)), solid objects such as pieces of cotton (FIG. 1, (6)), insecticides, fungicides, nematicides, antimicrobial compounds, antibiotics, biocides, herbicides, plant growth regulators or stimulators, microbes, molluscicides, miticides, acaricides, bird repellant(s), insect repellant(s), plant hormones, rodent repellant(s), fertilizers, hydrogels, superabsorbents, fillers, soil, soil amendments and water. Biocides include, but are not limited to, hypochlorite, sodium dichloro-s-triazinetrione, Plant Preservative Mixture™, obtained from Plant Cell Technology and trichloro-s-triazinetrione. Molluscicides include, but are not limited to, metaldehyde or methiocarb. Acaricides include, but are not limited to, ivermectin or permethrin. A bird repellent is defined as a substance that repels birds. Bird repellants include, but are not limited to, methyl anthranilate, methiocarb, chlorpyrifos and propiconazole. A rodent repellent is defined as a substance that repels rodents. Rodent repellents include, but are not limited to, thiram and methiocarb. Insect repellents include, but are not limited to, N,N-diethyl-m-toluamide, essential oils and citronella oil. Miticides include, but are not limited to, abamectin and chlorfenapyr. Plant hormones include, but are not limited to, abscisic acid, auxins, cytokinins, ethylene and gibberellins. Plant growth regulators include, but are not limited to, paclobutyrazol, ethephon, and ancymidol. As used herein, “superabsorbents” means absorbents which absorb water or aqueous solutions resulting in a hydrated gel such that the weight of the gel is 30 times or greater the weight of the dry superabsorbent. Superabsorbents include, but are not limited to, superabsorbent polymers, crosslinked poly(sodium acrylate), crosslinked poly(acrylic acid), crosslinked poly(acrylic acid) salts, acrylic acid modified starch, crosslinked copolymers of acrylic acid with poly(ethylene glycol) acrylate, poly(ethylene glycol) methacrylate, poly(ethylene glycol) diacrylate, acrylamide, vinyl acetate, acrylic acid salts, bisacrylamide, N-vinyl pyrrolidone, acrylate esters, methacryrlate esters, styrenic monomers, diene monomers and crosslinkers. The superabsorbent may be present in the artificial seed in a dry or swollen state. It may be swollen with water or aqueous solutions, including but not limited to nutrient solutions, fertilizer solutions and antimicrobial solutions. The superabsorbent may also be mixed with soil or other components of the nutrient media. In one embodiment, the superabsorbent may be present in a separate compartment of the seed. The compartment may be connected or not with the compartment containing the regenerable plant tissue. The compartment may be separated by a screen or mesh from the compartment containing the tissue. Microbes include but are not limited to beneficial microbes, nitrogen fixing bacteria, rhizobium, fungi, azotobacter, microrhyza, microbes that release cellulases, and microbes that participate in degradation of the artificial seed container.

The artificial seed of the disclosed invention comprises airspace (2) within the container. The artificial seed can also contain closures (FIG. 1, (1)). Closures are defined as lids, caps or objects that cover openings. In one embodiment the closure may be separable from the container. The regenerable plant tissue may be capable of lifting off or shedding the separable closure during its growth. Separable closures include but are not limited to caps, inserts, flat films, dome shaped caps and conical caps. The separable closure may be attached to the container using an adhesive or degradable material. The adhesive may be water soluble or flowable in a range of temperatures from about 1-50° C. The degradable material may be hydrolytically degradable, oxidatively degradable, biodegradable, compostable or photodegradable. The caps or lids may also be attached by simple physical means including but not limited to insertion or crimping.

As used herein, “nutrient source” means nutrients which can help sustain and provide for the growth of the plant from the regenerable tissue. Suitable nutrients include, but are not limited to, one or more of water, soil, coconut coir, vermiculite, an artificial growth medium, agar, a plant growth regulator, a plant hormone, a superabsorbent polymer, macronutrients, micronutrients, fertilizers, inorganic salts, (including but not limited to nitrate, ammonium, phosphate, potassium and calcium salts) vitamins, sugars and other carbohydrates, proteins, lipids, Murashige and Skoog (MS) nutrient formula, Hoagland's nutrient formula, Gamborg's B-5 medium, nutrient formula and native and synthetic soils, peat and vinasse, and combinations thereof. Macronutrients include but are not limited to nitrate, phosphate and potassium. Micronutrients include but are not limited to cobalt chloride, boric acid, ferrous sulfate and manganese sulfate. The nutrient source can also contain extracellular polysaccharides such as those described in Mager, D. M. and Thomas, A. D. Journal of Arid Environments, 2011, 75, 2, 91-7.

The nutrient source can also contain hormones and plant growth regulators including but not limited to, gibberellic acid, indole acetic acid, naphthalene acetic acid (NAA), ethephon, 6-benzylamino purine (6-ABP), 2,4-dichlorophenoxyacetic acid (2,4-D), paclobutrazole, ancymidol and abcissic acid.

The nutrients can be present in an aqueous solution or aqueous gel solution, such as those well known in the art of plant propagation, including but not limited to natural and synthetic gels including: agar, agarose, gellan gum, guar gum, gum arabic, Gelrite™, Phytagel™, superabsorbent polymers, carrageenan, amylose, carboxymethyl-cellulose, dextran, locust bean gum, alginate, xanthan gum, gelatin, pectin, starches, zein, polyacrylamide, polyacrylic acid, poly(ethylene glycol) and crosslinked versions thereof.

The soil suitable for application inside the container where the regenerable plant tissue is to be inserted to grow should be able to provide aeration, water, nutrition, and anchorage to the growing regenerable plant tissue. Various kinds of soil that can be used in the container include synthetic soils like MetroMix® and vermiculite. It can also include natural soils such as sand, silt, loam, peat, and mixtures of these soils. The suitable soil can be present such that the container is at most 99% full. It is beneficial to leave at least 1 mm gap between the moist soil and the top of the container in order to maintain the rigidity of the stretched gelatin-starch-glycerol film used as closure for securing the opening.

In one embodiment, the nutrients can be present in a silicate gel. Such a silicate gel can be formed by neutralizing a solution of sodium or potassium silicate with acid. In one embodiment, subsequent washing or soaking steps may be used to remove the excess salts. Optionally, the gel can then be infused with nutrients through soaking or other processes. Alternatively, the silicate gel can be formed from silicic acid, or from other precursors, including but not limited to alkoxysilanes, silyl halides, or silazanes.

When the container comprises a nutrient source, the regenerable plant tissue within the container is partially embedded or in contact with the nutrient source and can be partially exposed to the airspace within the container. The term “partially exposed to an airspace”, as used herein, refers to a regenerable plant tissue that is either in contact with or has been partially embedded (i.e., 0 to 90% of the tissue submerged) in the nutrient source present in the container, with the remainder exposed to the airspace within the container. The regenerable plant tissue can be partially or fully surrounded by the nutrient source. The regenerable plant tissue can also be placed on top of the nutrient source. As used herein, “airspace” means a void in the container that is empty of any solid or liquid material, and filled by atmospheric gasses such as air, for example. An airspace, as defined herein does not include the collective voids in a porous or particulate material.

It is advantageous for the function of the artificial seed that the airspace be free of obstructions that limit the growth of the regenerable plant tissue with exception of the limits of the container wall. As used herein, “an unobstructed airspace” means an airspace that is continuous and uninterrupted between any part of the regenerable plant tissue and any region of the container. As used herein, “tapered” means narrowing or becoming progressively narrower along a dimension.

For the purposes of the disclosed invention, regenerable plant tissues can be prepared using various methods well known in the relevant art, such as the method of tissue culture of meristematic tissue described in International Publication Number WO2011/085446, the disclosure of which is herein incorporated by reference. Other possible methods include using plant cuttings, embryos from natural seeds or somatic embryos obtained through somatic embryogenesis. In one embodiment meristems can be excised to form explants and cultured to increase the tissue mass. The term “explant” as used herein, refers to tissues which have been excised from a plant to be used in plant tissue culture.

The regenerable plant tissue of the invention may also be genetically modified. This genetic modification includes, but is not limited to, herbicide resistance, disease resistance, drought tolerance, and insect resistance. Genetically modified (also known as transgenic) plants may comprise a single transgenic trait or a stack of one or more transgene polynucleotides with one or more additional polynucleotides resulting in the production or suppression of multiple polypeptide sequences. Transgenic plants comprising stacks of polynucleotide sequences can be obtained by either or both of traditional breeding methods or through genetic engineering methods. These methods include, but are not limited to, breeding individual lines each comprising a polynucleotide of interest, transforming a transgenic plant comprising a gene with a subsequent gene and co-transformation of genes into a single plant cell.

As used herein, the term “stacked” includes having the multiple traits present in the same plant (i.e., both traits are incorporated into the nuclear genome, one trait is incorporated into the nuclear genome and one trait is incorporated into the genome of a plastid or both traits are incorporated into the genome of a plastid). In one non-limiting example, “stacked traits” comprise a molecular stack where the sequences are physically adjacent to each other. A trait, as used herein, refers to the phenotype derived from a particular sequence or groups of sequences. Co-transformation of genes can be carried out using single transformation vectors comprising multiple genes or genes carried separately on multiple vectors. If the sequences are stacked by genetically transforming the plants, the polynucleotide sequences of interest can be combined at any time and in any order. The traits can be introduced simultaneously in a co-transformation protocol with the polynucleotides of interest provided by any combination of transformation cassettes. For example, if two sequences will be introduced, the two sequences can be contained in separate transformation cassettes (trans) or contained on the same transformation cassette (cis). Expression of the sequences can be driven by the same promoter or by different promoters. In certain cases, it may be desirable to introduce a transformation cassette that will suppress the expression of the polynucleotide of interest. This may be combined with any combination of other suppression cassettes or overexpression cassettes to generate the desired combination of traits in the plant. It is further recognized that polynucleotide sequences can be stacked at a desired genomic location using a site-specific recombination system. See, for example, International Publication Numbers WO 1999/25821, WO 1999/25854, WO 1999/25840, WO 1999/25855 and WO 1999/25853, the disclosures of each of which are herein incorporated by reference.

In some embodiments the polynucleotides encoding the polypeptides, alone or stacked with one or more additional insect resistance traits can be stacked with one or more additional input traits (e.g., herbicide resistance, fungal resistance, virus resistance, stress tolerance, disease resistance, male sterility, stalk strength, and the like) or output traits (e.g., increased yield, modified starches, improved oil profile, balanced amino acids, high lysine or methionine, increased digestibility, improved fiber quality, drought resistance, and the like). Thus, the polynucleotide embodiments can be used to provide a complete agronomic package of improved crop quality with the ability to flexibly and cost effectively control any number of agronomic pests.

Transgenes useful for preparing transgenic plants include, but are not limited to, the following:

1. Transgenes Conferring Resistance to Insects or Disease:

(A) Plant disease resistance genes. Plant defenses are often activated by specific interaction between the product of a disease resistance gene (R) in the plant and the product of a corresponding avirulence (Avr) gene in the pathogen. A plant variety can be transformed with cloned resistance gene to engineer plants that are resistant to specific pathogen strains. See, for example, Jones, et al., (1994) Science 266:789 (cloning of the tomato Cf-9 gene for resistance to Cladosporium fulvum); Martin, et al., (1993) Science 262:1432 (tomato Pto gene for resistance to Pseudomonas syringae pv. tomato encodes a protein kinase); Mindrinos, et al., (1994) Cell 78:1089 (Arabidopsis RSP2 gene for resistance to Pseudomonas syringae), McDowell and Woffenden, (2003) Trends Biotechnol. 21(4):178-83 and Toyoda, et al., (2002) Transgenic Res. 11(6):567-82. A plant resistant to a disease is one that is more resistant to a pathogen as compared to the wild type plant.

(B) Genes encoding a Bacillus thuringiensis protein, a derivative thereof or a synthetic polypeptide modeled thereon. See, for example, Geiser, et al., (1986) Gene 48:109, who disclose the cloning and nucleotide sequence of a Bt delta-endotoxin gene. Moreover, DNA molecules encoding delta-endotoxin genes can be purchased from American Type Culture Collection (Rockville, Md.), for example, under ATCC Accession Numbers 40098, 67136, 31995 and 31998. Other non-limiting examples of Bacillus thuringiensis transgenes being genetically engineered are given in the following patents and patent applications and hereby are incorporated by reference for this purpose: U.S. Pat. Nos. 5,188,960; 5,689,052; 5,880,275; 5,986,177; 6,023,013, 6,060,594, 6,063,597, 6,077,824, 6,620,988, 6,642,030, 6,713,259, 6,893,826, 7,105,332; 7,179,965, 7,208,474; 7,227,056, 7,288,643, 7,323,556, 7,329,736, 7,449,552, 7,468,278, 7,510,878, 7,521,235, 7,544,862, 7,605,304, 7,696,412, 7,629,504, 7,705,216, 7,772,465, 7,790,846, 7,858,849 and WO 1991/14778; WO 1999/31248; WO 2001/12731; WO 1999/24581 and WO 1997/40162, the disclosures of each of which are herein incorporated by reference.

(C) A polynucleotide encoding an insect-specific hormone or pheromone such as an ecdysteroid and juvenile hormone, a variant thereof, a mimetic based thereon or an antagonist or agonist thereof. See, for example, the disclosure by Hammock, et al., (1990) Nature 344:458, of baculovirus expression of cloned juvenile hormone esterase, an inactivator of juvenile hormone.

(D) A polynucleotide encoding an insect-specific peptide which, upon expression, disrupts the physiology of the affected pest. For example, see the disclosures of, Regan, (1994) J. Biol. Chem. 269:9 (expression cloning yields DNA coding for insect diuretic hormone receptor); Pratt, et al., (1989) Biochem. Biophys. Res. Comm. 163:1243 (an allostatin is identified in Diploptera puntata); Chattopadhyay, et al., (2004) Critical Reviews in Microbiology 30(1):33-54; Zjawiony, (2004) J Nat Prod 67(2):300-310; Carlini and Grossi-de-Sa, (2002) Toxicon 40(11):1515-1539; Ussuf, et al., (2001) Curr Sci. 80(7):847-853 and Vasconcelos and Oliveira, (2004) Toxicon 44(4):385-403. See also, U.S. Pat. No. 5,266,317 to Tomalski, et al., who disclose genes encoding insect-specific toxins.

(E) A polynucleotide encoding an enzyme responsible for a hyperaccumulation of a monoterpene, a sesquiterpene, a steroid, hydroxamic acid, a phenylpropanoid derivative or another non-protein molecule with insecticidal activity.

(F) A polynucleotide encoding an enzyme involved in the modification, including the post-translational modification, of a biologically active molecule; for example, a glycolytic enzyme, a proteolytic enzyme, a lipolytic enzyme, a nuclease, a cyclase, a transaminase, an esterase, a hydrolase, a phosphatase, a kinase, a phosphorylase, a polymerase, an elastase, a chitinase and a glucanase, whether natural or synthetic. See, PCT Application WO 1993/02197 in the name of Scott, et al., which discloses the nucleotide sequence of a callase gene. DNA molecules which contain chitinase-encoding sequences can be obtained, for example, from the ATCC under Accession Numbers 39637 and 67152. See also, Kramer, et al., (1993) Insect Biochem. Molec. Biol. 23:691, who teach the nucleotide sequence of a cDNA encoding tobacco hookworm chitinase and Kawalleck, et al., (1993) Plant Molec. Biol. 21:673, who provide the nucleotide sequence of the parsley ubi4-2 polyubiquitin gene, and U.S. Pat. Nos. 6,563,020; 7,145,060 and 7,087,810.

(G) A polynucleotide encoding a molecule that stimulates signal transduction. For example, see the disclosure by Botella, et al., (1994) Plant Molec. Biol. 24:757, of nucleotide sequences for mung bean calmodulin cDNA clones, and Griess, et al., (1994) Plant Physiol. 104:1467, who provide the nucleotide sequence of a maize calmodulin cDNA clone.

(H) A polynucleotide encoding a hydrophobic moment peptide. See, PCT Application WO 1995/16776 and U.S. Pat. No. 5,580,852 disclosure of peptide derivatives of Tachyplesin which inhibit fungal plant pathogens) and PCT Application WO 1995/18855 and U.S. Pat. No. 5,607,914 (teaches synthetic antimicrobial peptides that confer disease resistance).

(I) A polynucleotide encoding a membrane permease, a channel former or a channel blocker. For example, see the disclosure by Jaynes, et al., (1993) Plant Sci. 89:43, of heterologous expression of a cecropin-beta lytic peptide analog to render transgenic tobacco plants resistant to Pseudomonas solanacearum.

(J) A gene encoding a viral-invasive protein or a complex toxin derived therefrom. For example, the accumulation of viral coat proteins in transformed plant cells imparts resistance to viral infection and/or disease development effected by the virus from which the coat protein gene is derived, as well as by related viruses. See, Beachy, et al., (1990) Ann. Rev. Phytopathol. 28:451. Coat protein-mediated resistance has been conferred upon transformed plants against alfalfa mosaic virus, cucumber mosaic virus, tobacco streak virus, potato virus X, potato virus Y, tobacco etch virus, tobacco rattle virus and tobacco mosaic virus. Id.

(K) A gene encoding an insect-specific antibody or an immunotoxin derived therefrom. Thus, an antibody targeted to a critical metabolic function in the insect gut would inactivate an affected enzyme, killing the insect. Cf Taylor, et al., Abstract #497, SEVENTH INT'L SYMPOSIUM ON MOLECULAR PLANT-MICROBE INTERACTIONS (Edinburgh, Scotland, 1994) (enzymatic inactivation in transgenic tobacco via production of single-chain antibody fragments).

(L) A gene encoding a virus-specific antibody. See, for example, Tavladoraki, et al., (1993) Nature 366:469, who show that transgenic plants expressing recombinant antibody genes are protected from virus attack.

(M) A polynucleotide encoding a developmental-arrestive protein produced in nature by a pathogen or a parasite. Thus, fungal endo alpha-1,4-D-polygalacturonases facilitate fungal colonization and plant nutrient release by solubilizing plant cell wall homo-alpha-1,4-D-galacturonase. See, Lamb, et al., (1992) Bio/Technology 10:1436. The cloning and characterization of a gene which encodes a bean endopolygalacturonase-inhibiting protein is described by Toubart, et al., (1992) Plant J. 2:367.

(N) A polynucleotide encoding a developmental-arrestive protein produced in nature by a plant. For example, Logemann, et al., (1992) Bio/Technology 10:305, have shown that transgenic plants expressing the barley ribosome-inactivating gene have an increased resistance to fungal disease.

(O) Genes involved in the Systemic Acquired Resistance (SAR) Response and/or the pathogenesis related genes. Briggs, (1995) Current Biology 5(2), Pieterse and Van Loon, (2004) Curr. Opin. Plant Bio. 7(4):456-64 and Somssich, (2003) Cell 113(7):815-6.

(P) Antifungal genes (Cornelissen and Melchers, (1993) Pl. Physiol. 101:709-712 and Parijs, et al., (1991) Planta 183:258-264 and Bushnell, et al., (1998) Can. J. of Plant Path. 20(2):137-149. Also see, U.S. patent application Ser. Nos. 09/950,933; 11/619,645; 11/657,710; 11/748,994; 11/774,121 and U.S. Pat. Nos. 6,891,085 and 7,306,946. LysM Receptor-like kinases for the perception of chitin fragments as a first step in plant defense response against fungal pathogens (US 2012/0110696).

(O) Detoxification genes, such as for fumonisin, beauvericin, moniliformin and zearalenone and their structurally related derivatives. For example, see, U.S. Pat. Nos. 5,716,820; 5,792,931; 5,798,255; 5,846,812; 6,083,736; 6,538,177; 6,388,171 and 6,812,380.

(R) A polynucleotide encoding a Cystatin and cysteine proteinase inhibitors. See, U.S. Pat. No. 7,205,453.

(S) Defensin genes. See, WO 2003/000863 and U.S. Pat. Nos. 6,911,577; 6,855,865; 6,777,592 and 7,238,781.

(T) Genes conferring resistance to nematodes. See, e.g., PCT Application WO 1996/30517; PCT Application WO 1993/19181, WO 2003/033651 and Urwin, et al., (1998) Planta 204:472-479, Williamson, (1999) Curr Opin Plant Bio. 2(4):327-31; U.S. Pat. Nos. 6,284,948 and 7,301,069 and miR164 genes (WO 2012/058266).

(U) Genes that confer resistance to Phytophthora Root Rot, such as the Rps 1, Rps 1-a, Rps 1-b, Rps 1-c, Rps 1-d, Rps 1-e, Rps 1-k, Rps 2, Rps 3-a, Rps 3-b, Rps 3-c, Rps 4, Rps 5, Rps 6, Rps 7 and other Rps genes. See, for example, Shoemaker, et al., Phytophthora Root Rot Resistance Gene Mapping in Soybean, Plant Genome IV Conference, San Diego, Calif. (1995).

(V) Genes that confer resistance to Brown Stem Rot, such as described in U.S. Pat. No. 5,689,035 and incorporated by reference for this purpose.

(W) Genes that confer resistance to Colletotrichum, such as described in US Patent Application Publication US 2009/0035765 and incorporated by reference for this purpose. This includes the Rcg locus that may be utilized as a single locus conversion.

2. Transgenes that Confer Resistance to a Herbicide:

(A) A polynucleotide encoding resistance to a herbicide that inhibits the growing point or meristem, such as an imidazolinone or a sulfonylurea. Exemplary genes in this category code for mutant ALS and AHAS enzyme as described, for example, by Lee, et al., (1988) EMBO J. 7:1241 and Miki, et al., (1990) Theor. Appl. Genet. 80:449, respectively. See also, U.S. Pat. Nos. 5,605,011; 5,013,659; 5,141,870; 5,767,361; 5,731,180; 5,304,732; 4,761,373; 5,331,107; 5,928,937 and 5,378,824; U.S. patent application Ser. No. 11/683,737 and International Publication WO 1996/33270.

(B) A polynucleotide encoding a protein for resistance to Glyphosate (resistance imparted by mutant 5-enolpyruvl-3-phosphikimate synthase (EPSP) and aroA genes, respectively) and other phosphono compounds such as glufosinate (phosphinothricin acetyl transferase (PAT) and Streptomyces hygroscopicus phosphinothricin acetyl transferase (bar) genes), and pyridinoxy or phenoxy proprionic acids and cyclohexones (ACCase inhibitor-encoding genes). See, for example, U.S. Pat. No. 4,940,835 to Shah, et al., which discloses the nucleotide sequence of a form of EPSPS which can confer glyphosate resistance. U.S. Pat. No. 5,627,061 to Barry, et al., also describes genes encoding EPSPS enzymes. See also, U.S. Pat. Nos. 6,566,587; 6,338,961; 6,248,876 B1; 6,040,497; 5,804,425; 5,633,435; 5,145,783; 4,971,908; 5,312,910; 5,188,642; 5,094,945, 4,940,835; 5,866,775; 6,225,114 B1; 6,130,366; 5,310,667; 4,535,060; 4,769,061; 5,633,448; 5,510,471; Re. 36,449; RE 37,287 E and 5,491,288 and International Publications EP 1173580; WO 2001/66704; EP 1173581 and EP 1173582, which are incorporated herein by reference for this purpose. Glyphosate resistance is also imparted to plants that express a gene encoding a glyphosate oxido-reductase enzyme as described more fully in U.S. Pat. Nos. 5,776,760 and 5,463,175, which are incorporated herein by reference for this purpose. In addition glyphosate resistance can be imparted to plants by the over expression of genes encoding glyphosate N-acetyltransferase. See, for example, U.S. Pat. Nos. 7,462,481; 7,405,074 and US Patent Application Publication Number US 2008/0234130. A DNA molecule encoding a mutant aroA gene can be obtained under ATCC Accession Number 39256, and the nucleotide sequence of the mutant gene is disclosed in U.S. Pat. No. 4,769,061 to Comai. EP Application Number 0 333 033 to Kumada, et al., and U.S. Pat. No. 4,975,374 to Goodman, et al., disclose nucleotide sequences of glutamine synthetase genes which confer resistance to herbicides such as L-phosphinothricin. The nucleotide sequence of a phosphinothricin-acetyl-transferase gene is provided in EP Application Numbers 0 242 246 and 0 242 236 to Leemans, et al.,; De Greef, et al., (1989) Bio/Technology 7:61, describe the production of transgenic plants that express chimeric bar genes coding for phosphinothricin acetyl transferase activity. See also, U.S. Pat. Nos. 5,969,213; 5,489,520; 5,550,318; 5,874,265; 5,919,675; 5,561,236; 5,648,477; 5,646,024; 6,177,616 B1 and 5,879,903, which are incorporated herein by reference for this purpose. Exemplary genes conferring resistance to phenoxy proprionic acids and cyclohexones, such as sethoxydim and haloxyfop, are the Acc1-S1, Acc1-S2 and Acc1-S3 genes described by Marshall, et al., (1992) Theor. Appl. Genet. 83:435.

(C) A polynucleotide encoding a protein for resistance to herbicide that inhibits photosynthesis, such as a triazine (psbA and gs+genes) and a benzonitrile (nitrilase gene). Przibilla, et al., (1991) Plant Cell 3:169, describe the transformation of Chlamydomonas with plasmids encoding mutant psbA genes. Nucleotide sequences for nitrilase genes are disclosed in U.S. Pat. No. 4,810,648 to Stalker and DNA molecules containing these genes are available under ATCC Accession Numbers 53435, 67441 and 67442. Cloning and expression of DNA coding for a glutathione S-transferase is described by Hayes, et al., (1992) Biochem. J. 285:173.

(D) A polynucleotide encoding a protein for resistance to Acetohydroxy acid synthase, which has been found to make plants that express this enzyme resistant to multiple types of herbicides, has been introduced into a variety of plants (see, e.g., Hattori, et al., (1995) Mol Gen Genet. 246:419). Other genes that confer resistance to herbicides include: a gene encoding a chimeric protein of rat cytochrome P4507A1 and yeast NADPH-cytochrome P450 oxidoreductase (Shiota, et al., (1994) Plant Physiol 106:17), genes for glutathione reductase and superoxide dismutase (Aono, et al., (1995) Plant Cell Physiol 36:1687) and genes for various phosphotransferases (Datta, et al., (1992) Plant Mol Biol 20:619).

(E) A polynucleotide encoding resistance to a herbicide targeting Protoporphyrinogen oxidase (protox) which is necessary for the production of chlorophyll. The protox enzyme serves as the target for a variety of herbicidal compounds. These herbicides also inhibit growth of all the different species of plants present, causing their total destruction. The development of plants containing altered protox activity which are resistant to these herbicides are described in U.S. Pat. Nos. 6,288,306 B1; 6,282,837 B1 and 5,767,373 and International Publication WO 2001/12825.

(F) The aad-1 gene (originally from Sphingobium herbicidovorans) encodes the aryloxyalkanoate dioxygenase (AAD-1) protein. The trait confers tolerance to 2,4-dichlorophenoxyacetic acid and aryloxyphenoxypropionate (commonly referred to as “fop” herbicides such as quizalofop) herbicides. The aad-1 gene, itself, for herbicide tolerance in plants was first disclosed in WO 2005/107437 (see also, US 2009/0093366). The aad-12 gene, derived from Delftia acidovorans, which encodes the aryloxyalkanoate dioxygenase (AAD-12) protein that confers tolerance to 2,4-dichlorophenoxyacetic acid and pyridyloxyacetate herbicides by deactivating several herbicides with an aryloxyalkanoate moiety, including phenoxy auxin (e.g., 2,4-D, MCPA), as well as pyridyloxy auxins (e.g., fluoroxypyr, triclopyr).

(G) A polynucleotide encoding a herbicide resistant dicamba monooxygenase disclosed in US Patent Application Publication 2003/0135879 for imparting dicamba tolerance;

(H) A polynucleotide molecule encoding bromoxynil nitrilase (Bxn) disclosed in U.S. Pat. No. 4,810,648 for imparting bromoxynil tolerance;

(I) A polynucleotide molecule encoding phytoene (crtl) described in Misawa, et al., (1993) Plant J. 4:833-840 and in Misawa, et al., (1994) Plant J. 6:481-489 for norflurazon tolerance.

3. Transgenes Conferring or Contributing to an Altered Grain Characteristic

(A) Altered fatty acids, for example, by

(1) Down-regulation of stearoyl-ACP to increase stearic acid content of the plant. See, Knultzon, et al., (1992) Proc. Natl. Acad. Sci. USA 89:2624 and WO 1999/64579 (Genes to Alter Lipid Profiles in Corn).

(2) Elevating oleic acid via FAD-2 gene modification and/or decreasing linolenic acid via FAD-3 gene modification (see, U.S. Pat. Nos. 6,063,947; 6,323,392; 6,372,965 and WO 1993/11245).

(3) Altering conjugated linolenic or linoleic acid content, such as in WO 2001/12800.

(4) Altering LEC1, AGP, Dekl, Superall, mil ps, various Ipa genes such as Ipa1, Ipa3, hpt or hggt. For example, see, WO 2002/42424, WO 1998/22604, WO 2003/011015, WO 2002/057439, WO 2003/011015, U.S. Pat. Nos. 6,423,886, 6,197,561, 6,825,397 and US Patent Application Publication Numbers US 2003/0079247, US 2003/0204870 and Rivera-Madrid, et al., (1995) Proc. Natl. Acad. Sci. 92:5620-5624.

(5) Genes encoding delta-8 desaturase for making long-chain polyunsaturated fatty acids (U.S. Pat. No. 8,058,571), delta-9 desaturase for lowering saturated fats (U.S. Pat. No. 8,063,269), Primula Δ6-desaturase for improving omega-3 fatty acid profiles.

(6) Isolated nucleic acids and proteins associated with lipid and sugar metabolism regulation, in particular, lipid metabolism protein (LMP) used in methods of producing transgenic plants and modulating levels of seed storage compounds including lipids, fatty acids, starches or seed storage proteins and use in methods of modulating the seed size, seed number, seed weights, root length and leaf size of plants (EP 2404499).

(7) Altering expression of a High-Level Expression of Sugar-Inducible 2 (HSI2) protein in the plant to increase or decrease expression of HSI2 in the plant. Increasing expression of HSI2 increases oil content while decreasing expression of HSI2 decreases abscisic acid sensitivity and/or increases drought resistance (US Patent Application Publication Number 2012/0066794).

(B) Altered phosphorus content, for example, by the

(1) Introduction of a phytase-encoding gene would enhance breakdown of phytate, adding more free phosphate to the transformed plant. For example, see, Van Hartingsveldt, et al., (1993) Gene 127:87, for a disclosure of the nucleotide sequence of an Aspergillus niger phytase gene.

(2) Modulating a gene that reduces phytate content. In maize, this, for example, could be accomplished, by cloning and then re-introducing DNA associated with one or more of the alleles, such as the LPA alleles, identified in maize mutants characterized by low levels of phytic acid, such as in WO 2005/113778 and/or by altering inositol kinase activity as in WO 2002/059324, US Patent Application Publication Number 2003/0009011, WO 2003/027243, US Patent Application Publication Number 2003/0079247, WO 1999/05298, U.S. Pat. No. 6,197,561, U.S. Pat. No. 6,291,224, U.S. Pat. No. 6,391,348, WO 2002/059324, US Patent Application Publication Number 2003/0079247, WO 1998/45448, WO 1999/55882, WO 2001/04147.

(C) Altered carbohydrates affected, for example, by altering a gene for an enzyme that affects the branching pattern of starch or, a gene altering thioredoxin such as NTR and/or TRX (see, U.S. Pat. No. 6,531,648. which is incorporated by reference for this purpose) and/or a gamma zein knock out or mutant such as cs27 or TUSC27 or en27 (see, U.S. Pat. No. 6,858,778 and US Patent Application Publication Number 2005/0160488, US Patent Application Publication Number 2005/0204418, which are incorporated by reference for this purpose). See, Shiroza, et al., (1988) J. Bacteriol. 170:810 (nucleotide sequence of Streptococcus mutant fructosyltransferase gene), Steinmetz, et al., (1985) Mol. Gen. Genet. 200:220 (nucleotide sequence of Bacillus subtilis levansucrase gene), Pen, et al., (1992) Bio/Technology 10:292 (production of transgenic plants that express Bacillus licheniformis alpha-amylase), Elliot, et al., (1993) Plant Molec. Biol. 21:515 (nucleotide sequences of tomato invertase genes), Søgaard, et al., (1993) J. Biol. Chem. 268:22480 (site-directed mutagenesis of barley alpha-amylase gene) and Fisher, et al., (1993) Plant Physiol. 102:1045 (maize endosperm starch branching enzyme II), WO 1999/10498 (improved digestibility and/or starch extraction through modification of UDP-D-xylose 4-epimerase, Fragile 1 and 2, Ref1, HCHL, C4H), U.S. Pat. No. 6,232,529 (method of producing high oil seed by modification of starch levels (AGP)). The fatty acid modification genes mentioned herein may also be used to affect starch content and/or composition through the interrelationship of the starch and oil pathways.

(D) Altered antioxidant content or composition, such as alteration of tocopherol or tocotrienols. For example, see, U.S. Pat. No. 6,787,683, US Patent Application Publication Number 2004/0034886 and WO 2000/68393 involving the manipulation of antioxidant levels and WO 2003/082899 through alteration of a homogentisate geranyl geranyl transferase (hggt).

(E) Altered essential seed amino acids. For example, see, U.S. Pat. No. 6,127,600 (method of increasing accumulation of essential amino acids in seeds), U.S. Pat. No. 6,080,913 (binary methods of increasing accumulation of essential amino acids in seeds), U.S. Pat. No. 5,990,389 (high lysine), WO 1999/40209 (alteration of amino acid compositions in seeds), WO 1999/29882 (methods for altering amino acid content of proteins), U.S. Pat. No. 5,850,016 (alteration of amino acid compositions in seeds), WO 1998/20133 (proteins with enhanced levels of essential amino acids), U.S. Pat. No. 5,885,802 (high methionine), U.S. Pat. No. 5,885,801 (high threonine), U.S. Pat. No. 6,664,445 (plant amino acid biosynthetic enzymes), U.S. Pat. No. 6,459,019 (increased lysine and threonine), U.S. Pat. No. 6,441,274 (plant tryptophan synthase beta subunit), U.S. Pat. No. 6,346,403 (methionine metabolic enzymes), U.S. Pat. No. 5,939,599 (high sulfur), U.S. Pat. No. 5,912,414 (increased methionine), WO 1998/56935 (plant amino acid biosynthetic enzymes), WO 1998/45458 (engineered seed protein having higher percentage of essential amino acids), WO 1998/42831 (increased lysine), U.S. Pat. No. 5,633,436 (increasing sulfur amino acid content), U.S. Pat. No. 5,559,223 (synthetic storage proteins with defined structure containing programmable levels of essential amino acids for improvement of the nutritional value of plants), WO 1996/01905 (increased threonine), WO 1995/15392 (increased lysine), US Patent Application Publication Number 2003/0163838, US Patent Application Publication Number 2003/0150014, US Patent Application Publication Number 2004/0068767, U.S. Pat. No. 6,803,498, WO 2001/79516.

4. Genes Creating a Site for Site-Specific DNA Integration.

This includes the introduction of FRT sites that may be used in the FLP/FRT system and/or Lox sites that may be used in the Cre/Loxp system. For example, see, Lyznik, et al., (2003) Plant Cell Rep 21:925-932 and WO 1999/25821, which are hereby incorporated by reference. Other systems that may be used include the Gin recombinase of phage Mu (Maeser, et al., (1991) Vicki Chandler, The Maize Handbook ch. 118 (Springer-Verlag 1994), the Pin recombinase of E. coli (Enomoto, et al., 1983) and the R/RS system of the pSRi plasmid (Araki, et al., 1992).

5. Genes Affecting Abiotic Stress Resistance

Including but not limited to flowering, ear and seed development, enhancement of nitrogen utilization efficiency, altered nitrogen responsiveness, drought resistance or tolerance, cold resistance or tolerance and salt resistance or tolerance and increased yield under stress.

(A) For example, see: WO 2000/73475 where water use efficiency is altered through alteration of malate; U.S. Pat. Nos. 5,892,009, 5,965,705, 5,929,305, 5,891,859, 6,417,428, 6,664,446, 6,706,866, 6,717,034, 6,801,104, WO 2000/060089, WO 2001/026459, WO 2001/035725, WO 2001/034726, WO 2001/035727, WO 2001/036444, WO 2001/036597, WO 2001/036598, WO 2002/015675, WO 2002/017430, WO 2002/077185, WO 2002/079403, WO 2003/013227, WO 2003/013228, WO 2003/014327, WO 2004/031349, WO 2004/076638, WO 199809521.

(B) WO 199938977 describing genes, including CBF genes and transcription factors effective in mitigating the negative effects of freezing, high salinity and drought on plants, as well as conferring other positive effects on plant phenotype.

(C) US Patent Application Publication Number 2004/0148654 and WO 2001/36596 where abscisic acid is altered in plants resulting in improved plant phenotype such as increased yield and/or increased tolerance to abiotic stress.

(D) WO 2000/006341, WO 2004/090143, U.S. Pat. Nos. 7,531,723 and 6,992,237 where cytokinin expression is modified resulting in plants with increased stress tolerance, such as drought tolerance, and/or increased yield. Also see, WO 2002/02776, WO 2003/052063, JP 2002/281975, U.S. Pat. No. 6,084,153, WO 2001/64898, U.S. Pat. No. 6,177,275 and U.S. Pat. No. 6,107,547 (enhancement of nitrogen utilization and altered nitrogen responsiveness).

(E) For ethylene alteration, see, US Patent Application Publication Number 2004/0128719, US Patent Application Publication Number 2003/0166197 and WO 2000/32761.

(F) For plant transcription factors or transcriptional regulators of abiotic stress, see, e.g., US Patent Application Publication Number 2004/0098764 or US Patent Application Publication Number 2004/0078852.

(G) Genes that increase expression of vacuolar pyrophosphatase such as AVP1 (U.S. Pat. No. 8,058,515) for increased yield; nucleic acid encoding a HSFA4 or a HSFA5 (Heat Shock Factor of the class A4 or A5) polypeptides, an oligopeptide transporter protein (OPT4-like) polypeptide; a plastochron2-like (PLA2-like) polypeptide or a Wuschel related homeobox 1-like (WOX1-like) polypeptide (U.S. Patent Application Publication Number US 2011/0283420).

(H) Down regulation of polynucleotides encoding poly (ADP-ribose) polymerase (PARP) proteins to modulate programmed cell death (U.S. Pat. No. 8,058,510) for increased vigor.

(I) Polynucleotide encoding DTP21 polypeptides for conferring drought resistance (US Patent Application Publication Number US 2011/0277181).

(J) Nucleotide sequences encoding ACC Synthase 3 (ACS3) proteins for modulating development, modulating response to stress, and modulating stress tolerance (US Patent Application Publication Number US 2010/0287669).

(K) Polynucleotides that encode proteins that confer a drought tolerance phenotype (DTP) for conferring drought resistance (WO 2012/058528).

Other genes and transcription factors that affect plant growth and agronomic traits such as yield, flowering, plant growth and/or plant structure, can be introduced or introgressed into plants, see e.g., WO 1997/49811 (LHY), WO 1998/56918 (ESD4), WO 1997/10339 and U.S. Pat. No. 6,573,430 (TFL), U.S. Pat. No. 6,713,663 (FT), WO 1996/14414 (CON), WO 1996/38560, WO 2001/21822 (VRN1), WO 2000/44918 (VRN2), WO 1999/49064 (GI), WO 2000/46358 (FR1), WO 1997/29123, U.S. Pat. No. 6,794,560, U.S. Pat. No. 6,307,126 (GAI), WO 1999/09174 (D8 and Rht) and WO 2004/076638 and WO 2004/031349 (transcription factors).

6. Genes Conferring Increased Yield

(A) A transgenic crop plant transformed by a 1-AminoCyclopropane-1-Carboxylate Deaminase-like Polypeptide (ACCDP) coding nucleic acid, wherein expression of the nucleic acid sequence in the crop plant results in the plant's increased root growth, and/or increased yield, and/or increased tolerance to environmental stress as compared to a wild type variety of the plant (U.S. Pat. No. 8,097,769).

(B) Over-expression of maize zinc finger protein gene (Zm-ZFP1) using a seed preferred promoter has been shown to enhance plant growth, increase kernel number and total kernel weight per plant (US Patent Application Publication Number 2012/0079623).

(C) Constitutive over-expression of maize lateral organ boundaries (LOB) domain protein (Zm-LOBDP1) has been shown to increase kernel number and total kernel weight per plant (US Patent Application Publication Number 2012/0079622).

(D) Enhancing yield-related traits in plants by modulating expression in a plant of a nucleic acid encoding a VIM1 (Variant in Methylation 1)-like polypeptide or a VTC2-like (GDP-L-galactose phosphorylase) polypeptide or a DUF1685 polypeptide or an ARF6-like (Auxin Responsive Factor) polypeptide (WO 2012/038893).

(E) Modulating expression in a plant of a nucleic acid encoding a Ste20-like polypeptide or a homologue thereof gives plants having increased yield relative to control plants (EP 2431472).

7. Gene Silencing

In some embodiments the stacked trait may be in the form of silencing of one or more polynucleotides of interest resulting in suppression of one or more target pest polypeptides. In some embodiments the silencing is achieved through the use of a suppression DNA construct.

In some embodiments one or more polynucleotides encoding the polypeptides or fragments or variants thereof may be stacked with one or more polynucleotides encoding one or more polypeptides having insecticidal activity or agronomic traits as set forth supra and optionally may further include one or more polynucleotides providing for gene silencing of one or more target polynucleotides as discussed infra.

“Suppression DNA construct” is a recombinant DNA construct which when transformed or stably integrated into the genome of the plant, results in “silencing” of a target gene in the plant. The target gene may be endogenous or transgenic to the plant. “Silencing,” as used herein with respect to the target gene, refers generally to the suppression of levels of mRNA or protein/enzyme expressed by the target gene, and/or the level of the enzyme activity or protein functionality. The term “suppression” includes lower, reduce, decline, decrease, inhibit, eliminate and prevent. “Silencing” or “gene silencing” does not specify mechanism and is inclusive, and not limited to, anti-sense, cosuppression, viral-suppression, hairpin suppression, stem-loop suppression, RNAi-based approaches and small RNA-based approaches.

A suppression DNA construct may comprise a region derived from a target gene of interest and may comprise all or part of the nucleic acid sequence of the sense strand (or antisense strand) of the target gene of interest. Depending upon the approach to be utilized, the region may be 100% identical or less than 100% identical (e.g., at least 50% or any integer between 51% and 100% identical) to all or part of the sense strand (or antisense strand) of the gene of interest.

Suppression DNA constructs are well-known in the art, are readily constructed once the target gene of interest is selected, and include, without limitation, cosuppression constructs, antisense constructs, viral-suppression constructs, hairpin suppression constructs, stem-loop suppression constructs, double-stranded RNA-producing constructs, and more generally, RNAi (RNA interference) constructs and small RNA constructs such as siRNA (short interfering RNA) constructs and miRNA (microRNA) constructs.

“Antisense inhibition” refers to the production of antisense RNA transcripts capable of suppressing the expression of the target protein.

“Antisense RNA” refers to an RNA transcript that is complementary to all or part of a target primary transcript or mRNA and that blocks the expression of a target isolated nucleic acid fragment (U.S. Pat. No. 5,107,065). The complementarity of an antisense RNA may be with any part of the specific gene transcript, i.e., at the 5′ non-coding sequence, 3′ non-coding sequence, introns or the coding sequence.

“Cosuppression” refers to the production of sense RNA transcripts capable of suppressing the expression of the target protein. “Sense” RNA refers to RNA transcript that includes the mRNA and can be translated into protein within a cell or in vitro. Cosuppression constructs in plants have been previously designed by focusing on overexpression of a nucleic acid sequence having homology to a native mRNA, in the sense orientation, which results in the reduction of all RNA having homology to the overexpressed sequence (see, Vaucheret, et al., (1998) Plant J. 16:651-659 and Gura, (2000) Nature 404:804-808).

Another variation describes the use of plant viral sequences to direct the suppression of proximal mRNA encoding sequences (PCT Publication WO 1998/36083).

Recent work has described the use of “hairpin” structures that incorporate all or part, of an mRNA encoding sequence in a complementary orientation that results in a potential “stem-loop” structure for the expressed RNA (PCT Publication WO 1999/53050). In this case the stem is formed by polynucleotides corresponding to the gene of interest inserted in either sense or anti-sense orientation with respect to the promoter and the loop is formed by some polynucleotides of the gene of interest, which do not have a complement in the construct. This increases the frequency of cosuppression or silencing in the recovered transgenic plants. For review of hairpin suppression, see, Wesley, et al., (2003) Methods in Molecular Biology, Plant Functional Genomics: Methods and Protocols 236:273-286.

A construct where the stem is formed by at least 30 nucleotides from a gene to be suppressed and the loop is formed by a random nucleotide sequence has also effectively been used for suppression (PCT Publication WO 1999/61632).

The use of poly-T and poly-A sequences to generate the stem in the stem-loop structure has also been described (PCT Publication WO 2002/00894).

Yet another variation includes using synthetic repeats to promote formation of a stem in the stem-loop structure. Transgenic organisms prepared with such recombinant DNA fragments have been shown to have reduced levels of the protein encoded by the nucleotide fragment forming the loop as described in PCT Publication WO 2002/00904.

RNA interference refers to the process of sequence-specific post-transcriptional gene silencing in animals mediated by short interfering RNAs (siRNAs) (Fire, et al., (1998) Nature 391:806). The corresponding process in plants is commonly referred to as post-transcriptional gene silencing (PTGS) or RNA silencing and is also referred to as quelling in fungi. The process of post-transcriptional gene silencing is thought to be an evolutionarily-conserved cellular defense mechanism used to prevent the expression of foreign genes and is commonly shared by diverse flora and phyla (Fire, et al., (1999) Trends Genet. 15:358). Such protection from foreign gene expression may have evolved in response to the production of double-stranded RNAs (dsRNAs) derived from viral infection or from the random integration of transposon elements into a host genome via a cellular response that specifically destroys homologous single-stranded RNA of viral genomic RNA. The presence of dsRNA in cells triggers the RNAi response through a mechanism that has yet to be fully characterized.

The presence of long dsRNAs in cells stimulates the activity of a ribonuclease III enzyme referred to as dicer. Dicer is involved in the processing of the dsRNA into short pieces of dsRNA known as short interfering RNAs (siRNAs) (Berstein, et al., (2001) Nature 409:363). Short interfering RNAs derived from dicer activity are typically about 21 to about 23 nucleotides in length and comprise about 19 base pair duplexes (Elbashir, et al., (2001) Genes Dev. 15:188). Dicer has also been implicated in the excision of 21- and 22-nucleotide small temporal RNAs (stRNAs) from precursor RNA of conserved structure that are implicated in translational control (Hutvagner, et al., (2001) Science 293:834). The RNAi response also features an endonuclease complex, commonly referred to as an RNA-induced silencing complex (RISC), which mediates cleavage of single-stranded RNA having sequence complementarity to the antisense strand of the siRNA duplex. Cleavage of the target RNA takes place in the middle of the region complementary to the antisense strand of the siRNA duplex (Elbashir, et al., (2001) Genes Dev. 15:188). In addition, RNA interference can also involve small RNA (e.g., miRNA) mediated gene silencing, presumably through cellular mechanisms that regulate chromatin structure and thereby prevent transcription of target gene sequences (see, e.g., Allshire, (2002) Science 297:1818-1819; Volpe, et al., (2002) Science 297:1833-1837; Jenuwein, (2002) Science 297:2215-2218 and Hall, et al., (2002) Science 297:2232-2237). As such, miRNA molecules of the invention can be used to mediate gene silencing via interaction with RNA transcripts or alternately by interaction with particular gene sequences, wherein such interaction results in gene silencing either at the transcriptional or post-transcriptional level.

Methods and compositions are further provided which allow for an increase in RNAi produced from the silencing element. In such embodiments, the methods and compositions employ a first polynucleotide comprising a silencing element for a target pest sequence operably linked to a promoter active in the plant cell; and, a second polynucleotide comprising a suppressor enhancer element comprising the target pest sequence or an active variant or fragment thereof operably linked to a promoter active in the plant cell. The combined expression of the silencing element with suppressor enhancer element leads to an increased amplification of the inhibitory RNA produced from the silencing element over that achievable with only the expression of the silencing element alone. In addition to the increased amplification of the specific RNAi species itself, the methods and compositions further allow for the production of a diverse population of RNAi species that can enhance the effectiveness of disrupting target gene expression. As such, when the suppressor enhancer element is expressed in a plant cell in combination with the silencing element, the methods and composition can allow for the systemic production of RNAi throughout the plant; the production of greater amounts of RNAi than would be observed with just the silencing element construct alone; and, the improved loading of RNAi into the phloem of the plant, thus providing better control of phloem feeding insects by an RNAi approach. Thus, the various methods and compositions provide improved methods for the delivery of inhibitory RNA to the target organism. See, for example, US Patent Application Publication 2009/0188008.

As used herein, a “suppressor enhancer element” comprises a polynucleotide comprising the target sequence to be suppressed or an active fragment or variant thereof. It is recognize that the suppressor enhancer element need not be identical to the target sequence, but rather, the suppressor enhancer element can comprise a variant of the target sequence, so long as the suppressor enhancer element has sufficient sequence identity to the target sequence to allow for an increased level of the RNAi produced by the silencing element over that achievable with only the expression of the silencing element. Similarly, the suppressor enhancer element can comprise a fragment of the target sequence, wherein the fragment is of sufficient length to allow for an increased level of the RNAi produced by the silencing element over that achievable with only the expression of the silencing element.

It is recognized that multiple suppressor enhancer elements from the same target sequence or from different target sequences or from different regions of the same target sequence can be employed. For example, the suppressor enhancer elements employed can comprise fragments of the target sequence derived from different region of the target sequence (i.e., from the 3′UTR, coding sequence, intron, and/or 5′UTR). Further, the suppressor enhancer element can be contained in an expression cassette, as described elsewhere herein, and in specific embodiments, the suppressor enhancer element is on the same or on a different DNA vector or construct as the silencing element. The suppressor enhancer element can be operably linked to a promoter. It is recognized that the suppressor enhancer element can be expressed constitutively or alternatively, it may be produced in a stage-specific manner employing the various inducible or tissue-preferred or developmentally regulated promoters that are discussed elsewhere herein.

In specific embodiments, employing both a silencing element and the suppressor enhancer element the systemic production of RNAi occurs throughout the entire plant. In further embodiments, the plant or plant parts of the invention have an improved loading of RNAi into the phloem of the plant than would be observed with the expression of the silencing element construct alone and, thus provide better control of phloem feeding insects by an RNAi approach. In specific embodiments, the plants, plant parts and plant cells of the invention can further be characterized as allowing for the production of a diversity of RNAi species that can enhance the effectiveness of disrupting target gene expression.

In specific embodiments, the combined expression of the silencing element and the suppressor enhancer element increases the concentration of the inhibitory RNA in the plant cell, plant, plant part, plant tissue or phloem over the level that is achieved when the silencing element is expressed alone.

As used herein, an “increased level of inhibitory RNA” comprises any statistically significant increase in the level of RNAi produced in a plant having the combined expression when compared to an appropriate control plant. For example, an increase in the level of RNAi in the plant, plant part or the plant cell can comprise at least about a 1%, about a 1%-5%, about a 5%-10%, about a 10%-20%, about a 20%-30%, about a 30%-40%, about a 40%-50%, about a 50%-60%, about 60-70%, about 70%-80%, about a 80%-90%, about a 90%-100% or greater increase in the level of RNAi in the plant, plant part, plant cell or phloem when compared to an appropriate control. In other embodiments, the increase in the level of RNAi in the plant, plant part, plant cell or phloem can comprise at least about a 1 fold, about a 1 fold-5 fold, about a 5 fold-10 fold, about a 10 fold-20 fold, about a 20 fold-30 fold, about a 30 fold-40 fold, about a 40 fold-50 fold, about a 50 fold-60 fold, about 60 fold-70 fold, about 70 fold-80 fold, about a 80 fold-90 fold, about a 90 fold-100 fold or greater increase in the level of RNAi in the plant, plant part, plant cell or phloem when compared to an appropriate control. Examples of combined expression of the silencing element with suppressor enhancer element for the control of Stinkbugs and Lygus can be found in US Patent Application Publication 2011/0301223 and US Patent Application Publication 2009/0192117.

Some embodiments relate to down-regulation of expression of target genes in insect pest species by interfering ribonucleic acid (RNA) molecules. PCT Publication WO 2007/074405 describes methods of inhibiting expression of target genes in invertebrate pests including Colorado potato beetle. PCT Publication WO 2005/110068 describes methods of inhibiting expression of target genes in invertebrate pests including in particular Western corn rootworm as a means to control insect infestation. Furthermore, PCT Publication WO 2009/091864 describes compositions and methods for the suppression of target genes from insect pest species including pests from the Lygus genus. PCT Publication WO 2012/055982 describes ribonucleic acid (RNA or double stranded RNA) that inhibits or down regulates the expression of a target gene that encodes: an insect ribosomal protein such as the ribosomal protein L19, the ribosomal protein L40 or the ribosomal protein S27A; an insect proteasome subunit such as the Rpn6 protein, the Pros 25, the Rpn2 protein, the proteasome beta 1 subunit protein or the Pros beta 2 protein; an insect β-coatomer of the COP1 vesicle, the γ-coatomer of the COPI vesicle, the β′-coatomer protein or the ξ-coatomer of the COPI vesicle; an insect Tetraspanine 2 A protein which is a putative transmembrane domain protein; an insect protein belonging to the actin family such as Actin 5C; an insect ubiquitin-5E protein; an insect Sec23 protein which is a GTPase activator involved in intracellular protein transport; an insect crinkled protein which is an unconventional myosin which is involved in motor activity; an insect crooked neck protein which is involved in the regulation of nuclear alternative mRNA splicing; an insect vacuolar H+-ATPase G-subunit protein and an insect Tbp-1 such as Tat-binding protein.

“Drought” refers to a decrease in water availability to a plant that, especially when prolonged, can cause damage to the plant or prevent its successful growth (e.g., limiting plant growth or seed yield). “Drought tolerance” is a trait of a plant to survive under drought conditions over prolonged periods of time without exhibiting substantial physiological or physical deterioration. “Increased drought tolerance” of a plant is measured relative to a reference or control plant, and is a trait of the plant to survive under drought conditions over prolonged periods of time, without exhibiting the same degree of physiological or physical deterioration relative to the reference or control plant grown under similar drought conditions. Typically, when a transgenic plant comprising a recombinant DNA construct or suppression DNA construct in its genome exhibits increased drought tolerance relative to a reference or control plant, the reference or control plant does not comprise in its genome the recombinant DNA construct or suppression DNA construct.

One of ordinary skill in the art is familiar with protocols for simulating drought conditions and for evaluating drought tolerance of plants that have been subjected to simulated or naturally-occurring drought conditions. For example, one can simulate drought conditions by giving plants less water than normally required or no water over a period of time, and one can evaluate drought tolerance by looking for differences in physiological and/or physical condition, including (but not limited to) vigor, growth, size, or root length, or in particular, leaf color or leaf area size. Other techniques for evaluating drought tolerance include measuring chlorophyll fluorescence, photosynthetic rates and gas exchange rates.

A drought stress experiment may involve a chronic stress (i.e., slow dry down) and/or may involve two acute stresses (i.e., abrupt removal of water) separated by a day or two of recovery.

The regenerable plant tissue can be obtained from any plant species, including crops such as, but not limited to: a graminaceous plant, saccharum spp., saccharum spp. hybrids, sugarcane, miscanthus, switchgrass, energycane, sterile grasses, bamboo, cassava, rice, potato, sweet potato, yam, banana, pineapple, citrus, trees, willow, poplar, mulberry, ficus spp., oil palm, date palm, poaceae, verbena, vanilla, tea, hops, Erianthus spp., intergenic hybrids of Saccharum, Erianthus and Sorghum spp., African violet, date, fig, conifers, apple, guava, mango, maple, plum, pomegranate, papaya, avocado, blackberries, garden strawberry, grapes, canna, cannabis, lemon, orange, grapefruit, tangerine, dayap, maize, wheat, sorghum and cotton.

In one embodiment, the regenerable plant tissue used in the artificial seed can be from sugarcane. The regenerable plant tissue can be prepared using several methods including excision of meristems from the top of the sugarcane stalks, followed by tissue culture on solid or liquid media, or temporarily immersed in liquid nutrients and combinations thereof. In one embodiment, the regenerable sugarcane tissue can be prepared using tissue culture on a solid medium, followed by temporary immersion in liquid nutrient media.

The meristem tissue can be allowed to grow and proliferate using a proliferation medium. The proliferation medium can include, but is not limited to, culturing in various liquid nutrient media, culturing on solid media, temporary immersion in liquid nutrient media, and any variations thereof. In one embodiment, the proliferation medium used in the current method comprises MS nutrients and can additionally comprise ingredients not limited to: 30 g/L sucrose, one or more cytokinins, including 6-BAP, auxins, or combinations of cytokinin and auxin, with or without inhibitors of the plant hormone, gibberellin. However, other nutrient formulations such as the well known in the art Gamborg's B-5 medium, other carbon sources such as glucose and mannitol, other cytokinins, such as kinetin and zeatin can also be used.

The meristem tissues can be allowed to proliferate from about 3 weeks to about 52 weeks. The temperature used for proliferation can vary from about 15° C. to about 45° C. Temperature control for growth of the regenerable plant tissues can be achieved using constant temperature incubators as is well known in the relevant art.

Following growth of the meristem tissue, proliferated buds are formed which contain independent meristem structures capable of differentiating into shoots, and subsequently into well-formed plantlets at later stages. As used herein, “proliferated bud tissue” means a meristematic tissue with the capacity to multiply and self-regenerate into similar meristem structures. Over time, the base of this tissue, which was the original plant tissue, can blacken due to polyphenol production and can be removed by mechanical trimming methods well known in the relevant art.

During the steps described above, the meristem tissue can be subjected to light to allow for growth. The light intensity suitable for the current invention can be from 1 micro (μ) Einstein per square meter per second (μE/m²/s) to about 1500 (μE/m²/s). The light can be produced by various devices suitable for this purpose such as fluorescent bulbs, incandescent bulbs, the sun, plant growth bulbs and light emitting diodes (LEDs). The amount of light required for growth of the meristem tissue can vary from 1 hour photoperiod to 24 hours photoperiod. In an embodiment, a 16 hours photoperiod using 30 μE/m²/s can be used.

After the meristem tissue forms the proliferated bud tissue, it can then be cut into small pieces (fragmented) to form tissue fragments. These tissue fragments can be 0.5-10 mm in size. Alternatively, they can be 1-5 mm in size. These tissue fragments can then be cultured for 0-5 weeks further to form plantlets, which are suitable for encapsulation in the artificial seeds. The culturing processes to form the plantlets can include, but is not limited to, culturing in various liquid nutrient media, culturing on solid media, temporary immersion in liquid culture, and any variations thereof. The plantlets that are formed in these processes possess shoots, with or without roots.

Artificial seeds of the type described in the present invention comprise a container assembly. The container assembly may be prepared using any variety of materials disclosed above. In the present method, the regenerable plant tissue, which has been further cultivated to produce a plantlet may be used. The plantlet may be partially embedded into a nutrient-containing agar plug at the bottom of the container of the artificial seed such that part of the tissue (e.g., approximately 80%) is optionally exposed to the airspace above the nutrient source. Alternatively the plantlet can be placed such that between about 1% and 99.9% is exposed to the airspace. The plantlet can be oriented or not, and can be trimmed to fit inside the container. Alternately, the plantlet can be placed in a soil layer in the container, such that airspace is present above it.

In the present method it is desirable to create an airspace within the container. The purpose of the airspace is to allow rapid gas exchange with the plantlet, helping to sustain the tissue and allow it to grow. The container can possess porosity which can allow a rate of gas transport such that equilibrium can be maintained between the airspace and the outside environment. Thus, as the plantlet consumes or releases oxygen or carbon dioxide, due to either respiration or photosynthesis, these gases are rapidly equilibrated with the outside atmosphere. In addition, the exposure of the plantlet to the airspace fosters the development of tissue that is better adapted to the harsher conditions the plantlet can be exposed to once it emerges from the seed (for example reduced humidity, wind, higher light). In the artificial seed, the plantlet is exposed to less harsh conditions due to the protection of the container. In the present invention, the airspace is also transparent to visible light, which allows the plantlet to perform photosynthesis. The airspace can also provide some thermal insulation for the plantlet. The airspace may consist of multiple compartments. These compartments may be connected or adjoined and may be in communication with each other. The airspace inside the container artificial seed is at least 1% of the total volume of the container.

To prevent fungal contamination of the artificial seed, the container can be treated with a solution of a fungicide prior to its assembly. Many fungicides can be used for this purpose. Examples include, but are not limited to: Maxim® XL, Maxim® 4FS, Ridomil Gold®, Uniform®, Quilt®, amphotericin B, cycloheximide, nystatin, griseofulvin, pentachloronitrobenzene, thiabendazole, benomyl, 2-(thiocyanatomethylthio)-1,3-benzothiazole, carbendazim, fuberidazole, thiophanate, thiophanate-methyl, chlozolinate, iprodione, procymidone, vinclozolin, imazalil, oxpoconazole, pefurazoate, prochloraz, triflumizole, triforine, pyrifenox, fenarimol, nuarimol, azaconazole, bitertanol, bromuconazole, cyproconazole, difenoconazole, diniconazole, epoxiconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimefon, triadimenol, triticonazole, benalaxyl, furalaxyl, metalaxyl, metalaxyl-M (mefenoxam), oxadixyl, ofurace, aldimorph, dodemorph, fenpropimorph, tridemorph, fenpropidin, piperalin, spiroxamine, edifenphos, iprobenfos, (IBP), pyrazophos, isoprothiolane, benodanil, flutolanil, mepronil, fenfuram, carboxin, oxycarboxin, thifluzamide, furametpyr, penthiopyrad, boscalid, bupirimate, dimethirimol, ethirimol, cyprodinil, mepanipyrim, pyrimethanil, diethofencarb, azoxystrobin, strobilurins, enestrobin, picoxystrobin, pyraclostrobin, kresoxim-methyl, trifloxystrobin, dimoxystrobin, metominostrobin, orysastrobin, famoxadone, fluoxastrobin, fenamidone, pyribencarb, fenpiclonil, fludioxonil, quinoxyfen, biphenyl, chloroneb, dicloran, quintozene (PCNB), tecnazene (TCNB), tolclofos-methyl, etridiazole, ethazole, fthalide, pyroquilon, tricyclazole, carpropamid, diclocymet, fenoxanil, fenhexamid, pyributicarb, naftifine, terbinafine, polyoxin, pencycuron, cyazofamid, amisulbrom, zoxamide, blasticidin-S, kasugamycin, streptomycin, streptomycin sulfate, validamycin, cymoxanil, iodocarb, propamocarb, prothiocarb, binapacryl, dinocap, ferimzone, fluazinam, fentin acetate, fentin chloride, fentin hydroxide, oxolinic acid, hymexazole, octhilinone, fosetyl-Al, phosphorous acid and salts, teclofthalam, triazoxide, flusulfamide, diclomezine, silthiofam, diflumetorim, dimethomorph, flumorph, benthiavalicarb, iprovalicarb, valiphenal, mandipropamid, oxytetracycline, methasulfocarb, fluopicolide, acibenzolar-S-methyl, probenazole, tiadinil, isotianil, ethaboxam, cyflufenamid, proquinazid, metrafenone, copper (different, salts), sulphur, ferbam, mancozeb, maneb, metiram, propineb, thiram, zineb, ziram, captan, captafol, folpet, chlorothalonil, dichlofluanid, tolylfluanid, dodine, guazatine, iminoctadine, anilazine, dithianon, mineral oils, organic oils, potassium bicarbonate, tridemorph anilinopyrimidines, antibiotics, cycloheximid, griseofulvin, dinitroconazole, etridazole, perfurazoate, 5-Chloro-7-(4-methyl-piperidin-1-yl)-6-(2,4,6-trifluoro-phenyl)-[1,2,4]tr-iazolo[1,5-a]pyrimidine, 2-Butoxy-6-iodo-3-propyl-chromen-4-one, 3-(3-Bromo-6-fluoro-2-methyl-indole-1-sulfonyl)-[1,2,4]triazole-1-sulfoni-c acid dimethylamide, nabam, metam, polycarbamate, dazomet, 3-[5-(4-Chloro-phenyl)-2,3-dimethyl-isoxazolidin-3-yl]-pyridine, Bordeaux mixture, copper acetate, copper hydroxide, copper oxychloride, basic copper sulfate, nitrophenyl derivatives, dinobuton, nitrophthalisopropyl phenylpyrroles, sulfur, sulfur organometallic compounds, phthalide, toloclofos-methyl, N-(2-{4-[3-(4-Chloro-phenyl)-prop-2-ynyloxy]-3-methoxy-phenyl}-ethyl)-2-m-ethanesulfonylamino-3-methyl-butyramide, N-(2-{4-[3-(4-Chloro-phenyl)-prop-2-ynyloxy]-3-methoxy-phenyl}-ethyl)-2-e-thanesulfonylamino-3-methyl-butyramide; 3,4-Dichloro-isothiazole-5-carboxylic acid(2-cyano-phenyl)-amide, Flubenthiavalicarb, 3-(4-Chloro-phenyl)-3-(2-isopropoxycarbonylamino-3-methyl-butyrylamino)-p-ropionic acid methyl ester, {2-Chloro-5-[1-(6-methyl-pyridin-2-ylmethoxyimino)-ethyl]-benzyl}-carbami-c acid methyl ester, {2-Chloro-5-[1-(3-methyl-benzyloxyimino)-ethyl]-benzyl}-carbamic acid methyl ester, hexachlorbenzene amides of following formula in which X is CHF2 or CH3; and R1, R2 are independently from each other halogen, methyl or halomethyl; enestroburin, sulfenic acid derivatives, cinnemamides and analogs such as, flumetover amide fungicides such as cyclofenamid or (Z)-N-[a-(cyclopropylmethoxyimino)-2,3-difluoro-6-(difluoromethoxy) benzyl]-2-phenylacetamide, thiabendozole, and triffumizole.

Additionally, the container may comprise one or more antimicrobials, including but not limited to: bleach, Plant Preservative Mixture™, quaternary ammonium or pyridinium salts, the copper salt of cyanoethylated sorbitol (as described in U.S. Pat. No. 6,978,724), silver salts and silver nanoparticles can be used. Additionally, the container may comprise one or more antibiotics, including but not limited to: cefotaxime, carbenicillin, chloramphenicols, tetracycline, erythromycin, kanamycin, neomycin sulfate, streptomycin sulfate, gentamicin sulfate, ampicillin, penicillin, ticarcillin, polymyxin-B and rifampicin chlorhexidine, chlorhexidine acetate, chlorhexidine gluconate, chlorhexidine hydrochloride, chlorhexidine sulfate, hexamethylene biguanides, oligo-hexamethyl biguanides, silver acetate, silver benzoate, silver carbonate, silver chloride, silver iodate, silver iodide, silver lactate, silver laurate, silver nitrate, silver oxide, silver palmitate, silver protein, silver sulfadiazine, polymyxin, tetracycline, tobramycin, gentamicin, rifampician, bacitracin, neomycin, chloramphenical, miconazole, tolnaftate, oxolinic acid, norfloxacin, nalidix acid, pefloxacin, enoxacin, ciprofloxacin, ampicillin, amoxicillin, piracil, vancomycin, polyhexamethylene biguanide, polyhexamethylene biguanide hydrochloride, polyhexamethylene biguanide hydrobromide, polyhexamethylene biguanide borate, polyhexamethylene biguanide acetate, polyhexamethylene biguanide gluconate, polyhexamethylene biguanide sulfonate, polyhexamethylene biguanide maleate, polyhexamethylene biguanide ascorbate, polyhexamethylene biguanide stearate, polyhexamethylene biguanide tartrate, polyhexamethylene biguanide citrate and combinations thereof.

In order to prevent insect damage, the artificial seed may also comprise one or more insecticides. Examples of suitable pesticidal compounds include, but are not limited to, abamectin, cyanoimine, acetamiprid, nitromethylene, nitenpyram, clothianidin, dimethoate, dinotefuran, fipronil, lufenuron, flubendamide, pyripfoxyfen, thiacloprid, fluxofenime, imidacloprid, thiamethoxam, beta cyfluthrin, fenoxycarb, lamda cyhalothrin, diafenthiuron, pymetrozine, diazinon, disulphoton; profenofos, furathiocarb, cyromazin, cypermethrin, tau-fluvalinate, tefluthrin, chlorantraniliprole, flonicamid, metaflumizone, spirotetramat, Bacillus thuringiensis products, azoxystrobin, acibenzolor s-methyl, bitertanol, carboxin, Cu₂O, cymoxanil, cyproconazole, cyprodinil, dichlofluamid, difenoconazole, diniconazole, epoxiconazole, fenpiclonil, fludioxonil, fluoxastrobin, fluquiconazole, flusilazole, flutriafol, furalaxyl, guazatin, hexaconazole, hymexazol, imazalil, imibenconazole, ipconazole, kresoxim-methyl, mancozeb, metalaxyl, R-metalaxyl, mefenoxam, metconazole, myclobutanil, oxadixyl, pefurazoate, paclobutrazole, penconazole, pencycuron, picoxystrobin, prochloraz, propiconazole, pyroquilone, SSF-109, spiroxamin, tebuconazole, thiabendazole, thiram, tolifluamide, triazoxide, triadimefon, triadimenol, trifloxystrobin, triflumizole, triticonazole, uniconazole.

The artificial seed may comprise other crop protection chemicals, including but not limited to nematicides, termiticides, molluscicides, miticides and acaricides.

In the process of artificial seed preparation and following addition of the plantlet, and in some cases, the nutrients, the opening in the container can be secured. A container can have more than one opening. Alternatively, a container can have a top opening and a bottom opening. Depending on the design and method of planting, optionally one or both openings can be secured. Identical materials can be used as closures for the top opening and the bottom opening of the container. Alternatively, different materials can be used as closures for securing the opening(s). Suitable materials to be used as closures or for the container in the disclosed invention include, but are not limited to: various types of paper, wax, Parafilm®, pre-stretched Parafilm®, biodegradable polymers including poly(lactide), poly(L-lactide), poly(D-lactide), poly(D,L-lactide), stereocomplexes of poly(L-lactide) with poly(D-lactide) and poly(hydroxyl alkanoate)s, natural and synthetic polymers including but not limited to poly(ethylene glycol), poly(acrylic acid) and its salts, poly(vinyl alcohol), poly(styrene), poly(alkyl (meth)acrylates), poly(vinyl acetate), poly(vinyl pyrollidinone), poly(vinyl pyridine), polyacrylamide, polycarbonate, epoxy resins, alkyd resins, polyolefins, photodegradable polymers, polyesters, polyamides, starch, gelatin, natural rubber, polysachharides including but not limited to alginate, carrageenan, cellulose, carboxymethylcellulose and its salts, xanthan gum, guar gum, zein, chitosan, locust bean gum, gum arabic, pectin, agar, agarose, crosslinked versions thereof, plasticized versions thereof, copolymers thereof and combinations thereof. In one embodiment, the closure or the container comprises, or alternatively consists of, bilayers or multilayers. A multilayer is defined as a structure possessing more than one layer. A bilayer is defined as a structure possessing two layers.

In one embodiment, the inner layer or layers consist of water insoluble substances which may also be moisture barriers. These layers are penetrable by the growing regenerable plant tissue. The outer layer or layers are water soluble or rapidly degradable and may be impenetrable by the regenerable plant tissue. In one embodiment, the outer layers serve to mechanically strengthen the artificial seed while being dissolvable through moisture, while the inner layers serve to protect the regenerable tissue from moisture loss while allowing it to escape at an appropriate growth stage.

In one embodiment, the closure or container can comprise gelatin or a water soluble protein. In another embodiment, the closure or container can comprise starch or a water soluble carbohydrate or polysaccharide, in yet another embodiment, the closure or container can comprise gelatin and starch. In yet another embodiment the closure or container can comprise gelatin and starch with a plasticizer. In yet another embodiment, the closure or container can comprise gelatin, starch and glycerol (FIG. 1).

The gelatin can be derived from various sources. Non-limiting examples include bovine skin, porcine skin, cattle bones or fish by-products. The starch can be various sources. Non-limiting examples include from roots, vegetables, potatoes, wheat, corn (maize), cassava. It can be derived from acorns, arrowroot, arracacha, bananas, barley, breadfruit, buckwheat, canna, colacasia, katakuri, kudzu, malanga, millet, oats, oca, polynesian arrowroot, sago, sorghum, sweet potatoes, rye, taro, chestnuts, water chestnuts and yams, and many kinds of beans, such as favas, lentils, mung beans, peas, and chickpeas. Components of starch, such as amylopectin and amylose, and related carbohydrates such as glycogen can also be utilized.

Plasticizers useful to be used in preparation of closures or the container for the artificial seed of the present invention can be glycerol, sorbitol, mannitol, sucrose, glucose, xylose, fructose, low molecular weight poly(ethylene glycols) or polypropylene glycols) or a combination thereof.

In another embodiment, the closure or container can comprise a water soluble or swellable film. The water soluble film can comprise poly(vinyl alcohol), poly(ethylene oxide), poly(N-vinyl pyrrolidone), poly(acrylic acid), poly(methacrylic acid), poly(acrylamide) and copolymers thereof. The water soluble film can also comprise cellulose, glycerol, poly(ethylene glycol), citric acid, urea, water, sodium acetate, potassium nitrate, ammonium nitrate, fertilizers, agar, xanthan gum, alginate, hydroxypropylcellulose, methylcellulose, carboxymethylcellulose, poly(acrylic acid), sodium polyacrylate, guar gum, pectin, a water soluble protein, a water soluble carbohydrate, gelatin, or sodium carboxymethylcellulose and blends or crosslinked versions thereof.

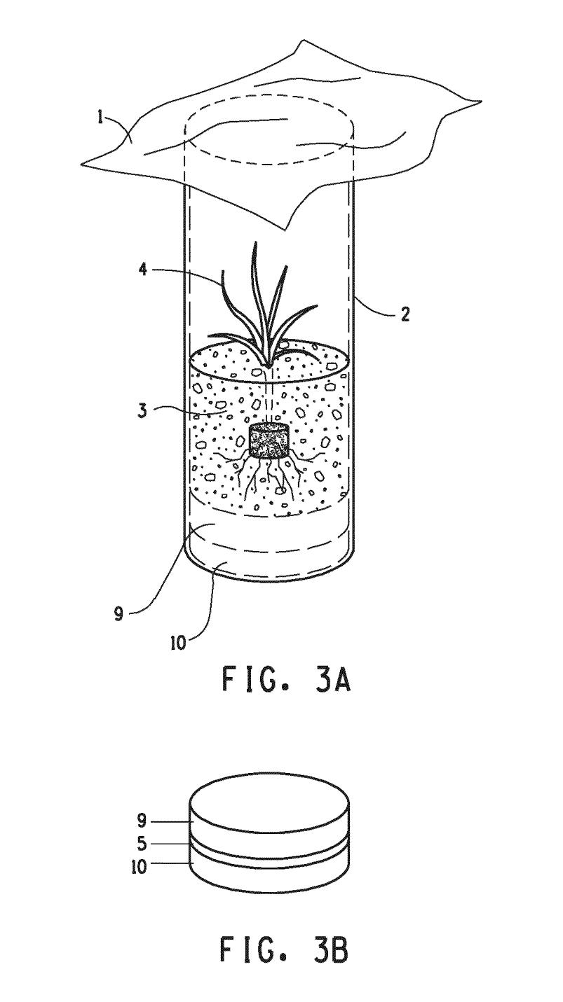

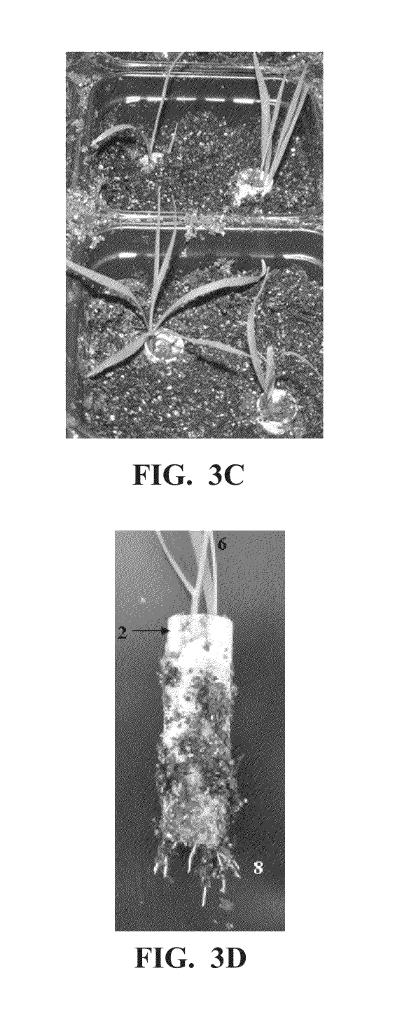

In the instant invention, when the closures comprise more than one layer or a multilayer, various parts of the closures for either the top opening or the bottom opening can be generated separately and then assembled together to make the final closure and the special architecture for the artificial seed. In the latter case (FIG. 3) various parts for the top and the bottom closures can be made of gelatin-starch-glycerol film (1). The gelatin-starch-glycerol film closure used for securing the top opening may be pre-stretched and provides a transparent closure for the top closure. The term “transparent closure” as used herein, refers to a film layer which allows the passage of light into the artificial seed container for the regenerable plant tissue in the container to grow. The bottom part of the closure, in addition to the gelatin-starch-glycerol film, can have additional layers such as a solid fat layer (9) to prevent contact of the soil moisture with the bottom gelatin-starch-glycerol film closure (10).

A closure suitable for the current invention can comprise a film layer comprised of gelatin, starch, glycerol and some remnant water. The gelatin-starch-glycerol film layer is prepared by evaporating an aqueous solution of gelatin, starch and glycerol. In this solution the concentration of gelatin can be from 0.5 wt % to 5 wt %. The concentration of starch can be from 0.1 wt % to 2 wt %. The concentration of glycerol can be from 2 wt % to 8 wt %. In one embodiment, the solution used to create the film can comprise 2.5 wt % Gelatin (175 Bloom Strength); 1.0 wt % starch and 5.0 wt % glycerol. In another embodiment, the film forming solution can comprise 1.25 wt % gelatin (175 Bloom Strength) and 1.25 wt % gelatin (300 Bloom Strength); 1.0 wt % starch and 5.0 wt % glycerol.

The closure or one of the layers of a multilayer closure or container useful in the current invention can contain oil. The oil suitable for application in the current invention has the following characteristics: it should melt between 30° C. to 38° C. and be solid at room temperature (from about 20° C. to about 25° C.). Various types of oil and triglycerides (fat) can be used. Non-limiting examples include butter, cocoa butter, palm oil, palm stearine and lard. In an embodiment, vegetable oil shortening, e.g., Crisco®, can be used. In another embodiment, the closure may be composed of an oil-gel. An oil-gel is defined as an oil that, through combination with one or more additives, does not flow over a finite range of temperature suitable for the application. In one embodiment, the oil-gel is formed by dissolving a compound in an oil at elevated temperature, and then cooling that solution to form a gel. Suitable oils include, but are not limited to, vegetable oil, castor oil, soybean oil, rapeseed oil, and mineral oil. Suitable compounds include, but are not limited to block polymers and associative, low molecular weight substances. Block polymers include, but are not limited to, styrenic block copolymers such as those sold under the trade name Kraton® (Kraton Polymers, Houston, Tex.), block copolymers of ethylene oxide and propylene oxide, such as those sold under the name Pluronic® (BASF, Ludwigshafen, Germany). Styrenic block copolymers include but are not limited to poly(styrene-b-isoprene-b-styrene), poly(styrene-b-butadiene-b-styrene) and hydrogenated versions thereof. Oil-gels suitable for this application will have mechanical properties weak enough to permit penetration by the growing regenerable plant tissue.

In one embodiment, the closure or container can comprise one or more layers of oil-gel and one or more layers of water soluble film. In this embodiment, the oil-gel layer prevents contact of the soil moisture with the bottom water soluble film layer. This preserves the structure of the artificial seed during storage. When the artificial seed is planted and irrigated, the water soluble film can dissolve, leaving behind the oil-gel, which allows the growth of the plant.

The closure or container useful in the current invention can contain additional one or more layers of paper (FIG. 3, 5). The paper suitable for application in preparation of the closure for the openings of the container in the current invention has the following characteristics: it is thicker and more durable than normal writing or printing paper, but thinner and more flexible than paperboard or cardboard. The paper should be able to retain its shape when it is punched through to create the proper size for inclusion in the seed architecture. The texture can be smooth, metallic, or glossy. Non-limiting examples include paper used for postcards, business cards, playing cards and scrapbooking paper. In an embodiment, card stock paper can be used.

Other materials such as wax-impregnated cheese cloth, wax-impregnated paper can also be included in preparation of the closures.

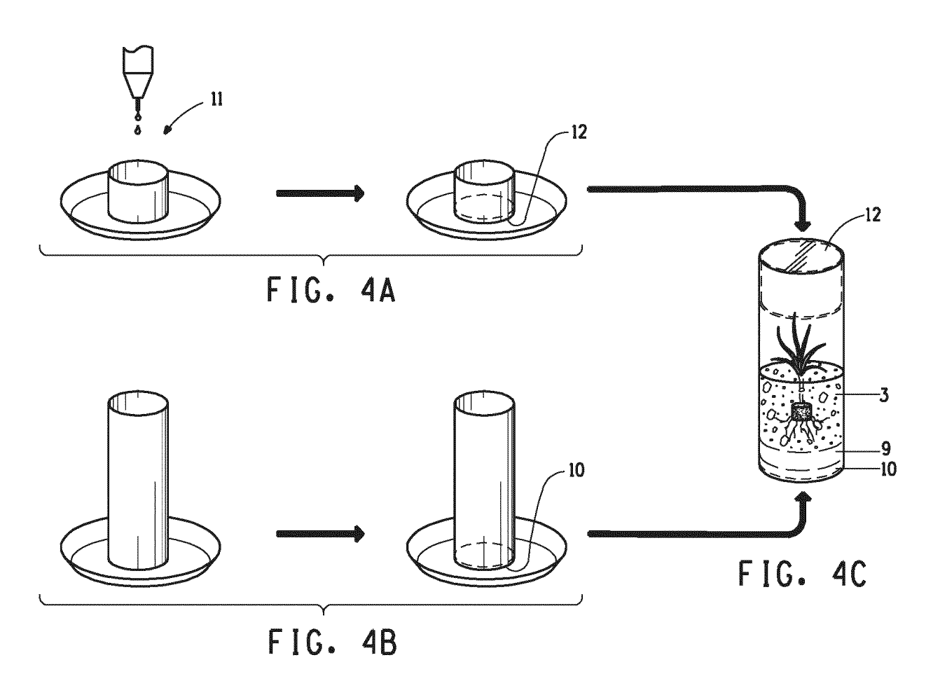

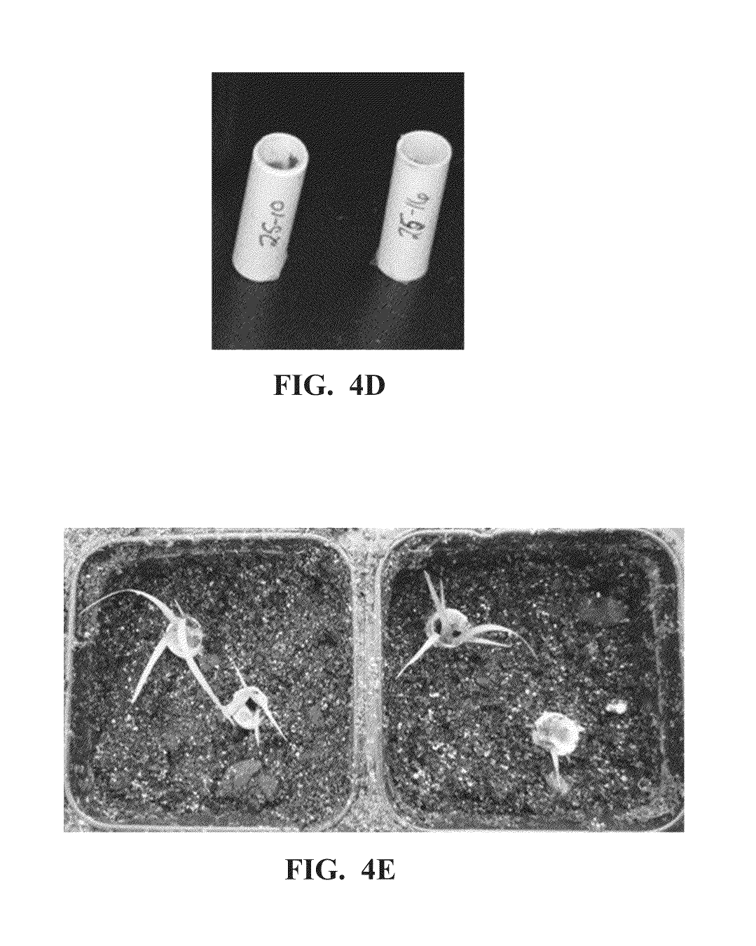

The closures used for securing the bottom opening of the containers of the artificial seeds in the current invention comprise more than one layer. It can be just one layer of stretched gelatin-starch-glycerol films at both top and bottom, or it can have more than one layer including a paper disc under the gelatin-starch-glycerol film. Alternatively the bottom closure can have multiple layers comprising an oil or a fat layer, followed by an optional paper layer, followed by a gelatin-starch-gylcerol film layer; whereas the top can still be the single stretched gelatin-starch-glycerol film layer which is transparent to light. Finally the artificial seed's top and bottom closures could be made separately and then put together by inserting the top portion into the bottom like a capsule (FIG. 4). This includes a wax paper tube with a transparent layer of gelatin-starch-glycerol film as the top closure (12). The bottom closure consists of an oil or fat layer (9) and an optional paper layer, followed by a gelatin-starch-glylcerol film layer (10).

In an embodiment one of the layers of a multilayer for the container or closures can consist of a hydrophobic substance. A hydrophobic substance is defined as a substance that has a lower surface energy than water. Hydrophobic substances include but are not limited to oils, fats, greases, polyolefins, polyolefin oligomers, triglycerides, polyethylene, polypropylene, ethylene propylene copolymers, polybutadiene, polyisoprene and polyisobutylene. In one embodiment, the hydrophobic substance can melt or flow at a temperature relevant to the application of the invention. In one embodiment, the hydrophobic substance can melt or flow above 1° C. In one embodiment, the hydrophobic substance can melt or flow above 10° C. In one embodiment, the hydrophobic substance can melt or flow above 15° C. In one embodiment, the hydrophobic substance can melt or flow above 20° C. In another embodiment, the hydrophobic substance can melt or flow above 25° C. In another embodiment, the hydrophobic substance can melt or flow above 30° C. In another embodiment, the hydrophobic substance can melt or flow above 35° C. In another embodiment, the hydrophobic substance can melt or flow above 40° C. In another embodiment, the hydrophobic substance can melt or flow above 45° C. In another embodiment, the hydrophobic substance can melt or flow below 50° C.

In another embodiment, one of the layers of the multilayer for the container or closures can consist of a moisture barrier. A moisture barrier is defined as a substance that reduces or prevents the transport of water or water vapor. Moisture barriers include but are not limited to polyolefins, ethylene copolymers, polyesters, polyamides, polydienes, polycarbonates, polyethers, polysulfides, polyimides, polyanhydrides, polyurethanes, poly(vinyl esters), poly(vinyl ethers), natural polymers, block copolymers, crosslinked polymers, proteins and blends and crosslinked versions thereof.

In another embodiment, one of the layers of the multilayer can be degradable. Degradable materials include but are not limited to poly(lactic acid), amorphous poly(D,L-lactic acid), poly(lactic acid), poly(L-lactic acid), poly(D-lactic acid), poly(meso-lactic acid), poly(rac-lactic acid), or poly(D,L-lactic acid), (poly(hydroxyalkanoate), poly(hydroxybutyrate), poly(hydroxybutyrate-co-valerate), poly(1,3-propanediol succinate), poly(propylene succinate), polyglycolide, poly(caprolactone), poly(butylene succinate), poly(ethylene succinate), poly(ethylene carbonate), poly(propylene carbonate), poly(butylene terephthalate adipate), poly(propylene terephthalate succinate), poly(propylene terephthalate adipate), poly(vinyl alcohol), cellulose acetate, cellulose butyrate acetate; and blends, copolymers or crosslinked versions thereof.

In one embodiment of the invention, the closure is made of biodegradable plastic materials such as poly(lactic acid), poly(hydroxybutyrate), poly(hydroxybutyrate-co-valerate), or blends thereof, optionally with starch, cellulose, chitosan and plasticizers, including but not limited to sorbitol, glycerol, citrate esters, phthalate esters and water. These blends may be formed by solution blending or melt blending.

In another embodiment, the closure comprises, or alternatively consists of, rapidly dissolvable blends of poly(vinyl alcohol) with starch, cellulose fibers and glycerol, optionally crosslinked, with a suitable agent, including but not limited to hexamethoxymethylmelamine or glutaraldehyde. This provides materials which are rapidly degradable in moist soil conditions, permitting rapid growth of the tissue inside. The starch may be from sources including but not limited to potato, corn, rice, wheat and cassava, and may be modified or unmodified. Additional additives may include, but are not limited to poly(ethylene glycol), citric acid, urea, water, salts including but not limited to sodium acetate, potassium nitrate and ammonium nitrate, fertilizers, agar, xanthan gum, alginate, cellulose derivatives including but not limited to hydroxypropylcellulose, methylcellulose and carboxymethylcellulose.

In the disclosed invention, the container may have a top and a bottom opening which can be secured. In an embodiment of the disclosed invention, pre-stretched Parafilm® F can be used to secure both the top opening and the bottom opening of the container. In another embodiment, the closure for the bottom opening can be pre-stretched Parafilm® M and the closure for the top opening can be a water-soluble plastic film, possibly composed of poly(vinyl alcohol), poly(vinyl pyrollidone), poly((meth)acrylic acid) and its salts or poly(ethylene glycol). In yet another embodiment, the closure for the top opening can be pre-stretched Parafilm® M and the closure for the bottom opening can be a wax-impregnated water-soluble paper. As used herein, wax-impregnated water-soluble paper means water soluble paper wherein wax has been introduced to the pores and/or surface of the material.

In another embodiment, the closure for the openings comprise, or alternatively consist of, alkyd resin films. Such alkyd resins are well known in the art, and can be formed through the reaction of unsaturated vegetable oils with polyols and cured with metal catalysts. Suitable alkyd resins include, but are not limited to Beckosol® 11-035 and Amberlac® 1074 (Reichhold Corp, Durham, N.C.).

In another embodiment, the closure for the openings comprises, or alternatively consists of, block copolymers. These polymers include two or more segments of chemically distinct constitutional repeating units, linked covalently. These block copolymers may be biodegradable. In one embodiment, polyester block copolymers are used. Such polymers may be elastomeric, allowing the plantlets to puncture them easily. The block copolymers contain blocks including but not limited to: poly(lactic acid), poly(lactide), poly(L-lactic acid), poly(D-lactic acid), poly(D,L-lactic acid), poly(caprolactone), poly(caprolactone-co-lactic acid), poly(dimethylsiloxane), poly(vinyl alcohol), poly(vinyl acetate), poly(ethylene glycol), poly(propylene glycol), poly(carbonate) s, polyethers, polyesters. In one embodiment, the block copolymers can consist of poly(L-lactic acid-b-caprolactone-co-D,L-lactic acid-b-L-lactic acid). In another embodiment, the block copolymer consists of poly(D,L-lactic acid-b-dimethyl siloxane-b-D,L-lactic acid).

The closure useful in the current invention may comprise oil. The oil suitable for application in the current invention has the following characteristics: it should melt between about 30° C. to 38° C. and be solid at room temperature (from about 20° C. to about 25° C.). Various types of oil and triglycerides (fat) can be used. Non-limiting examples include butter, cocoa butter, palm oil, palm stearine and lard. In one embodiment, vegetable oil shortening, e.g., Crisco®, can be used. In another embodiment, the closure may be composed of an oil-gel. An oil-gel is defined herein as an oil that, through combination with one or more additives, does not flow over a finite range of temperature suitable for the application. In one embodiment, the oil-gel is formed by dissolving a compound in an oil at elevated temperature, and then cooling that solution to form a gel. Suitable oils include, but are not limited to, vegetable oil, castor oil, soybean oil, isopropyl myristate, rapeseed oil, and mineral oil. Suitable compounds include, but are not limited to block polymers and associative, low molecular weight substances. Block polymers include, but are not limited to, styrenic block copolymers such as those sold under the trade name Kraton® (Kraton Polymers, Houston, Tex.), block copolymers of ethylene oxide and propylene oxide, such as those sold under the name Pluronic® (BASF, Ludwigshafen, Germany). Styrenic block copolymers include but are not limited to poly(styrene-b-isoprene-b-styrene), poly(styrene-b-butadiene-b-styrene) and hydrogenated versions thereof. Oil-gels suitable for this application will have mechanical properties weak enough to permit penetration by the growing regenerable plant tissue.

In another embodiment the openings can be secured using porous materials, including but not limited to, screens, meshes, gauze, cotton, clay, cheesecloth, and rockwool.

Alternatively, the top and bottom openings can be secured by folding, crimping, pinching, stapling, or fastening the opposing sides of the container together. In one embodiment, the bottom opening can be secured by stapling its sides together using a common, galvanized steel staple.

In another embodiment, the openings can be secured by the flap-like structures, wherein one or more flexible flaps protrude over the opening. The flaps are flexible enough to allow the plantlet to push them apart as it grows. In one embodiment, the flaps form a slotted lid or “flower” or “blossom”-shaped lid.

In another embodiment, the container can have one or more openings on the side of the container. These side openings can be in addition to the top and bottom openings. Alternatively, the container can have only side openings without top or bottom openings. These openings can also be secured using methods and materials described above.

In another embodiment, the container can possess anchoring devices. Such devices include, but are not limited to flaps, barbs, stakes and ribs. The anchoring devices can be foldable or collapsed, to reduce space prior to planting. In such cases, a restraint may be used to hold the anchoring device in a folded or collapsed state. Such restraints may include, but are not limited to tapes, bands, and adhesives.

Following methods of assembly of the container, adding the plantlet or the regenerable plant tissue, the nutrient medium, if required, and securing the top opening and the bottom opening, the artificial seeds thus created, can be planted in soil. Any kind of soil such as field soil, sandy soil, silty soil, clay soil, organic rich soil, organic poor soil, high pH soil, low pH soil, loam, synthetic soil, vermiculite, potting soil, nursery soil, topsoil, mushroom soil and sterilized versions thereof can be used for this purpose. In an embodiment, Metro-Mix® 360 (and field soil—such as that from farms or other natural sources around the world) can be used for planting the plantlets or the regenerable plant tissue in the containers. The artificial seeds will then sprout or germinate at some frequency thereafter. As used herein, “sprouting” and “germination” mean the protrusion of the regenerable tissue from the boundaries of the container of the artificial seed due to growth of the regenerable tissue.

The artificial seeds described herein are suited for storage prior to planting. Storage conditions may include, but are not limited to ambient temperature, refrigerated temperature, sub-ambient temperature, sub-ambient oxygen concentration, sub-ambient illumination, in light or in darkness, in external packaging, under air or in an inert atmosphere. Sub-ambient temperature is defined herein as temperature below the ambient temperature. Sub-ambient illumination is defined herein as illumination levels below the ambient illumination. Sub-ambient oxygen is defined as levels of oxygen below that present in the natural atmosphere. The storage duration may be as long as one year, or a few months, but may also be on the order of weeks or days.

In one embodiment, holes, cuts, breaches or slits may be made in the artificial seed at the time of planting in order to facilitate the growth of the regenerable plant tissue. This can enable the shoots or the roots to grow out of and escape the container.

The present invention provides for production of artificial seeds of plants that can develop into fully grown crops for propagation in the field. For example, the disclosed invention can provide for an economical method of propagating hard-to-scale up plants such as sugarcane that can allow their rapid propagation to meet the growing global demand for sugarcane production. Also, the present invention can provide for a simpler, safer and more economical planting method compared to the traditional planting of sugarcane stalks and billets via either mechanical or manual means. Simply reducing the weight and volume of planting material, from sugarcane stalks and billets to artificial seeds, can save the energy and time required to transport planting materials to the field for planting.

The above description of various illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. The teachings provided herein of the invention can be applied to other purposes, other than the examples described above. The invention may be practiced in ways other than those particularly described in the foregoing description and examples. Numerous modifications and variations of the invention are possible in light of the above teachings and, therefore, are within the scope of the appended claims.

These and other changes may be made to the invention in light of the above detailed description. In general, in the following claims, the terms used should not be construed to limit the invention to the specific embodiments disclosed in the specification and the claims.

Certain teachings related to viable plant artificial seeds were disclosed in U.S. Provisional patent application No. 61/578,432, filed Dec. 21, 2011, the disclosure of which is herein incorporated by reference in its entirety.

The entire disclosure of each document cited (including patents, patent applications, journal articles, abstracts, manuals, books, or other disclosures) in the Background of the Invention, Detailed Description, and Examples is herein incorporated by reference in their entireties.

The following examples are put forth so as to provide those of ordinary skill in the art with a complete disclosure and description of how to make and use the subject invention, and are not intended to limit the scope of what is regarded as the invention. Efforts have been made to ensure accuracy with respect to the numbers used (e.g. amounts, temperature, concentrations, etc.) but some experimental errors and deviations should be allowed for. Unless otherwise indicated, parts are parts by weight, molecular weight is average molecular weight; temperature is in degrees centigrade; and pressure is at or near atmospheric.

### EXAMPLES

### Materials

Wax paper containers (1.19 cm OD, Aardvark, “Colossal” size) were obtained from Precision Products Group, Inc, 245 Falley Dr, Westfield, Mass.
Vermiculite (part number 65-3120, Whittemore, grade D3, fine) was obtained from Griffin Greenhouse and Nursery Supplies in Morgantown, Pa.
Conviron model BDW-120 and Conviron CGR-962 were purchased from Conviron, Manitoba, Canada.
Metromix-360™ soil was obtained from Sun Gro Horticulture, Vancouver, Canada. fungicide (Maxim 4FS) was obtained from Syngenta, Wilmington, Del.
Crisco® oil was obtained from J. M. Smucker Co. Orrville, Ohio.
3ply wax paper cylinders with 1.12 cm OD were obtained from Precision Products Group, Inc., Westfield, Mass.
175 and 300 bloom strength porcine gelatin, potato starch and glycerol were obtained from Sigma Co.
Conventional card stock paper was obtained commercially.
Kraton® A1535 poly(styrene-b-ethylene-co-butylene-co-styrene-b-styrene) block copolymer was obtained from Kraton Polymers (Houston, Tex.).
Soybean oil was from MP Biomedicals, (Solon, Ohio).
Reynolds® Freezerpaper was obtained from an Acme grocery store.

### Growth Media

Proliferation agar medium contained Murashige and Skoog (MS) basal medium with vitamins (Phytotechnology Laboratories, Shawnee Mission, Kans.) plus 3 wt % sucrose (Grade 1 sucrose, Sigma, St. Louis, Mo.), 0.8 wt % Difco™ Agar, and 6-benzylaminopurine 0.9 milligram per liter (mg/L) (Phytotechnology Laboratories, Shawnee Mission, Kans.), at pH 5.7).

Regeneration medium, contained MS basal medium with vitamins (Phytotechnology Laboratories, Shawnee Mission, Kans.) plus 3 wt % sucrose and 0.2% Plant Preservative Mixture (PPM, Plant Cell Technology, Washington, D.C.), at pH 5.7)

Hoagland's growth medium was prepared as follows:

First, individual stock solutions were prepared: 2M KNO₃ (202 grams per liter, g/L); 2M Ca(NO₃)₂×2 H₂O (236 g/L); Iron (Sprint 300 Fe chelate, 38.5 g/L); 2M MgSO₄×7H₂O (493 g/L); 1 M NH₄NO₃ (80 g/L). The micronutrients were pared using: H₃BO₃ (2.86 g/L); MnCl₂×4H₂O (1.81 g/L); ZnSO₄×7H₂O (0.22 g/L); CuSO₄ (0.051 g/L); H₃MoO₄×H₂O (0.09 g/L); 1M KH₂PO₄ (pH to 6.0 with 3M KOH (136 g/L). To prepare Hoagland's growth medium, the stock solutions were combined with about 0.5 L water as follows: 2M KNO₃ (2.5 milliliters, mL); 2M Ca(NO₃)₂ (2.5 mL); Iron (1.5 mL); 2M MgSO₄ (1.0 mL); 1M NH₄NO₃ (1.0 mL); Micronutrient Solution (1.0 mL). Finally, the mixture was diluted to a total volume of 1 L with water.

### Preparation of Plantlets

### Week 1—Culture Initiation

1. Sugarcane stalks from 2 to 12-month-old plants of varieties CP01-1372 or KQ228 were cut the day of or one day before the excision of meristematic tissue (hereafter termed explant) for culturing. Leaf blades were trimmed closely, leaving the leaf sheaths intact. The stalks were stored in plastic bags overnight at room temperature if necessary.
2. The stalks were trimmed to get closer to the meristem and then two to three outer leaf sheaths were removed. The stalks were sprayed with 70% ethanol to saturate the outer surface. Ethanol was sprayed to maintain sterility on the surface of each leaf sheath. The stalks were then transferred into laminar flow hoods.
3. Leaf sheaths were then removed to establish the position of the meristem, the stalk was cut 2-3 centimeter (cm) below this point and 2-3 cm above this point and was placed on the sterile surface of a petri dish.
4. Finally, the meristem was split in half longitudinally and the two trimmed halves placed directly onto the proliferation medium. The cut surface was embedded into the medium and petri dishes were sealed with porous filter tape to allow gas exchange and maintain sterility.
5. The explant was grown at 26° C., with light intensity of 30 microEinsteins/m²/s from Philips F32T8/ADV841/XEN 25 watt fluorescent tubes.

### Weeks 2-3: Culture Establishment and Initial Stage of Explant Growth and Proliferation

1. The explants became brown at the cut surfaces due to polyphenols exuding into the medium.
2. Under sterile conditions, the cut ends of explant were trimmed with care taken not to shear off the regenerable tissues from which buds arise. The blackened outer tissue of the explant was removed as needed with minimum tissue excision.
3. The shoots from any lateral buds that arose from the upper side of the section were trimmed.
4. Leaves and shoots were trimmed as necessary.
5. The growing explants were transferred to fresh medium once per week.

### Weeks 4-5: Proliferated Bud Development

1. Once the explants began to proliferate, they were divided into smaller pieces of proliferating buds.
2. The blackened tissue of proliferating buds was removed and each bud piece was given a fresh cut surface for good contact with the fresh proliferation agar medium.
3. The leaves and shoots growing from the buds were trimmed to <1 cm with sterile scissors or scalpels.
4. As much of the original stalk tissue as possible was removed leaving behind only the proliferating buds.
5. The buds were transferred to fresh medium.

### Weeks 5-6: Fragmentation and Plantlet Regeneration

1. Proliferated bud tissue was typically ready for fragmentation and regeneration of plantlets after 7 weeks of growth. However, proliferated buds were occasionally used as young as 6 weeks or as old as 9 weeks after initiation.
2. Fragmentation was done by trimming the proliferated bud masses with scissors to shorten the shoots to 2-3 millimeters (mm).
3. The ‘trimmed’ proliferated buds were then fragmented using sterile scalpels to cut the bud mass into 2-3 mm pieces using a 2 mm grid pattern as a guide.
4. The 2 mm roughly cubic fragments were put directly into the plantlet regeneration medium (MS with 3% sucrose without plant growth regulators).
5. Fragments were cultured in 50-100 mL of liquid regeneration medium in sterile 250 mL polycarbonate flasks with air filters with 15-20 fragments per flask on a rotary shaker at 75 revolution per minute (rpm) to form plantlets.
6. Cultures were incubated at 26° C. with 60 microEinsteins/m²/s light from Philips F32T8/ADV841/XEN 25 watt cool white fluorescent tube in the containers for a period of 2-3 weeks to provide plantlets for use in the artificial seed.

### Preparation of Gelatin-Starch-Glycerol Film

Two different gelatin-starch-glycerol combinations were prepared for various experiments. The preparations include the following:

### Composition A

2.5 wt % Gelatin (175 Bloom Strength); 1.0 wt % Potato starch and 5.0% Glycerol

### Composition B

1.25 wt % Gelatin (175 Bloom Strength); 1.25 wt % Gelatin (300 Bloom Strength); 1.0 wt % Potato starch and 5.0 wt % Glycerol

In a beaker, gelatin, potato starch and glycerol were combined and dissolved in water at 50-65° C. with stirring. The resultant solution was allowed to stir for few minutes before it was poured into Teflon petri dishes which were left undisturbed for few days to allow most of the water to evaporate. (Because an unknown amount of water was retained in the final, dried film, the film compositions are referred to by the wt %'s of the components in the original solution prior to the evaporation step). This process resulted in preparation of pliable gelatin-starch-glycerol films. These films were removed from the petri dishes before using them to secure the openings of the wax paper cylinders.

### Example 1

### Sugarcane Artificial Seed—Architecture 1

The assembly process of making the artificial sugarcane seed was done in a non-sterile open lab bench environment. A wax paper cylinder was cut to 3 cm in length. One opening of the wax paper cylinder was secured by a piece of stretched gelatin-starch-glycerol film based on composition A. This secured opening served as the bottom opening of the cylinder. Metromix soil was then added to the cylinder till the cylinder was approximately ⅓rd full. The cylinder was tapped on the lab bench to pack the soil down. A 20 day sugarcane plantlet, prepared as described above, was trimmed both at the shoot and root apices and was placed in the Metromix. More Metromix was added again on top of the plantlet and tapped again to pack the soil such that the cylinder was ¾th full and the plantlet shoot tips were visible above the soil. The Metromix was moistened with approximately 400 microliters (μl) of water and then the top opening was secured with a piece of stretched gelatin-starch-glycerol film (Composition A) as described above (FIGS. 1a and 1b). In these Figures (1) is the stretched gelatin-starch-glycerol film; (2) is the wax paper cylinder; (3) is the Metromix soil; and (4) is sugarcane plantlet. Such an architecture resulted in 100% sprouting of sugarcane plantlets (Table 1) when they were placed in a growth chamber set under Brazilian day and night growing conditions with 11 hours daylight at 31° C., 80% humidity and 13 hours dark at 22° C. at 80% humidity (FIG. 1c). FIG. 1c is a photograph of an artificial seed showing shoots and roots of the plantlet that have emerged from the artificial seed.

This architecture, however, suffered from the drawback of being softened at the bottom opening due to penetration of moisture from the Metromix soil present inside the container. The top gelatin-starch-glycerol closure along the side walls of the wax paper cylinder softened upon contact with the moist soil outside the container in which the container was planted. Additionally, this architecture was difficult to assemble and store prior to planting the artificial seed in the soil.

### Example 2

### Sugarcane Artificial Seed—Architecture 2

In addition to the moisture from the soil outside the artificial seed, the moisture of the soil inside the artificial seed caused some softening of the structure of the artificial seed. To prevent contact of the moisture from the Metromix inside the wax paper cylinder with the gelatin-starch-glycerol closure at the bottom opening, a second layer consisting of a paper disc was added to the closure for securing both the bottom and the top openings of the wax paper cylinder prior to securing the openings with gelatin-starch-glycerol films (FIG. 2a and FIG. 2b). In FIGS. 2a and 2b, (1) is the stretched gelatin-starch-glycerol film; (2) is the wax paper cylinder; (3) is the Metromix soil; (4) is the sugarcane plantlet and (5) is a paper disc layer added to the stretched gelatin-starch-glycerol film to secure the top and the bottom openings.

The assembly process of making the artificial seed according to this architecture was done in a non-sterile open lab bench environment. Wax paper tube was cut to 3 cm in length. One opening of the wax paper tube was covered by a paper disc punched out of a card stock paper. The diameter of the paper disc was equal to the OD of the wax paper tube. The paper disc was held in place by stretching a gelatin-starch-glycerol (composition A) film on the opening and slightly along the side walls. The rest of the process for preparing the container and the plantlet was as described in Example 1. The Metromix was moistened with approximately 400 μl of water and then the opening at the top was secured with a paper disc followed by a stretched gelatin-starch-glycerol film (Composition A) as described above. Such architecture resulted in 80% sprouting of sugarcane plantlets (Table 1) when grown in a growth chamber set under conditions described in Example 1.

This architecture also resulted in good regeneration of plantlets (80%). However, the closures were still unable to hold moisture inside the cylinder which was evident by the softening of the bottom opening of the cylinder (FIG. 2c). In this FIG. 6) is the sugarcane shoot; (7) is the paper disc after the softening of gelatin-starch-glycerol film; (2) is the wax paper cylinder and (8) is the sugarcane root. Additionally, the top opening prevented light penetration because of the presence of paper disc. Furthermore, this architecture with a plantlet and moist Metromix was difficult to store prior to planting due to softening of the bottom opening.

TABLE 1
Sprouting of plantlets from artificial seeds
assembled according to architectures 1 and 2

| | | Number of plantlets | |
|---|---|---|---|
| | | emerge from the | % Regeneration |
| | Number of wax | top opening after | from |
| | paper cylinders | three weeks | artificial seed |
| Architecture 1 | 20 | 20 | 100% |
| Architecture 2 | 20 | 16 | 80% |

### Example 3

### Sugarcane Artificial Seed—Architecture 3

To eliminate water loss from the bottom opening of the wax paper, a new architecture for the artificial seed was used. The wax paper cylinder was cut into 4 cm in length and placed vertically on an aluminum dish set on a hot plate at 35° C. The bottom opening of the cylinder was filled with approximately 7-10 drops of (or filled to a thickness of approximately 2-3 mm with) an aqueous solution of gelatin-starch-glycerol (Composition A). The filled cylinder was allowed to sit on the hot plate for 1 hour and then at room temperature overnight thus creating a film layer at the bottom opening of the cylinder. In the next step, approximately 10 drops of molten (33-34° C.) Crisco® (vegetable oil shortening) were added to the dried gelatin-starch-glycerol film at the bottom opening of the wax paper cylinder to form a crack free fat layer upon cooling to room temperature. The oil layer helped with water retention within the Metromix soil in the wax paper cylinder.

Alternatively, an artificial seed with three layers at the bottom opening was prepared by adding a layer of card stock paper in between the gelatin-starch-glycerol film and the oil layer (FIGS. 3a and 3b). In these Figures (1) is the stretched gelatin-starch-glycerol film used as closure for the top opening; (2) is the wax paper cylinder; (3) is the Metromix soil; (4) is sugarcane plantlet; (5) is the paper disc, (9) is the Crisco® fat layer and (10) is the gelatin-starch-glycerol film. The diameter of the paper disc was such that it could be inserted slightly inside the cylinder. The artificial seed was assembled as described in Example 1. The Metromix was moistened with approximately 400 μl of water and then the top opening was secured with a stretched gelatin-starch-glycerol film closure (Composition A) as described above. Architecture 3 resulted in approximately 80%-86% sprouting (FIGS. 3c and 3d) of the sugarcane plantlets when grown in the growth chamber as described in Example 1. FIG. 3d is a photograph of artificial seeds assembled with architecture 3. Sugarcane shoot (6) has emerged from the wax paper cylinder (2) and sugarcane roots (8) have emerged from the bottom of the cylinder. Table 2 summarizes the results of the sprouting artificial seed prepared with 2 layers and 3 layers of the bottom closure indicating a slight advantage of using a 3 layer architecture versus the 2 layer one.

TABLE 2
Sprouting artificial seed prepared with 2 layers and 3 layers of the bottom
closure.

| | | Number of | |
|---|---|---|---|
| | Number of | plantlets emerge | |
| | wax paper | from the top opening | % Regeneration |
| | cylinders | after 11 days | from artificial seed |
| Architecture 3- | 10 | 8 | 80% |
| Two layer | | | |
| bottom opening | | | |
| closure | | | |
| Architecture 3- | 21 | 18 | 86% |
| Three layer | | | |
| bottom opening | | | |
| closure | | | |

### Example 4

### Sugarcane Artificial Seed—Architecture 3—Using 2 Week-Old Plantlets

In this example younger (2 week old) sugarcane plantlets were used. Since the plantlets were younger, agar with sucrose and MS nutrients was used as the nutrient source. Wax paper cylinder was cut into 4 cm in length and placed vertically on an aluminum dish set on a hot plate at 35° C. The bottom opening of the cylinder was filled with approximately 7-10 drops of (or filled to a thickness of approximately 2-3 mm with) aqueous solution of gelatin-starch-glycerol (Composition A) and was allowed to sit on the hot plate for 1 hour and then at room temperature overnight thus creating a gelatin-starch-glycerol film layer at the bottom opening of the cylinder. In the next step, drops of molten Crisco (vegetable oil shortening) were added to the dried gelatin-starch-glycerol layer at the bottom opening to form a crack free fat layer upon cooling at room temperature. The fat layer helped with water retention within the agar plug in the wax paper cylinder.

In another experiment, a three layer bottom closure was prepared by adding a layer of card stock paper in between the gelatin-starch-glycerol film layer and the oil layer. The diameter of the paper was such that it could be inserted slightly inside the cylinder as described in Example 3.

To provide nutrients for the plantlet in the artificial seed, in a sterile laminar flow hood, the open opening of the wax paper cylinder was stabbed into a petri dish containing a ˜1 cm layer of 0.8 weight percent (wt %) Difco™ agar containing MS nutrients, 0.2 wt % Plant Preservative Mixture (PPM) and 3% sucrose, no 6-benzylamino purine (BAP), twice to get a ˜2 cm plug of agar that was pushed down using a thinner wax paper cylinder onto the fat layer inside the wax paper cylinder. A 2 week-old sugarcane plantlet, prepared as described above was placed on top of the agar. Finally the top opening was secured with a piece of stretched gelatin-starch-glycerol film (Composition A). Such architecture resulted in 83% sprouting of sugarcane plantlets (Table 3) in the artificial seed when grown as described in Example 1. When the artificial seeds had the 3 layer bottom opening closure, all plantlets sprouted (Table 3).

TABLE 3
Sprouting of 2 week old plantlets using artificial seeds
of architecture 3 with 2 and 3 layer bottom opening closures

| | | Number of | |
|---|---|---|---|
| | | plantlets emerge | |
| | | from the top | |
| | Number of wax | opening after 14 | % Regeneration |
| | paper cylinders | days | from artificial seed |
| Architecture 3- | 12 | 10 | 83% |
| Two layer | | | |
| bottom opening | | | |
| closure | | | |
| Architecture 3- | 9 | 9 | 100% |
| Three layer | | | |
| bottom opening | | | |
| closure | | | |

### Example 5

### Sugarcane Artificial Seed—Architecture 4

The closures used for the top openings in examples 1-4 required stretching of the gelatin-starch-glycerol films on the top opening of the wax paper cylinder. These stretched film ends on the cylinder walls sometimes snap completely right after planting when they come in contact with the moist soil outside the cylinder in which they are planted. Thus a new process was used for preparation of the closures for the top opening and the bottom opening prior to the assembly of the artificial seeds.

### Preparation of the Closures for the Top Opening and the Bottom Opening for the Artificial Seed

Two separate wax paper cylinders were used for preparing closures for the top opening and bottom opening (FIG. 4). Aqueous solutions of gelatin-starch-glycerol (FIGS. 4a-11) were dropped in two separate wax paper cylinders. The wax paper cylinder for preparation of the top opening closure was a 3 ply paper instead of the 5 ply paper that was used to construct the main body of the wax paper cylinder in the previous examples (FIGS. 4b-10). Additionally, the 3 ply paper had a slightly smaller internal diameter of 1.1 cm and was cut to 1 cm in length. The wax paper cylinder was placed vertically on an aluminum dish set on a hot plate at 33° C. The cylinder was filled with 6 to 7 drops of aqueous solutions of gelatin-starch-glycerol using either composition A or B. The hot plate was switched off after 30 min and the gelatin-starch-gylcerol solution was further allowed to dry at room temperature thus creating a gelatin-starch-glycerol film to be used as the closure for securing the bottom opening of the cylinder. The 1 cm wax paper cylinder with a transparent gelatin-starch-glycerol film, described above, served as a premade closure for the top opening (12) and was inserted into the 4 cm long 5 ply wax paper cylinder which served as the container for the artificial seed.

The procedure described in example 3, which involved creating a bilayer structure of gelatin-starch-glycerol layer (10) and a fat layer of Crisco® (9) for preparation of the closure for the bottom opening was followed (FIG. 4b). The closures thus prepared were used for assembly of the artificial seed (FIG. 4c).

### Preparation of the Artificial Seed

The artificial seed, using a 3 week old plantlet, was prepared as described in Example 1. The Metromix was moistened with approximately 500 μl of water and then the 1 cm long pre-made top closure was inserted inside the 4 cm cylinder. Using this architecture resulted in 80% and 90% sprouting of sugarcane when gelatin-starch-glycerol films using either composition A or B, respectively, were used as closures to secure the top opening (Table 4) under growth conditions described in Example 1 (FIGS. 4d and 4e).

The artificial seeds assembled using architecture 4 had several advantages. They had a polymeric transparent layer, as the top closure, to allow light penetration into the artificial seed which resulted in improved sprouting of the plantlets. The closures were pre-made and then the artificial seed assembled readily when the plantlets became available. The presence of the fat layer at the bottom opening allowed for moisture retention within the artificial seed. Such artificial seeds, which include the plantlet, can be stored and have shown to regenerate successfully after one week of storage at 15° C. Finally the artificial seed prepared according to this procedure is completely biodegradable.

TABLE 4
Sprouting of the plantlets used in architecture 4

| | | Number of | |
|---|---|---|---|
| | | plantlets emerge | |
| | Number of | from the top | |
| | wax paper | opening after 7 | % Regeneration from |
| | cylinders | weeks | artificial seed |
| Architecture | 10 | 8 | 80% |
| 4- | | | |
| Composition A | | | |
| Architecture | 10 | 9 | 90% |
| 4- | | | |
| Composition B | | | |

### Example 6

### Production of Polyester-Polysiloxane Block Polymer Film for Artificial Seed Closures

The synthetic procedure described below was carried out to provide an alternative material with enhanced biodegradability for use as an artificial seed closure. The material is a block polymer comprised of poly(lactide) (PLA)—a rigid, glassy polymer at room temperature—and poly(dimethylsiloxane) (PDMS)—a liquid at room temperature. The relative contents of PLA and PDMS in the material are selected to yield an overall mechanical response that is similar to manually pre-stretched Parafilm® M. Aminopropyl-terminated PDMS of 900-1100 cSt viscosity was purchased from Gelest (DMS-A31) and used as a difunctional macroinitiator for the polymerization of lactide. Under oxygen- and water-free conditions, 40 g of the PDMS was added to a 1 L round bottom flask. To the flask, 60 g of lactide (Sigma-Aldrich), 40 μL of tin(II) 2-ethylhexanoate (Sigma-Aldrich), and 461 mL of toluene (EMD Chemicals) were added. The reaction mixture was heated under stirring to 100° C. for 24 hrs. The resultant solution of poly(lactide-b-dimethylsiloxane-b-lactide) (LDL) triblock polymer was dried using a rotary evaporator. The solid LDL polymer was re-dissolved in 435 g methylene chloride (EMD Chemicals), precipitated in a 10-fold volumetric excess of methanol (EMD Chemicals), filtered and washed with methanol, and then dried under vacuum at 45° C. Approximately 87 g of LDL were obtained.

The total number-averaged molecular weight Mₙ, and composition f_{PLA} (weight fraction of PLA) of the LDL, determined by nuclear resonance spectroscopy, and the polydispersity index PDI, determined by size exclusion chromatography, are provided in Table 5. A film of LDL was prepared by first dissolving the polymer in chloroform (EMD Chemicals) at 20 wt. %. This solution was cast on a Teflon® substrate using a doctor blade with a 5 cm wide and 254 um thick gap. After drying under ambient conditions for 5 days, a film of approximately 75 um thickness was obtained. The elastic modulus E, tensile strength σ_{f}, and strain at break ε_{f} of the LDL was measured under uniaxial tension, as shown in Table 5. For comparison, the corresponding values of pre-stretched Parafilm® M are also provided. In this case, prior to measurement, the Parafilm® sample, having equal initial length and width, was subjected to 200% uniaxial strain along its length, followed by 200% uniaxial strain along its width.

TABLE 5
Molecular and mechanical properties of LDL and Parafilm ® M

| | Mₙ | | | | | |
|---|---|---|---|---|---|---|
| Material | (kg/mol) | f_{PLA} | PDI | E (MPa) | σ_{f} (MPa) | ε_{f} (%) |
| LDL | 50 | 0.57 | 1.37 | 52 | 5.2 | 210 |
| Parafilm ® | — | — | — | 19 | 3.6 | 130 |
| M | | | | | | |

### Example 7

### Effect of Container Length and Closure Type on Viability of Artificial Seeds

Wax paper containers were cut into 4 cm and 7 cm lengths. One open end of each container was secured with either a 38 um thick LDL film, prepared as described in Example 6, or a 254 um thick soybean oil gel film. The latter was prepared by dissolving Kraton® A1535 poly(styrene-b-ethylene-co-butylene-co-styrene-b-styrene) triblock polymer in soybean oil at 9 wt. % and 155° C., and casting the hot solution on a glass substrate using a doctor blade with a 5 cm wide and 254 um thick gap, preheated to 155° C. Upon cooling to room temperature, the physical gelation of the triblock polymer in the oil yields a solid, but highly deformable film. LDL film was affixed to the wax paper container using a thin layer of cyanoacrylate adhesive (Sigma-Aldrich).

Soybean oil gel film was affixed by heating the film, still adhered to the glass substrate, to near its sol-gel transition (approximately 80° C.), pressing the end of the wax-paper container into the softened film, and cooling to room temperature to re-solidify the film.

The 4 cm and 7 cm wax paper containers, having their bottom ends secured with LDL or soybean oil gel film, were then loaded approximately one-third full with dry Metro-Mix® 360 growing media. One regenerated sugarcane plantlet was then added to each container. The regenerated plantlets were prepared from cultivar CPO-1372 according to a procedure similar to that described in Example 1. The regenerated plantlets varied in length from several cm to over 10 cm.

After adding a plantlet to a 4 cm container, the shoots of the plantlet were trimmed to fit within the 4 cm length. For the 7 cm containers, the shoots of the plantlets were still trimmed to fit within a 4 cm container, i.e., all plantlets were trimmed to the same length, regardless of container size. The 4 cm containers were then filled to the top with additional Metro-Mix® 360 and 1 mL of deionized water was added to the container via pipette. After the addition of water, the soil level in the 4 cm tube compacted to fill approximately two thirds of the container. The 7 cm containers were then filled with a 4 cm thick layer of Metro-Mix® 360 and 1 mL of deionized water was added to the container via pipette. The top end of the container was secured with LDL or soybean oil gel film as described previously. Identical materials were used for the top and bottom closure of each container, that is, each container was closed exclusively by LDL film or exclusively by soybean oil gel film.

The artificial seeds were planted in 4 inch plastic pots with slits cut along the bottom surface and filled with Metro-Mix® 360. The pots were further placed in a plastic tray to collect water. All artificial seeds were planted in a vertical orientation; 4 cm containers were planted with the top closure flush with the soil level and 7 cm containers were planted with the top closure 3 cm above the soil level. The pots were maintained in an environmental chamber with a 16 hr photoperiod of 3000 lum/ft² luminosity and a 31/20° C. day/night cycle. The pots were watered, generally, at frequencies of several days.

The number of artificial seeds planted of each combination of container length and closure type is provided in Table 6, as well as the percentage of artificial seeds that sprouted and survived the 4 week duration of observation and their average height. The artificial seeds exhibited high sprouting and survival rates, a minimum of 60%. For comparison, bare plantlets transplanted directly from regeneration to Metro-Mix® 360 in the same environmental chamber exhibited 46% survival, respectively, after 4 weeks. Therefore, enclosure of the regenerated plantlets in the wax-paper containers provided a marked increase in viability. It is further evident that LDL closures provided enhanced viability—a minimum of 90% —in comparison to soybean oil gel closures. While the latter are more deformable, and hence more readily punctured by the shoots of the encapsulated plantlet, discoloration of the plantlet shoots was observed when in contact with the top closure. This suggests a certain degree of phytotoxicity of the soybean oil gel to the plantlets, which likely explains the lower degree of success of the corresponding artificial seeds. In contrast, no discoloration of plantlet shoots in contact with LDL closures was observed.

TABLE 6
Viability of sugarcane plants from artificial seeds
of varying container length, closure type, and plantlet type

| | | | | Mean Height |
|---|---|---|---|---|
| Container | | Number of | Survival of | of Plants |
| Length | | Seeds | Plants After 4 | After 4 Weeks |
| (cm) | Closure Type | Planted | Weeks (%) | (cm) |
| 4 | LDL | 58 | 90 | 19 |
| 4 | soybean oil gel | 59 | 80 | 18 |
| 7 | LDL | 29 | 97 | 27 |
| 7 | soybean oil gel | 30 | 60 | 17 |

### Example 8

### Encapsulation of Sugarcane Plantlets by Bilayer Film to Provide Artificial Seeds

Bilayer films were constructed by laminating a rapeseed oil-based gel to the water-soluble polymer poly(vinyl alcohol) (PVOH). A room temperature-soluble grade of PVOH was obtained from Extra Packaging Corp., supplied as a 0.002 in thick film. The rapeseed oil-based gel consisted of 9 wt. % Kraton® A1535—a triblock polymer consisting of polystyrene end blocks and a poly(ethylene-co-butylene-co-styrene) mid-block—in rapeseed oil from Brassica rapa (Sigma-Aldrich). The A1535 was dissolved in the rapeseed oil at 155° C. Upon cooling the resultant solution below approximately 80° C., gelation is induced, yielding a soft and highly elastic solid. This sol-gel transition is reversible; that is, the material can be repeatedly transformed to the liquid and gel states by heating above and cooling below ˜80° C., respectively.

The material was cast onto the PVOH film using a stainless steel doctor blade with a 2 inch wide and 0.010 inch thick gap; the Kraton-rapeseed oil solution and the doctor blade were preheated to 155° C. and 110° C., respectively.

Two pieces of this PVOH-oil gel bilayer film were overlaid such that the oil gel layers are in contact, while the PVOH layers are not. By hot-pressing this sandwich structure together with temperatures in excess of 80° C., the oil gel layers can be locally bonded to create bilayer pouches. The central cavity of the pouch is encapsulated by the inner oil gel layer, and the inner oil gel layer is encapsulated by the outer PVOH layer. In this manner, artificial sugarcane seeds were created by encapsulating a sugarcane plantlet with moist Metro-Mix°-360 growing media. The plantlets were prepared from cultivar CPO-1372 according to a procedure similar to that described in Example 1. The Metro-Mix°-360 was compacted around the roots of the plantlet to form a solid mass.

Seven of these artificial seeds were planted in plastic pots with slits cut along the bottom surface and filled with Metro-Mix®-360. The pots were further placed in a plastic tray to collect water. The artificial seeds were planted at the soil surface in a horizontal orientation, such that the encapsulated plantlet's shoots are roughly parallel with the soil surface. The pots were maintained in an environmental chamber with a 13 hr photoperiod of 1900 lum/ft² luminosity and a 31/22° C. day/night cycle. The relative humidity was controlled at a constant value of 80%. The pots were watered at a frequency of 1-2 times per week. Upon contact of the outer surface of the artificial seeds with water, the PVOH layer was dissolved. This leaves only the soft oil gel layer as a membrane encapsulating the plantlet. It was clear from visual observation that the moisture barrier property of the oil gel caused prolonged retention of water in the Metro-Mix°-360 potting soil inside the seed, relative to the surrounding Metro-Mix®-360 in the pot. Within days, two of the seven encapsulated plantlets grew and ruptured the oil gel membrane. Over one month after planting, the resulting sugarcane plants had survived and established in the surrounding soil. Two of the remaining five plantlets were able to rupture the oil gel membrane, but later died, while the other three plantlets died without rupturing the membrane.

### Example 9

### Comparison of Unencapsulated Plantlets to Bilayer Film Artificial Seeds

17 artificial sugarcane seeds were constructed as described in Example 8. An additional 15 artificial sugarcane seeds were constructed as described in Example 8, except that each plantlet was encapsulated with only deionized water, as opposed to Metro-Mix®-360 growing media. The amount of deionized water in the artificial seeds was adjusted such that the plantlet roots were immersed. The artificial seeds were planted in plastic pots with slits cut along the bottom surface and filled with Metro-Mix°-360. The pots were further placed in a plastic tray to collect water. The artificial seeds were planted at a 45° angle relative to the soil surface, such that the encapsulated plantlet's shoots and roots were slightly above and below the surface, respectively.

For comparison, 18 bare plantlets were planted in similarly prepared pots. The bare plantlets were planted vertically, such that the roots were well-packed in soil and the shoots were above the surface. The pots were maintained in an environmental chamber with a 13 hr photoperiod of 1900 lum/ft² luminosity and a 31/22° C. day/night cycle. The relative humidity was controlled at a constant value of 80%. The pots were watered at a frequency of once per week.

One month after planting, 83% of the bare plantlets survived. In comparison, 59% of the artificial seeds where Metro-Mix°-360 was used as a nutrient source sprouted and survived, while the corresponding value was only 27% for the artificial seeds containing only deionized water. The average height of the living plants was greatest among the bare plantlet set and smallest among the set of artificial seeds containing only deionized water. Nearly all artificial seeds had sprouted—i.e., the encapsulated plantlet ruptured the oil gel membrane—within one week of planting, thus the survival rates indicate significant mortality of plants post-sprouting. The results demonstrate the necessity of including a nutrient source within the artificial seed.

### Example 10

### Comparison of Oil Gel to Vegetable Shortening in Bilayer Film Artificial Seeds

18 artificial sugarcane seeds were constructed as described in Example 8, except that the oil gel was created using 6 wt. % of Kraton® A1535, as opposed to 9 wt. %. By decreasing the amount of A1535 in the gel, a material of lower modulus and lower ultimate elongation is created. However, the gel also exhibits a stronger proclivity for syneresis—separation of free oil from the gel—over time. A film of 9 wt. % A1535 gel shows standing oil droplets when allowed to sit for weeks, while a film of 6 wt. % A1535 gel shows standing oil droplets when allowed to sit for only one day.

18 additional artificial seeds were constructed, substituting Crisco® vegetable shortening for the oil gel. The Crisco®, pre-heated to 50° C., was cast onto the PVOH film using a stainless steel doctor blade with a 2 inch wide and 0.040 inch thick gap. The resultant PVOH-Crisco® bilayer film was used to construct artificial seeds in an identical manner to that described in Example 8.

The artificial seeds were planted in plastic pots with slits cut along the bottom surface and filled with Metro-Mix®-360. The pots were further placed in a plastic tray to collect water. The artificial seeds were planted roughly 2-3 inches deep in a vertical orientation such that the encapsulated plantlet's shoots were facing upwards. For comparison, 18 bare plantlets were planted in similarly prepared pots. The bare plantlets were planted vertically, such that the roots were well-packed in soil and the shoots were above the surface. The pots were maintained in an environmental chamber with a 13 hr photoperiod of 1900 lum/ft² luminosity and a 31/22° C. day/night cycle. The relative humidity was controlled at a constant value of 80%. The pots were watered at a frequency of once per week.

One month after planting, 83% of the bare plantlets survived. In comparison, 39% and 33% of the bilayer film artificial seeds having an oil gel and Crisco® inner layer, respectively, sprouted and survived. The encapsulated plantlets easily ruptured both the oil gel and Crisco® membranes within several days after planting. The mechanical behavior of the two membranes is fairly disparate—the oil gel is a soft, but highly cohesive and elastic solid, whereas the Crisco® is quite brittle and poorly cohesive. The Crisco® film frequently fractures spontaneously upon dissolution of the PVOH outer layer.

The fact that both membranes pose little mechanical impediment to plantlet sprouting and growth thus suggests that an alternative phenomenon is responsible for the low survival rates of the synthetic seeds relative to bare plantlets. The most likely explanation is that the materials comprising the inner layer exhibit a certain degree of phytotoxicity to the sugarcane plantlets, or that their contact with the plantlet affects its ability to perform necessary functions. Indeed, this explanation is supported by the fact that the 9 wt. % A1535 gel inner layer described in Example 9 yielded a higher survival rate compared to the 6 wt. % A1535 gel described here.

If rapeseed oil is phytotoxic to the sugarcane plantlet, or if contact of, for example, the roots of the plantlet with rapeseed oil inhibits the ability of the plantlet to uptake nutrients or water, then poorer survival would indeed be expected with 6 wt. % A1535, due to the aforementioned increase in syneresis. Likewise, the poor cohesiveness of Crisco® causes a coating to be deposited on surfaces that are contacted with it.

### Example 11

### Comparison of Poly(Vinyl Alcohol) to Carboxymethylcellulose in Bilayer Film Artificial Seeds

18 artificial sugarcane seeds were constructed as described in Example 8, except that the oil gel was created using 6 wt. ° A of Kraton® A1535, as opposed to 9 wt. %. An additional 18 artificial seeds were prepared in an identical manner, except the PVOH component of the bilayer film was replaced with carboxymethylcellulose paper, obtained from Aquasol Corporation (grade ASWL-75). These artificial seeds and 18 bare plantlets were planted and maintained in an identical manner to that described in Example 10. Three weeks after planting, 55% of the bare plantlets survived.

In comparison, 22% of the artificial seeds having carboxymethylcellulose as an outer layer sprouted and survived, while none of the artificial seeds having PVOH as an outer layer survived. As with the previous examples, the encapsulated plantlets were easily able to rupture the oil gel membrane after planting, but significant mortality was observed as time progressed. As the outer layer serves only the function of providing mechanical support to the artificial seed structure, and both the carboxymethylcellulose and PVOH are highly water soluble and readily dissolve after planting and watering, a significant difference in survival between the two types of artificial seeds was not expected.

The survival values are more likely controlled by the effects of syneresis of the oil gel discussed in Example 10, coupled with intrinsic variability of physical development among the population of sugarcane plantlets used. To this end, it is important to note that the viability of bare plantlets was less in this example compared with Examples 8 and 9.

### Example 12

### Comparison of Bilayer Film and Wax-Paper Tube Artificial Seeds

54 artificial sugarcane seeds were constructed as described in Examples 9 and 10. The bilayer film used to encapsulate the sugarcane plantlets was comprised of a carboxymethylcellulose outer layer and a Crisco® inner layer. An additional 18 artificial seeds comprised of wax-paper containers enclosed by oil gel film were constructed. Wax-paper containers like those described in Example 2 were cut into 4 cm lengths. An oil gel film was prepared by dissolving Kraton® A1535 in rapeseed oil at 9 wt. % and 155° C., and casting the hot solution on a glass substrate using a doctor blade with a 2 inch wide and 0.010 inch thick gap, preheated to 110° C.

Upon cooling to room temperature, the oil gel film was affixed to the bottom of a container by heating the film, still adhered to the glass substrate, above 80° C., pressing the end of the wax-paper container into the softened film, and cooling to room temperature to re-solidify the film. The container was then loaded approximately one-third full with dry Metro-Mix®-360 growing media. One regenerated sugarcane plantlet was then added to each container and the shoots of the plantlet were trimmed to fit within the 4 cm length. The container was then filled to the top with additional Metro-Mix®-360 and 1 mL of deionized water was added to the container via pipette. After the addition of water, the soil level in the 4 cm tube compacted to fill approximately two thirds of the container. The top end of the container was secured with oil gel film by the same procedure as the bottom end.

The abovementioned artificial seeds, along with encapsulated plantlets, were planted in plastic pots with slits cut along the bottom surface and filled with Metro-Mix®-360. The pots were further placed in a plastic tray to collect water. The wax-paper artificial seeds were planted within one day of assembly, in a vertical orientation with the top closure flush with the soil level. 36 of the bilayer film artificial seeds were planted within one day of assembly—half were planted 2-3 inches deep in a vertical orientation such that the encapsulated plantlet's shoots were facing upwards, while the remaining half were planted in a horizontal orientation covered by approximately ⅛ inch of soil.

The other bilayer film artificial seeds were stored under ambient conditions for one week before being planted in the vertical orientation described above. 36 bare plantlets were planted vertically, such that the roots were well-packed in soil and the shoots were above the surface. 18 bare plantlets were planted horizontally, covered by approximately ⅛ inch of soil. The pots were maintained in an environmental chamber with a 13 hr photoperiod of 1900 lum/ft² luminosity and a 31/22° C. day/night cycle. The relative humidity was controlled at a constant value of 80%. The pots were watered at a frequency of one to two times per week.

Table 7 shows the percentage of artificial seeds that sprouted and survived, along with the percentage of bare plantlets that survived. The wax-paper tube artificial seeds exhibited very high sprouting and survival rates.

In contrast, the bilayer film artificial seeds exhibited low survival rates, consistent with Example 10. The horizontal planting orientation caused a reduction in the number of seeds where sprouting could be positively identified; however, the planting orientation had no impact on ultimate survival. Similarly, bare plantlets exhibited no change in survival rate with planting orientation. Storage, on the other hand, caused a decrease in both sprouting and survival for the bilayer film artificial seeds. Collectively, these results further support the explanation given in Example 10 for the negative impact of Crisco® and rapeseed oil on plant survival.

When the wax-paper tube artificial seed is compared to a bilayer film artificial seed, the surface area of oil gel or Crisco® that has the potential to contact the encapsulated plantlet, as well as the duration of that contact, is far less in the case of the wax-paper tube, hence its greatly improved survival rate relative to the bilayer film. In addition, storage increases the duration of contact between the inner layer of the bilayer film and the encapsulated plantlet, which also would be expected to worsen survival.

TABLE 7
Viability of sugarcane plants from bilayer film and wax-paper
tube artificial seeds

| | | | Amount | Survival of |
|---|---|---|---|---|
| | Storage Time | Planting | Sprouted | Plants After 3 |
| Type | (Days) | Orientation | (%) | Weeks (%) |
| wax-paper | <1 | Vertical | 94 | 94 |
| tube | | | | |
| bilayer film | <1 | Vertical | 100 | 28 |
| | <1 | Horizontal | 39 | 28 |
| | 7 | Vertical | 6 | 0 |
| bare plantlets | <1 | Vertical | N/A | 100 |
| | <1 | Horizontal | N/A | 100 |

### Example 13

### Role of Oils in Bilayer Film Artificial Seeds

Artificial sugarcane seeds were prepared as described in Example 8, except that the oil gel was created using 10 wt. % of Kraton® A1535, as opposed to 9 wt. %. Moreover, several different oils were used: pure rapeseed oil and 2:8 and 4:6 (by wt.) mixtures of isopropyl myristate (Tokyo Chemical Industry Co.):rapeseed oil. The replacement of rapeseed oil with isopropyl myristate in the oil component of the gel induces a decrease in both its mechanical strength and gel temperature.

The artificial seeds were planted and maintained as described in Example 10. Bare plantlets were also planted and maintained as described in Example 10. A subset of these bare plantlets were dipped in pure rapeseed oil immediately prior to planting; for half of the subset, the entire plantlet was dipped, while for the other half, only the roots were dipped.

Table 8 shows the percentage of sugarcane plants from the artificial seeds and bare plantlets that survived, one month after planting. For each composition of the oil gel component of the bilayer film and for each oil treatment to the bare plantlets, 18 samples were planted. The values in Table 8 show low survival with bilayer film artificial seeds and little change as the composition of the oil in the inner layer is varied.

The survival of bare plantlets was lowest for those plantlets which had been dipped entirely in rapeseed oil immediately prior to planting, and was highest for those plantlets which only had their roots dipped. This suggests that specific contact of the plantlet shoots with rapeseed oil is detrimental to survival. In the context of Example 7, where discoloration of plantlet shoots in contact with oil gel film was observed, this lends further support to the notion that syneresis of the oil gel and subsequent contact of the oil with the plantlet limits the performance of the bilayer film artificial seeds.

TABLE 8
Viability of sugarcane plants from artificial seeds and bare plantlets
employing different oil compositions and treatments

| | | Survival of Plants |
|---|---|---|
| Type | Oil Composition/Treatment | After 1 Month (%) |
| bilayer film | 0:10 IPM:RO | 11 |
| artificial seed | 2:8 IPM:RO | 6 |
| | 4:6 IPM:RO | 0 |
| bare plantlet | no treatment | 67 |
| | roots dipped in RO | 83 |
| | entire plantlet dipped in RO | 39 |

IPM ≡ isopropyl myristate
RO ≡ rapeseed oil

### Example 14

### Bilayer Film and Wax-Paper Tube Artificial Seeds in Field

50 artificial sugarcane seeds were prepared using bilayer films as described in Example 13. The oil gel component of the bilayer film was created using 10 wt. % of Kraton® A1535 in soybean oil. An additional 50 artificial sugarcane seeds were also prepared using 4 cm long, wax-paper containers with soybean oil gel closures as described in Example 7.

The artificial seeds were planted in a field at the DuPont Stine-Haskell Research Center located in Newark, Del. The field was prepared to give a flat planting surface. The bilayer film artificial seeds were planted 2-3 inches deep in a vertical orientation such that the encapsulated plantlet's shoots were facing upwards. The wax-paper tube artificial seeds were planted in a vertical orientation with the top closure flush with the soil surface. In addition, 50 bare plantlets were planted vertically, such that the roots were well-packed in soil and the shoots were above the surface. The field was irrigated immediately after planting and generally 3 to 4 times per week thereafter.

Within two weeks after planting, many of the artificial seeds had sprouted, but none of the plants from bilayer film artificial seeds and only 6% of the plants from wax-paper tube artificial seeds had survived. The latter 6% died shortly thereafter. No bare plantlets had survived, even 8 days after planting.

### Example 15

### Performance of Kraft Paper Pouch Artificial Seeds in the Field

### Preparation of Artificial Seed Constructs

This experiment was designed to demonstrate viability of artificial seeds constructed from paper. The paper substrate consisted of 75 um thick kraft paper lined with 12.7 um thick LDPE (Reynolds® Freezerpaper, plastic coated). This paper was formed into pouches by folding a 5 cm wide by 20.3 cm long sheet along the midpoint of the 20.3 cm side. The resulting 5 cm wide by 10.2 cm long part was then heat sealed (American International Electric Impulse Sealer Model# AIE-400P, 550 watts, setting 4-5) along the two 10.2 cm long sides to create a rectangular pouch with three water tight sides and a 5 cm wide opening at one end. The pouches were filled with 2 g of Metro-Mix® 360 soil.

Sugarcane plantlets, which had been regenerated from meristem tissue fragments (variety KQ228) in the plantlet regeneration medium for 15 days post-fragmentation, were placed into the pouches. The plantlets were pushed into the soil to insure the roots were in intimate contact with the soil. 2 ml of water was added to the soil. The pouches were sealed by pushing the upper corners of the 10.2 cm long sides together. This forces the center of the 5 cm sides away from each other and results in two 2.5 cm wide tabs. These tabs are heat sealed together to form a water tight container. The heat seal can be any angle but for this test the heat seals were between 45 and 60 degrees off vertical. This creates a pyramidal shaped open area inside the pouch which provides stiffness and sufficient room for the plan to grow without being constrained.

### Planting in the Field

Field trials were conducted at the Stine farm in Newark, Del. The field was prepared similar to commercial practice (i.e., 1.5 m row spacing) used for conventional sugarcane billet planting as is well known in the relevant art. About 100 meter long furrows were prepared with 1.5 m gap between furrows and irrigated to full field capacity 2-3 days prior to planting. Just before planting the top of the pouch was cut off, exposing a small opening from approximately 0.64 cm in diameter to 1.91 cm in diameter. This is to allow the shoots to emerge.

The bottom of the pouch was penetrated with between 5 and 10 holes in some cases. In other cases, the bottom of the pouch was not penetrated and yet in others, the bottom of the pouch was cut across the full width of the pouch. This was to allow moisture to enter the pouch and to allow a route for the roots to escape. The pouches were planted within the furrows so that the soil level within the pouch was level with the soil in the furrow. The soil was pressed against the pouch and sprayed with water immediately after planting to establish good connections between the soil and the artificial seed.

The planted furrows were irrigated every third day for the first 10 days and then the irrigation continued once a week. Approximately 150 artificial seeds were planted. As control, plantlets of similar age, and produced similarly, were planted directly in the field and received similar field treatments.

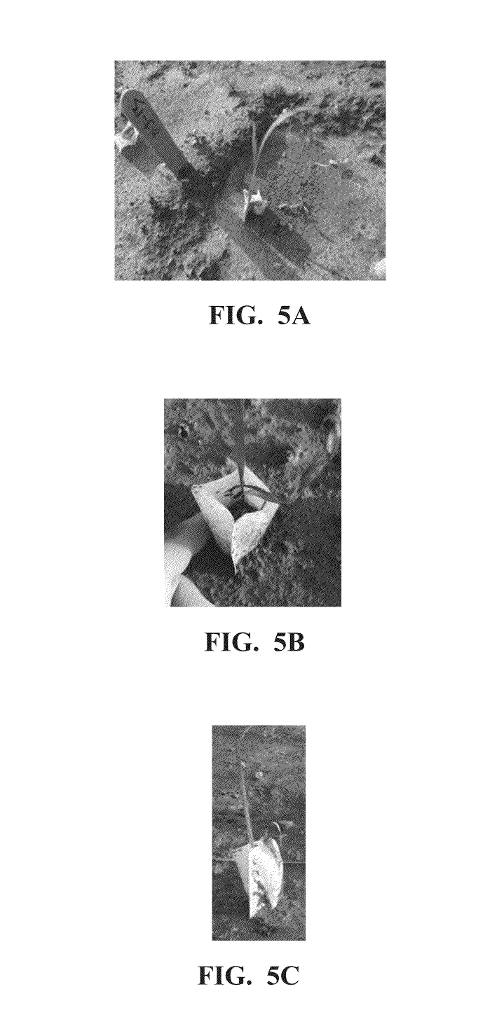

One week after planting, the number of plants emerged from the artificial seeds were recorded. Nearly 90% of plantlets in the pouches survived. After two weeks the survival rate dropped to 77%. FIG. 5 shows three photographs of plants emerging from pouches.

### Example 16

### Effect of Holes in the Sides of Wax Paper Tubes in Field Testing for Artificial Seeds in Brazil

Cylindrical wax paper containers (Aardvark colossal drinking straw, 1.19 cm outer diameter) were cut into 4 cm lengths. In selected treatments, several approximately 3 mm diameter holes were cut in the side of the paper tubes, spaced roughly evenly along the bottom half of the tube. Sugarcane plantlets, cultivar V11 (SP813250) which had been regenerated for 36 days from bud tissue fragments in plantlet regeneration medium were used for this experiment. The plantlet shoots were trimmed to approximately 3 cm length before encapsulation.

The bottoms of the paper tubes were either stapled along the axis of the tube with half of the staple extending beyond the end of the tube, or were closed by wrapping pre-stretched Parafilm® M across the bottom or by using gelatin starch lids on the bottom. A thin ˜1 cm layer of autoclaved potting soil (Topstrato® HT) was placed at the bottom of the tubes. The plantlets were placed on the soil layer, and then additional potting soil was added to fill the tube until the plantlet was mostly covered. A volume of ˜1 mL of water was added into the structure, and then the tops of the tubes were closed with either pre-stretched Parafilm® M or gelatin starch lids without a fat layer.

The artificial seeds were planted vertically in raised beds at the DuPont do Brasil site in Paulinia (SP), Brazil such that the tops of the tubes were less than 0.5 cm above the soil surface. Bare plantlets without trimming were planted in both the field, as well as a nearby greenhouse onsite (using the same autoclaved potting soil used inside the structures) in 8 cm pots (or 240 mL pots)). The field soil had been prepared before the experiment using rotary hoes and a bed shaper. After planting, irrigation was performed daily and survival was monitored every two days.

TABLE 9
Results of field experiment with wax paper tube artificial seeds.

| | | | Presence of | | |
|---|---|---|---|---|---|
| Seed | | Bottom | holes in | Initial # of | % Survival |
| structure | Top closure | closure | paper tube | containers | by day 30 |
| Wax paper | Pre-stretched | Pre-stretched | No | 15 | 87 |
| tube | Parafilm ® M | Parafilm ® M | | | |
| Wax paper | Pre-stretched | Pre-stretched | Yes | 15 | 60 |
| tube | Parafilm ® M | Parafilm ® M | | | |
| Wax paper | Pre-stretched | Staple | No | 15 | 80 |
| tube | Parafilm ® M | | | | |
| Wax paper | Pre-stretched | Staple | Yes | 15 | 47 |
| tube | Parafilm ® M | | | | |
| Wax paper | Gelatin/starch | Gelatin/starch | No | 15 | 20 |
| tube | | | | | |
| Wax paper | Gelatin/starch | Gelatin/starch | Yes | 15 | 13 |
| tube | | | | | |
| Bare plantlet - | None | None | None | 19 | 26 |
| Field | | | | | |
| Bare plantlet - | None | None | None | 12 | 33 |
| Greenhouse | | | | | |

As shown in Table 9, in this experiment, many of the tube artificial seeds exhibited higher survival rates than the bare plantlets. In several treatments, the top lids of the artificial seeds were observed to spontaneously rupture in the first 5 days of the experiment.

### Example 17

### Effect of Duration of Coverage on Top of Wax Paper Tubes in Field Testing in Brazil

Cylindrical wax paper containers (Colossal drinking straw, Aardvark®, Precision Products Group, Ft Wayne, 1N, 1.19 cm outer diameter) were cut into 4 cm lengths. Sugarcane plantlets, cultivar V11 (SP813250) which had been regenerated for 28 days from bud tissue fragments in plantlet regeneration medium were used for this experiment. The plantlet shoots were trimmed to approximately 3 cm length before encapsulation in some treatments. The bottoms of the paper tubes were either closed by wrapping pre-stretched Parafilm® M across the bottom or by using gelatin starch lids on the bottom.

In some treatments, a thin approximately 1 cm layer of autoclaved potting soil (Topstrato® HT) was placed at the bottom of the tubes; the plantlets were placed on the soil layer, and then additional potting soil was added to fill the tube until the plantlet was mostly covered; a volume of ˜1 mL of water was added into the structure. In other treatments, a thin approximately 1 cm layer of a solution at 10 g/L of a Super Absorbent Polymer (Stockosorb®) with MS Salt was placed at the bottom of the tubes and then the plantlets were placed on this solution. The tops of the tubes were closed with either pre-stretched Parafilm® M or with inverted 15 mL Falcon tubes. For the treatments covered with Falcon tubes, they were removed from the structure after 5, 9 and 16 days.

The artificial seeds were planted in a vertical orientation in raised beds at the DuPont do Brasil site in Paulinia (SP), Brazil such that the tops of the tubes were less than 0.5 cm above the soil surface. Bare plantlets were planted in both the field, as well as a nearby greenhouse onsite (using the same autoclaved potting soil used inside the structures) in 8 cm pots (240 mL volume)). The field soil had been prepared before the experiment using rotary hoes and a bed shaper. After planting, irrigation was performed daily and survival was monitored every two days.

TABLE 10
Results of field experiment with wax paper tube artificial seeds.

| Seed | Material inside | | Top | Bottom | Removal of | Initial # of | % Survival |
|---|---|---|---|---|---|---|---|
| structure | the structure | Trimmed | closure | closure | Falcon tube | containers | by day 30 |
| Wax paper | Potting | Yes | Pre-stretched | Pre-stretched | — | 18 | 72.2 |
| tube | soil | | Parafilm ® M | Parafilm ® M | | | |
| Wax paper | Potting | No | 15 mL | Gelatin/starch | 5 days | 18 | 72.2 |
| tube | soil | | Falcon tube | | | | |
| Wax paper | Potting | No | 15 mL | Gelatin/starch | 9 days | 18 | 77.8 |
| tube | soil | | Falcon tube | | | | |
| Wax paper | Potting | No | 15 mL | Gelatin/starch | 16 days | 18 | 72.2 |
| tube | soil | | Falcon tube | | | | |
| Wax paper | SAP with MS | No | 15 mL | Gelatin/starch | 5 days | 18 | 77.8 |
| tube | Salt | | Falcon tube | | | | |
| Wax paper | SAP with MS | No | 15 mL | Gelatin/starch | 9 days | 18 | 88.9 |
| tube | Salt | | Falcon tube | | | | |
| Wax paper | SAP with MS | No | 15 mL | Gelatin/starch | 16 days | 18 | 72.2 |
| tube | Salt | | Falcon tube | | | | |
| Bare plantlet - | None | No | None | None | — | 18 | 0.0 |
| Field | | | | | | | |
| Bare plantlet - | None | No | None | None | — | 18 | 77.8 |
| Greenhouse | | | | | | | |
| Bare plantlet - | None | Yes | None | None | — | 18 | 44.4 |
| Greenhouse | | | | | | | |
| (Trimmed) | | | | | | | |

As shown in Table 10 all the tube artificial seeds exhibited higher survival rates than the bare plantlets. The removal of the conical lid after 9 days resulted in the highest survival rates.

What is claimed is:

1. An artificial seed comprising one or more regenerable plant tissues, a container comprising a degradable portion, an unobstructed airspace, a multilayer, and a nutrient source, and further comprising one or more features selected from the group consisting of:
a) a penetrable or degradable region through which the regenerable plant tissue grows,
b) a monolayer water soluble portion of the container,
c) a region of the container that flows or creeps between about 25° C. and 50° C.,
d) a separable closure which is physically displaced during regenerable plant tissue growth,
e) one or more openings in sides or bottom of the container,
f) a conical or tapered region leading to an opening less than 2 cm wide at the apex and wherein the angle of the conical or tapered region is less than 135 degrees measured from opposite sides, and
g) a plurality of flexible flaps through which the regenerable tissue grows.

2. The artificial seed of claim 1, where the container, or a region of the container, or a closure, or a layer of the multilayer further comprises one or more of the following: polyesters, polyamides, polyolefins, cellulose, cellulose derivatives, polysaccharides, polyethers, polyurethanes, polycarbonates, poly(alkyl methacrylate)s, poly(alkyl acrylate)s, poly(acrylic acids), poly(meth)acrylic acids, polyphosphazenes, polyimides, polyanhydrides, polyamines, polydienes, polyacrylamides, poly(siloxanes), poly(vinyl alcohol), poly(vinyl esters), poly(vinyl ethers), natural polymers, block copolymers, crosslinked polymers, proteins, waxes, oils, fats, greases, water soluble polymers, poly(ethylene glycol), salts of poly(acrylic acid), poly(vinyl alcohol), plasticizers, antioxidants, nucleating agents, impact modifiers, processing aids, tougheners, colorants, fillers, stabilizers, flame retardants, natural rubber, polysulfones, or polysulfides; or blends thereof; or crosslinked versions thereof.

3. The artificial seed of claim 1, wherein the container further comprises a component selected from the group consisting of:
a) amorphous poly(D,L-lactic acid), poly(lactic acid), poly(L-lactic acid), poly(D-lactic acid), poly(meso-lactic acid), poly(rac-lactic acid), or poly(D,L-lactic acid), (poly(hydroxyalkanoate), poly(hydroxybutyrate), poly(hydroxybutyrate-co-valerate), poly(caprolactone), poly(butylene succinate), poly(ethylene succinate), poly(ethylene carbonate), poly(propylene carbonate), starch, gelatin, thermoplastic starch, poly(butylene terephthalate adipate), poly(propylene terephthalate succinate), poly(propylene terephthalate adipate), poly(vinyl alcohol), poly(ethylene glycol), cellulose, chitosan, cellulose acetate, or cellulose butyrate acetate,
b) a polyester with greater than 5 mol percent aliphatic monomer content,
c) a crosslinked version of amorphous poly(D,L-lactic acid), poly(lactic acid), poly(L-lactic acid), poly(D-lactic acid), poly(meso-lactic acid), poly(rac-lactic acid), or poly(D,L-lactic acid), (poly(hydroxyalkanoate), poly(hydroxybutyrate), poly(hydroxybutyrate-co-valerate), poly(caprolactone), poly(butylene succinate), poly(ethylene succinate), poly(ethylene carbonate), poly(propylene carbonate), starch, gelatin, thermoplastic starch, poly(butylene terephthalate adipate), poly(propylene terephthalate succinate), poly(propylene terephthalate adipate), poly(vinyl alcohol), poly(ethylene glycol), cellulose, chitosan, cellulose acetate, cellulose butyrate acetate, or a polyester with greater than 5 mol percent aliphatic monomer content,
d) a plasticizer, wherein the plasticizer is present at less than 30 wt % of the total composition,
e) acetyl tributyl citrate, tributyl citrate, di-n-octyl sebacate, di-2-ethylhexylsebacate, di-2-ethylhexylsuccinate, diisooctyl adipate, di-2-ethylhexyl adipate, diisooctyl glutarate, di-2-ethylhexyl glutarate, poly(ethylene glycol), poly(ethylene glycol) monolaurate, sorbitol, glycerol, poly(propylene glycol), or water,
f) copolymers of two or more of caprolactone, lactic acid, D-lactide, L-lactide, meso-lactide, D,L-lactide, sebacic acid, succinic acid, adipic acid, glycolic acid, oxalic acid, ethylene glycol, 1,2-propanediol, 1,3-propanediol, 1,3-butanediol, 1,4-butanediol, 1,5-pentanediol, 2,2,4,4-tetramethyl-1,3-cyclobutanediol, 1,6-hexanediol, terephthalic acid, isophthalic acid, dimethyl siloxane, succinic anhydride, a crosslinker, a diisocyanate, or phthalic anhydride,
g) an antioxidant, a nucleating agent, an impact modifier, a processing aid, a toughener, a colorant, a filler, a stabilizer, or a flame retardant,
h) paper, water soluble paper, recycled paper, bond paper, kraft paper, waxed paper, or coated paper;
i) a combination of two or more of components a) through h) above, and
j) a blend comprising two or more of components a) through i) above.

4. The artificial seed of claim 1, wherein a region of the container or closure or a layer of the multilayer further comprises a component selected from the group consisting of:
a) random, block or gradient copolymers of lactic acid with caprolactone,
b) random, block or gradient copolymers of lactic acid with dimethylsiloxane,
c) an alkyd resin,
d) poly(vinyl alcohol), poly(acrylamide), poly(vinyl pyrrolidone), starch, cellulose, glycerol, poly(ethylene glycol), citric acid, urea, water, sodium acetate, potassium nitrate, ammonium nitrate, fertilizers, agar, xanthan gum, alginate, hydroxypropylcellulose, methylcellulose, carboxymethylcellulose, guar gum, pectin, a water soluble protein, a water soluble carbohydrate, a water soluble synthetic polymer, gelatin, or sodium carboxymethylcellulose, or crosslinked versions thereof,
e) blends of two or more of the following: poly(vinyl alcohol), starch, cellulose, glycerol, poly(ethylene glycol), poly(acrylamide), poly(vinyl pyrrolidone), citric acid, urea, water, sodium acetate, potassium nitrate, ammonium nitrate, fertilizers, agar, xanthan gum, alginate, hydroxypropylcellulose, methylcellulose, carboxymethylcellulose, a water soluble protein, a water soluble carbohydrate, a water soluble synthetic polymer, gelatin, a crosslinker, or sodium carboxymethylcellulose,
f) a gel comprising a block copolymer and an oil,
g) sodium carboxymethylcellulose,
h) wax-impregnated water soluble paper,
i) amorphous poly(D,L-lactic acid), poly(lactic acid), poly(L-lactic acid), poly(D-lactic acid), poly(meso-lactic acid), poly(rac-lactic acid), or poly(D,L-lactic acid), (poly(hydroxyalkanoate), poly(hydroxybutyrate), poly(hydroxybutyrate-co-valerate), poly(caprolactone), poly(butylene succinate), poly(ethylene succinate), poly(ethylene carbonate), poly(propylene carbonate), starch, thermoplastic starch, gelatin, poly(butylene terephthalate adipate), poly(propylene terephthalate succinate), poly(propylene terephthalate adipate), poly(vinyl alcohol), poly(ethylene glycol), cellulose, chitosan, cellulose acetate, cellulose butyrate acetate; or a crosslinked version thereof,
j) a polyester with greater than 5 mol percent aliphatic monomer content,
k) a crosslinked version of amorphous poly(D,L-lactic acid), poly(lactic acid), poly(L-lactic acid), poly(D-lactic acid), poly(meso-lactic acid), poly(rac-lactic acid), or poly(D,L-lactic acid), poly(hydroxyalkanoate), poly(hydroxybutyrate), poly(hydroxybutyrate-co-valerate), poly(caprolactone), poly(butylene succinate), poly(ethylene succinate), poly(ethylene carbonate), poly(propylene carbonate), starch, gelatin, thermoplastic starch, poly(butylene terephthalate adipate), poly(propylene terephthalate succinate), poly(propylene terephthalate adipate), poly(vinyl alcohol), poly(ethylene glycol), cellulose, chitosan, cellulose acetate, cellulose butyrate acetate, or a polyester with greater than 5 mol percent aliphatic monomer content,
l) a plasticizer, wherein the plasticizer is present at less than 30 wt % of the total composition,
m) acetyl tributyl citrate, tributyl citrate, di-n-octyl sebacate, di-2-ethylhexylsebacate, di-2-ethylhexylsuccinate, diisooctyl adipate, di-2-ethylhexyl adipate, diisooctyl glutarate, di-2-ethylhexyl glutarate, poly(ethylene glycol), poly(ethylene glycol) monolaurate, sorbitol, glycerol, poly(propylene glycol), or water,
n) copolymers of two or more of caprolactone, lactic acid, D-lactide, L-lactide, meso-lactide, D,L-lactide, sebacic acid, succinic acid, adipic acid, glycolic acid, oxalic acid, ethylene glycol, 1,2-propanediol, 1,3-propanediol, 1,3-butanediol, 1,4-butanediol, 1,5-pentanediol, 2,2,4,4-tetramethyl-1,3-cyclobutanediol, 1,6-hexanediol, terephthalic acid, isophthalic acid, succinic anhydride, a diisocyanate, a crosslinker, or phthalic anhydride,
o) an antioxidant, a nucleating agent, an impact modifier, a processing aid, a toughener, a colorant, a filler, a stabilizer, or a flame retardant,
p) a wax, Parafilm® or Nescofilm®,®, a hydrophobic substance, a fat, a triglyceride, fatty acid, fatty alcohol, a lipid, an oil, polyethylene, polypropylene, ethylene propylene copolymers, polybutadiene, polyisoprene, polyisobutylene, polyolefin oligomers, and crosslinked versions or blends thereof,
q) paper, water soluble paper, recycled paper, bond paper, kraft paper, waxed paper, or coated paper; or
r) a combination of two or more of components a) through q) above, and
s) a blend comprising two or more of components a) through r) above.

5. The artificial seed of claim 1, wherein the container is expandable.

6. The artificial seed of claim 5, wherein said artificial seed is expandable through a method selected from the group consisting of:
a) telescoping of two or more tubular members,
b) unfolding,
c) inflation,
d) unraveling; and
e) stretching.

7. The artificial seed of claim 1, wherein the nutrient source further comprises a component selected from the group consisting of:
a) soil,
b) coconut coir,
c) vermiculite,
d) an artificial growth medium,
e) agar,
f) a superabsorbent polymer,
g) a plant growth regulator,
h) a plant hormone,
i) micronutrients,
j) macronutrients,
k) water,
l) a fertilizer,
m) peat,
n) a combination of two or more of components a) through m) above, and
o) a blend comprising two or more of components a) through n) above.

8. The artificial seed of claim 1, wherein the regenerable plant tissue is a regenerable tissue selected from the group consisting of:
a) sugar cane, a graminaceous plant, saccharum spp, saccharum spp hybrids, miscanthus, switchgrass, energycane, sterile grasses, bamboo, cassava, corn, rice, banana, potato, sweet potato, yam, pineapple, trees, willow, poplar, mulberry, ficus spp, oil palm, date palm, poaceae, verbena, vanilla, tea, hops, Erianthus spp, intergeneric hybrids of Saccharum, Erianthus and Sorghum spp, African violet, apple, date, fig, guava, mango, maple, plum, pomegranate, papaya, avocado, blackberries, garden strawberry, grapes, canna, cannabis, citrus, lemon, orange, grapefruit, tangerine, or dayap,
b) a genetically modified plant of a) above,
c) a micropropagated version of a) above, and
d) a genetically modified, micropropagated version of a) above.

9) The artificial seed of claim 1, wherein the container further comprises a component selected from the group consisting of:
a) a cylindrical tube with a conical top,
b) a two part tube with a porous bottom section and a nonporous top section,
c) a flexible packet,
d) a semi-flexible packet,
e) one or more rigidifying elements,
f) a multi-component extruded tube,
g) a rolled tube structure, capable of unraveling,
f) an anchoring device,
g) a two multi-part tube with a hinged edge,
h) a two multi-part tube held together with adhesive,
i) a tubular shape,
j) a container portion in contact with soil that degrades faster than the portion above soil,
k) an airspace comprising multiple compartments,
l) a closed bottom end that retains moisture,
m) a cap attached by an adhesive joint,
n) a cap attached by insertion into the container, and
o) a weak region.

10) The artificial seed of claim 1, wherein the container or closure further comprises a material selected from the group consisting of:
a) a transparent, translucent or semi-translucent material,
b) an opaque material,
c) a porous material,
d) a nonporous material,
e) a permeable material,
f) an impermeable material; and
g) any one of materials a) through f) above, wherein the material is biodegradable, hydrolytically degradable, or compostable.

11) The artificial seed of claim 1, where one or more of the openings are secured using a component selected from the group consisting of:
a) a crimp,
b) a fold,
c) a porous material,
d) mesh,
e) screen,
f) cotton,
g) gauze; and
h) a staple.

12) The artificial seed of claim 1, wherein the artificial seed further comprises an agent selected from the group consisting of:
a) a fungicide,
b) a nematicide,
c) an insecticide,
d) an antimicrobial compound,
e) an antibiotic,
f) a biocide,
g) an herbicide,
h) plant growth regulator or stimulator,
i) microbes,
j) a molluscicide,
k) a miticide,
l) an acaricide,
m) a bird repellant,
n) an insect repellant,
o) a plant hormone; and
p) a rodent repellant.

13) A method of storing the artificial seed of claim 1, comprising obtaining the artificial seed and storing said artificial seed before planting in one or more of the following conditions:
a) ambient conditions,
b) sub-ambient temperature,
c) sub-ambient oxygen levels, or
d) under sub-ambient illumination, and
wherein the regenerable plant tissue remains viable.

14) A method of planting the artificial seed of claim 1, comprising obtaining the artificial seed and performing a step from the group consisting of:
a) introducing one or more breaches in said artificial seed wherein the breaches facilitate the growth of the regenerable plant tissues,
b) expanding the artificial seed, and
c) the combination of a) and b) above.
